(19) United States
(12) Patent Application Publication
(10) Pub. No.: US 2011/0218838 A1
(43) Pub. Date: Sep. 8, 2011

(54) ECONOMETRICAL INVESTMENT STRATEGY ANALYSIS APPARATUSES, METHODS AND SYSTEMS

(76) Inventors: Chuck Byce, Mill Valley, CA (US); Laura DiGioacchino, San mateo, CA (US)

(21) Appl. No.: 13/038,267

(22) Filed: Mar. 1, 2011

Related U.S. Application Data
(60) Provisional application No. 61/309,335, filed on Mar. 1, 2010.

(51) Int. Cl. G06Q 10/00; G06Q 40/00

(52) U.S. Cl. 705/7.31; 705/7.29

(57) ABSTRACT

The ECONOMETRICAL INVESTMENT STRATEGY ANALYSIS APPARATUSES, METHODS AND SYSTEMS (“EISA”) transform raw card-based transaction data via EISA components into business analytics reports. In one embodiment, the EISA may obtain an investment strategy analysis request. The EISA may determine a scope of aggregation of card-based transaction data records for investment strategy analysis and aggregate the card-based transaction data records for investment strategy analysis according to the determined scope. The EISA may generate anonymized card transaction data by removing identifying characteristics from the aggregated transaction data. The EISA may determine a forecast regression equation using the anonymized card-based transaction data records. Using the forecast regression equation, the EISA may calculate a forecast for retail spending in a specified spending category. Based on the calculated forecast, the EISA may generate a business analytics report, and provide the business analytics report in response to the obtained investment strategy analysis report.

### RELATED APPLICATIONS

Applicant hereby claims priority under 35 USC §119 for U.S. provisional patent application Ser. No. 61/309,335 filed Mar. 1, 2010, entitled “PORTAL DELIVERY SYSTEM AND METHOD FOR DELIVERING INFORMATION PRODUCTS TO INVESTORS,” attorney docket no. P-41069PRV|20270-107PV. The entire contents of the aforementioned application are expressly incorporated by reference herein.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for business analytics, and more particularly, to ECONOMETRICAL INVESTMENT STRATEGY ANALYSIS APPARATUSES, METHODS AND SYSTEMS (“EISA”).

### BACKGROUND

Businesses desire to tailor their business strategies, and product and service offerings based on an understanding of market demand and consumer behavior. However, studying market demand and consumer behavior raises issues of computation complexity and consumer privacy. Consumers often use card-based transactions (e.g., credit, debit, prepaid cards, etc.) to obtain products and services.

### BRIEF DESCRIPTION OF THE DRAWINGS

The accompanying appendices and/or drawings illustrate various non-limiting, example, inventive aspects in accordance with the present disclosure:

FIGS. 1A-B show block diagrams illustrating example aspects of econometrical investment strategy analysis in some embodiments of the EISA;

FIGS. 2A-C show data flow diagrams illustrating an example procedure to execute a card-based transaction resulting in raw card-based transaction data in some embodiments of the EISA;

FIGS. 3A-D show logic flow diagrams illustrating example aspects of executing a card-based transaction resulting in generation of raw card-based transaction data in some embodiments of the EISA, e.g., a Card-Based Transaction Execution (“CTE”) component 300;

FIGS. 4A-C show data flow diagrams illustrating an example procedure for econometrical analysis of a proposed investment strategy based on card-based transaction data in some embodiments of the EISA;

FIG. 5 shows a data flow diagram illustrating an example procedure to aggregate card-based transaction data in some embodiments of the EISA;

FIG. 6 shows a logic flow diagram illustrating example aspects of aggregating card-based transaction data in some embodiments of the EISA, e.g., a Transaction Data Aggregation (“TDA”) component 600;

FIG. 7 shows a logic flow diagram illustrating example aspects of normalizing raw card-based transaction data into a standardized data format in some embodiments of the EISA, e.g., a Transaction Data Normalization (“TDN”) component 700;

FIG. 8 shows a logic flow diagram illustrating example aspects of generating classification labels for card-based transactions in some embodiments of the EISA, e.g., a Card-Based Transaction Classification (“CTC”) component 800;

FIG. 9 shows a logic flow diagram illustrating example aspects of filtering card-based transaction data for econometrical investment strategy analysis in some embodiments of the EISA, e.g., a Transaction Data Filtering (“TDF”) component 900;

FIG. 10 shows a logic flow diagram illustrating example aspects of anonymizing consumer data from card-based transactions for econometrical investment strategy analysis in some embodiments of the EISA, e.g., a Consumer Data Anonymization (“CDA”) component 1000;

FIGS. 11A-B show logic flow diagrams illustrating example aspects of econometrically analyzing a proposed investment strategy based on card-based transaction data in some embodiments of the EISA, e.g., an Econometrical Strategy Analysis (“ESA”) component 1100;

FIG. 12 shows a logic flow diagram illustrating example aspects of reporting business analytics derived from an econometrical analysis based on card-based transaction data in some embodiments of the EISA, e.g., a Business Analytics Reporting (“BAR”) component 1200;

FIGS. 13A-E show example business analytics reports on specially clothing analysis generated from econometrical investment strategy analysis based on card-based transaction data in some embodiments of the EISA;

FIGS. 14A-B show example business analytics reports on e-commerce penetration into various industries generated from econometrical investment strategy analysis based on card-based transaction data in some embodiments of the EISA;

FIGS. 15A-E show example business analytics reports on home improvement sales generated from econometrical investment strategy analysis based on card-based transaction data in some embodiments of the EISA;

FIGS. 16A-H show example business analytics reports on the hotel industry generated from econometrical investment strategy analysis based on card-based transaction data in some embodiments of the EISA;

FIGS. 17A-E show example business analytics reports on pharmacy sales generated from econometrical investment strategy analysis based on card-based transaction data in some embodiments of the EISA;

FIGS. 18A-H show example business analytics reports on rental car usage generated from econometrical investment strategy analysis based on card-based transaction data in some embodiments of the EISA;

FIGS. 19A-E show example business analytics reports on sports, hobbies, and book-related sales generated from econometrical investment strategy analysis based on card-based transaction data in some embodiments of the EISA;

FIGS. 20A-E show example business analytics reports on total retail spending generated from econometrical investment strategy analysis based on card-based transaction data in some embodiments of the EISA; and

FIG. 21 shows a block diagram illustrating embodiments of a EISA controller.

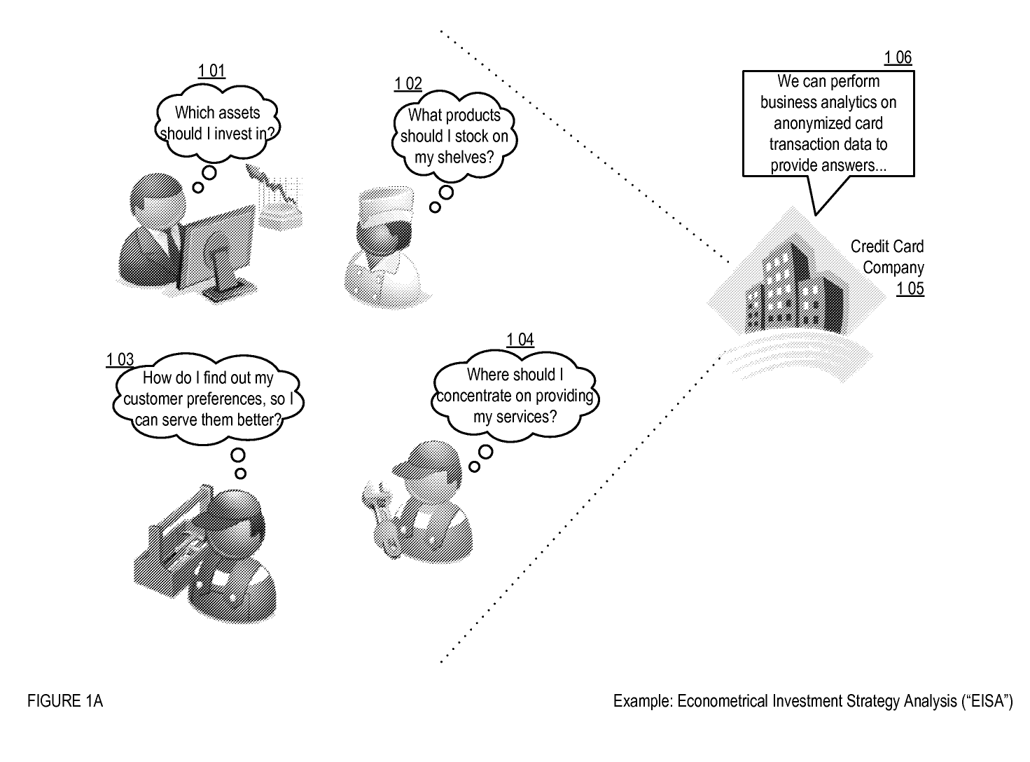

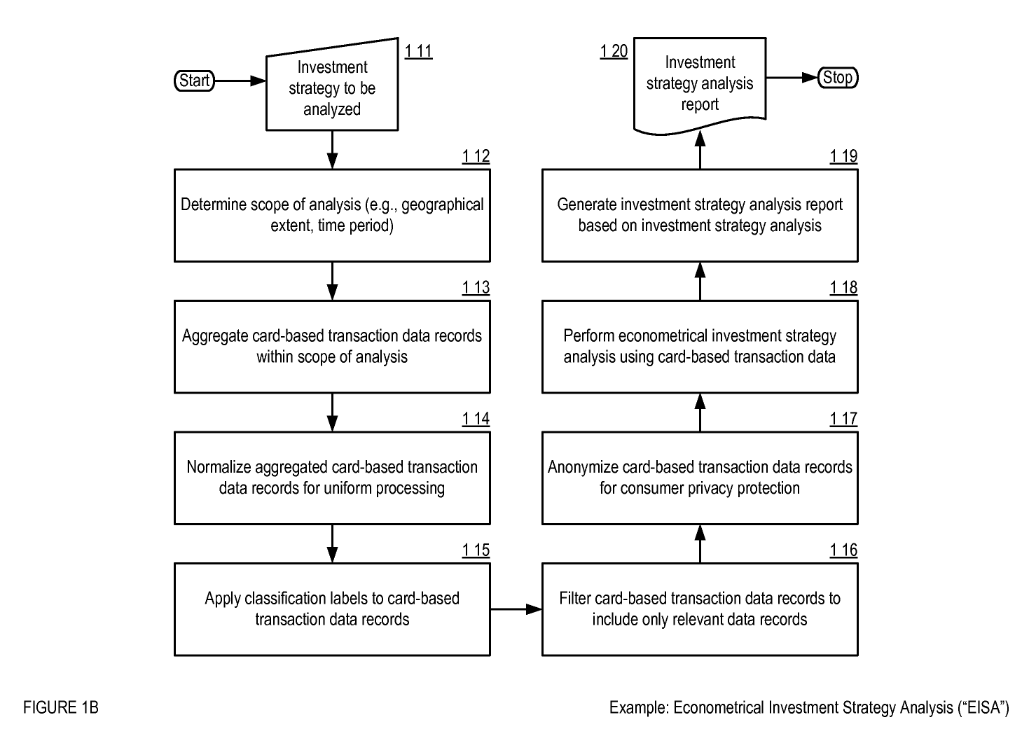

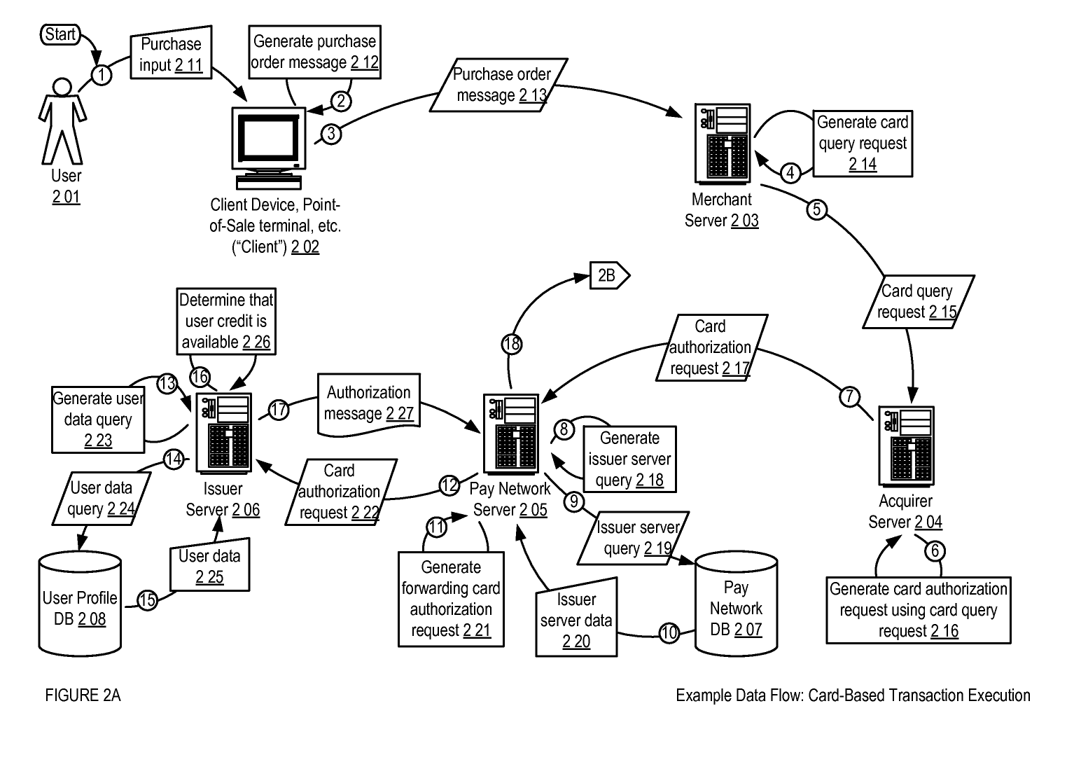

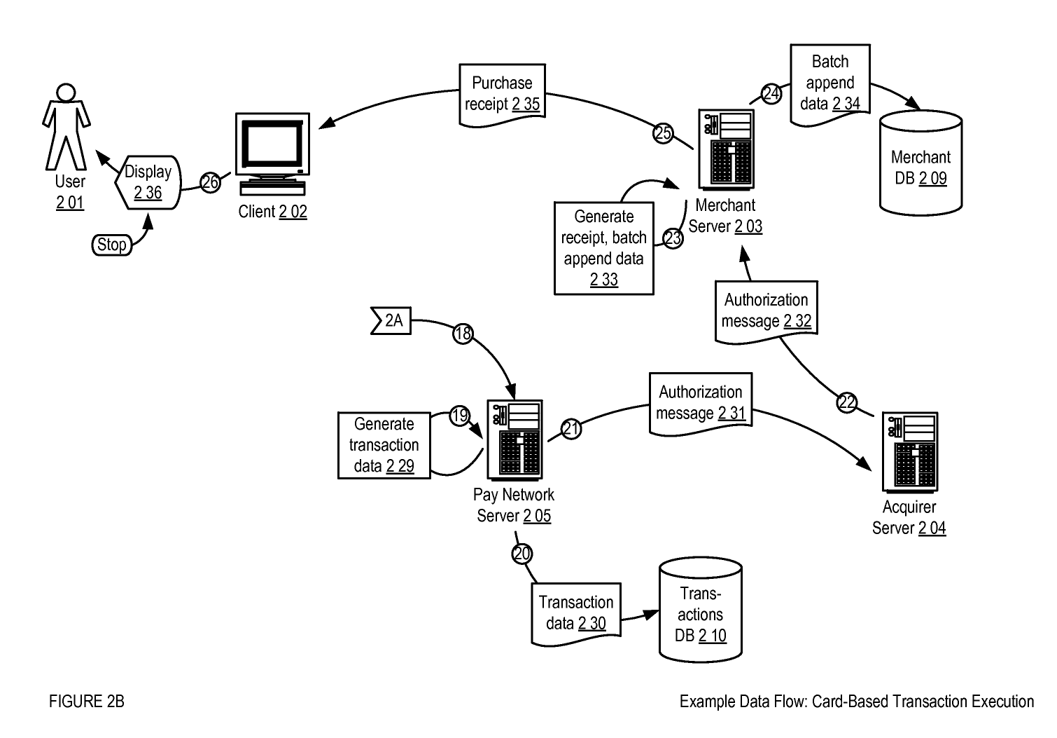

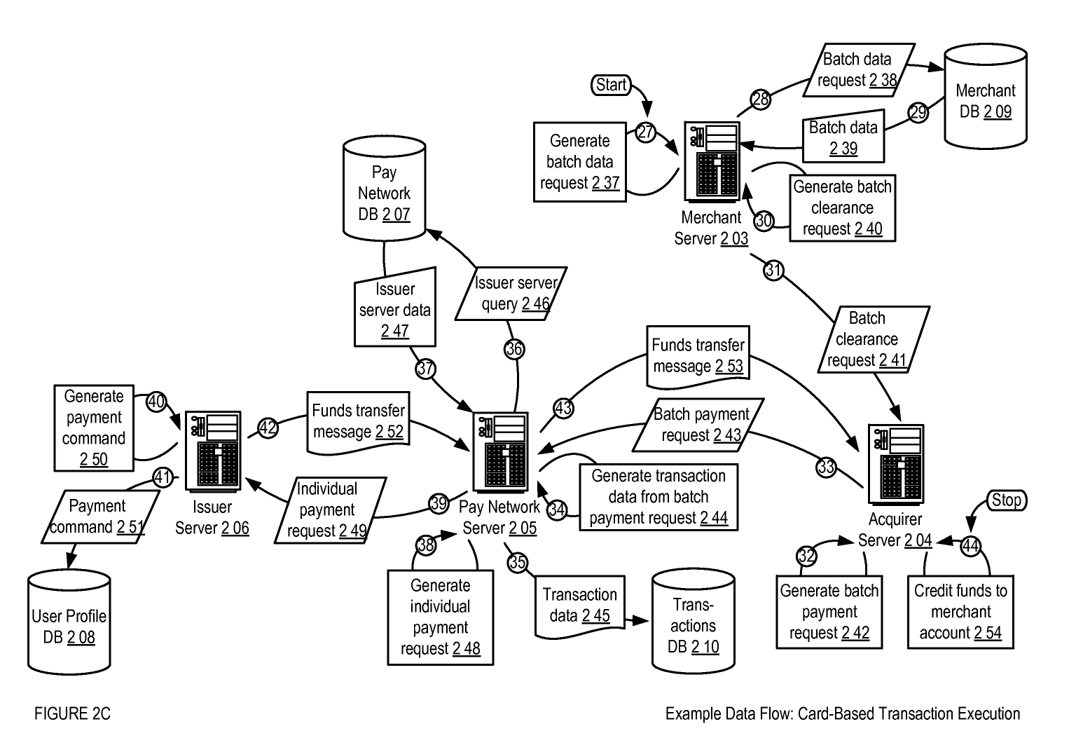

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Econometrical Investment Strategy Analysis (EISA)

The ECONOMETRICAL INVESTMENT STRATEGY ANALYSIS APPARATUSES, METHODS AND SYSTEMS (hereinafter “EISA”) transform raw card-based transaction data, via EISA components, into business analytics reports.

FIGS. 1A-B show block diagrams illustrating example aspects of econometrical investment strategy analysis in some embodiments of the EISA. In some implementations, the EISA may provide business analytics reports to various users in order to facilitate their making calculated investment decisions. For example, a stock investor may desire business analytics to determine which stocks the investor should invest in, how the investor should modify the investor's portfolio, and/or the like, e.g., 101. In another example, a retailer may desire to understand customer behavior better so that the retailer may determine which products to provide for customers to generate maximum retail sales, e.g., 102. In another example, a serviceperson providing services to customers may desire to understand which services the customer tend to prefer, and/or a paying for in the marketplace, e.g., 103. In another example, a service provider may desire to understand the geographical areas where business for the serviceperson is likely to be concentrated, e.g., 104. In some implementations, a credit card company may have access to a large database of card-based transactions. The card-based transaction may have distributed among them information on customer behavior, demand, geographical distribution, industry sector preferences, and/or the like, which may be mined in order to provide investors, retailer, service personnel and/or other users business analytics information based on analyzing the card-based transaction data. In some implementations, the EISA may take specific measures in order to ensure the anonymity of users whose card-based transaction data are analyzed for providing business analytics information for users. For example, the EISA may perform business analytics on anonymized card-based transaction data to provide solutions to questions such as illustrated in 101-104.

In some implementations, the EISA may obtain an investment strategy to be analyzed, e.g., in, for example, from a user. The EISA may determine, e.g., 112 the scope of the investment strategy analysis (e.g., geographic scope, amount of data required, industry segments to analyze, type of analysis to be generated, time-resolution of the analysis (e.g., minute, hour, day, month, year, etc.), geographic resolution (e.g., street, block, zipcode, metropolitan area, city, state, country, inter-continental, etc.). The EISA may aggregate card-based transaction data in accordance with the determined scope of analysis, e.g., 113. The EISA may normalized aggregated card-based transaction data records for uniform processing, e.g., 114. In some implementations, the EISA may apply classification labels to card-based transaction data records, e.g., 115, for investment strategy analysis. The EISA may filter the card-based transaction data records to include only those records as relevant to the analysis, e.g., 116. For example, the EISA may utilize the classification labels corresponding to the transaction data records to determine which records are relevant to the analysis. In some implementations, the EISA may anonymize transaction data records for consumer privacy protection prior to investment strategy analysis, e.g., 117. The EISA may perform econometrical investment strategy analysis, e.g., 118, and generate an investment strategy analysis report based on the investment strategy analysis, e.g., 119. The EISA may provide the investment strategy analysis report for the user requesting the investment strategy analysis.

FIGS. 2A-C show data flow diagrams illustrating an example procedure to execute a card-based transaction resulting in raw card-based transaction data in some embodiments of the EISA. In some implementations, a user, e.g., 201, may desire to purchase a product, service, offering, and/or the like (“product”), from a merchant. The user may communicate with a merchant server, e.g., 203, via a client such as, but not limited to: a personal computer, mobile device, television, point-of-sale terminal, kiosk, ATM, and/or the like (e.g., 202). For example, the user may provide user input, e.g., purchase input 211, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a purchase order message, e.g., 212, and provide, e.g., 213, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. The merchant server may generate a card query request, e.g., 214 to determine whether the transaction can be processed. For example, the merchant server may attempt to determine whether the user has sufficient funds to pay for the purchase in a card account provided with the purchase order. The merchant server may provide the generated card query request, e.g., 215, to an acquirer server, e.g., 204. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

POST /cardquery.php HTTP/1.1
Host: www.acquirer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for dummies</product_summary>
<product_quantity>1</product_quantity?

</product>

</purchase_summary>
<transaction_cost>$34.78</transaction_cost>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</card_query_request>

In some implementations, the acquirer server may generate a card authorization request, e.g., 216, using the obtained card query request, and provide the card authorization request, e.g., 217, to a pay network server, e.g., 205. For example, the acquirer server may redirect the HTTP(S) POST message in the example above from the merchant server to the pay network server.

In some implementations, the pay network server may obtain the card authorization request from the acquirer server, and may parse the card authorization request to extract details of the request. Using the extracted fields and field values, the pay network server may generate a query, e.g., 218, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 206, of the issuer may maintain details of the user's card account. In some implementations, a database, e.g., pay network database 207, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address

auth_key port_num security_settings_list FROM IssuerTable
WHERE account_num LIKE ′%′ $accountnum”;

$result = mysql_query($query); // perform the search query
mysql_close(“ISSUERS.SQL”); // close database access
?>

In response to obtaining the issuer server query, e.g., 219, the pay network database may provide, e.g., 220, the requested issuer server data to the pay network server. In some implementations, the pay network server may utilize the issuer server data to generate a forwarding card authorization request, e.g., 221, to redirect the card authorization request from the acquirer server to the issuer server. The pay network server may provide the card authorization request, e.g., 222, to the issuer server. In some implementations, the issuer server, e.g., 206, may parse the card authorization request, and based on the request details may query a database, e.g., user profile database 208, for data of the user's card account. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable

WHERE account_num LIKE ′%′ $accountnum”;

$result = mysql_query($query); // perform the search query
mysql_close(“USERS.SQL”); // close database access
?>

In some implementations, on obtaining the user data, e.g., 225, the issuer server may determine whether the user can pay for the transaction using funds available in the account, e.g., 226. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 227, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record, e.g., 229, from the card authorization request it received, and store, e.g., 230, the details of the transaction and authorization relating to the transaction in a database, e.g., transactions database 210. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PurchasesTable (timestamp,

purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key)

VALUES (time( ), $purchase_summary_list, $num_products,

$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”);
// add data to table in database

mysql_close(″TRANSACTIONS.SQL″); // close connection to database
?>

In some implementations, the pay network server may forward the authorization message, e.g., 231, to the acquirer server, which may in turn forward the authorization message, e.g., 232, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 233, and store the XML data file, e.g., 234, in a database, e.g., merchant database 209. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some implementations, the server may also generate a purchase receipt, e.g., 233, and provide the purchase receipt to the client. The client may render and display, e.g., 236, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 2C, in some implementations, the merchant server may initiate clearance of a batch of authorized transactions. For example, the merchant server may generate a batch data request, e.g., 237, and provide the request, e.g., 238, to a database, e.g., merchant database 209. For example, the merchant server may utilize PHP/SQL commands similar to the examples provided above to query a relational database. In response to the batch data request, the database may provide the requested batch data, e.g., 239. The server may generate a batch clearance request, e.g., 240, using the batch data obtained from the database, and provide, e.g., 241, the batch clearance request to an acquirer server, e.g., 204. For example, the merchant server may provide a HTTP(S) POST message including XML-formatted batch data in the message body for the acquirer server. The acquirer server may generate, e.g., 242, a batch payment request using the obtained batch clearance request, and provide the batch payment request to the pay network server, e.g., 243. The pay network server may parse the batch payment request, and extract the transaction data for each transaction stored in the batch payment request, e.g., 244. The pay network server may store the transaction data, e.g., 245, for each transaction in a database, e.g., transactions database 210. For each extracted transaction, the pay network server may query, e.g., 246, a database, e.g., pay network database 207, for an address of an issuer server. For example, the pay network server may utilize PHP/SQL commands similar to the examples provided above. The pay network server may generate an individual payment request, e.g., 248, for each transaction for which it has extracted transaction data, and provide the individual payment request, e.g., 249, to the issuer server, e.g., 206. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>1</product_quantity?

</product>

</purchase_summary>

</pay_request>

In some implementations, the issuer server may generate a payment command, e.g., 250. For example, the issuer server may issue a command to deduct funds from the user's account (or add a charge to the user's credit card account). The issuer server may issue a payment command, e.g., 251, to a database storing the user's account information, e.g., user profile database 208. The issuer server may provide a funds transfer message, e.g., 252, to the pay network server, which may forward, e.g., 253, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 254.

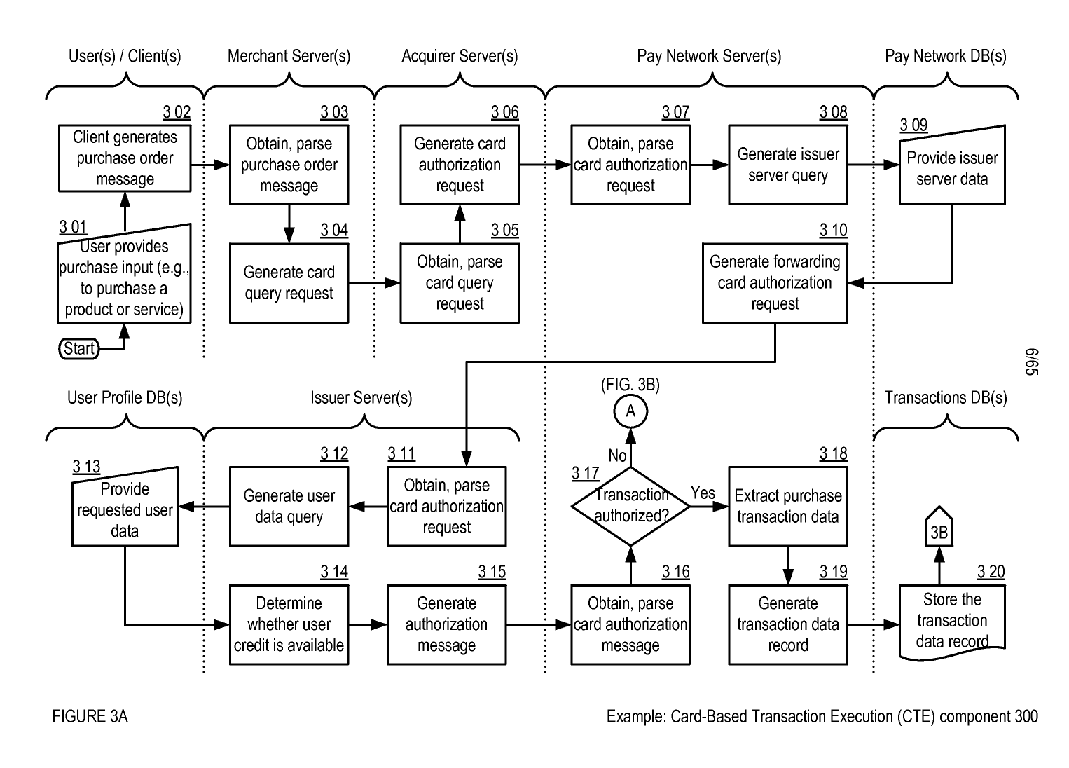

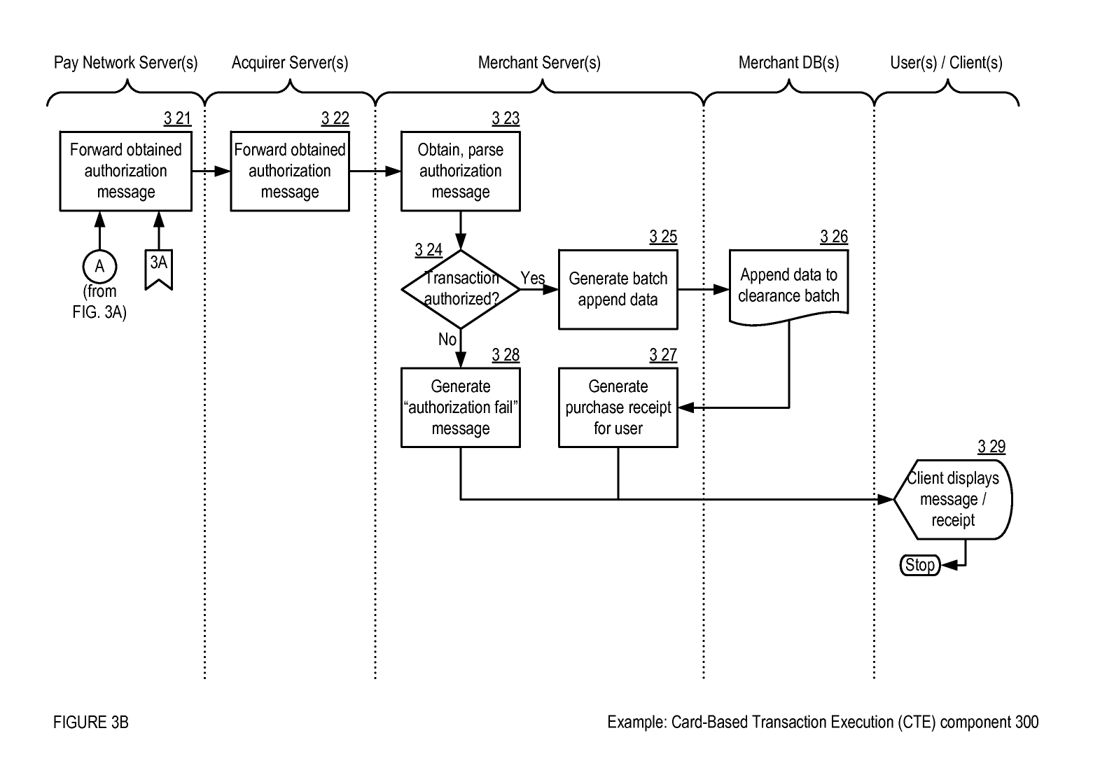

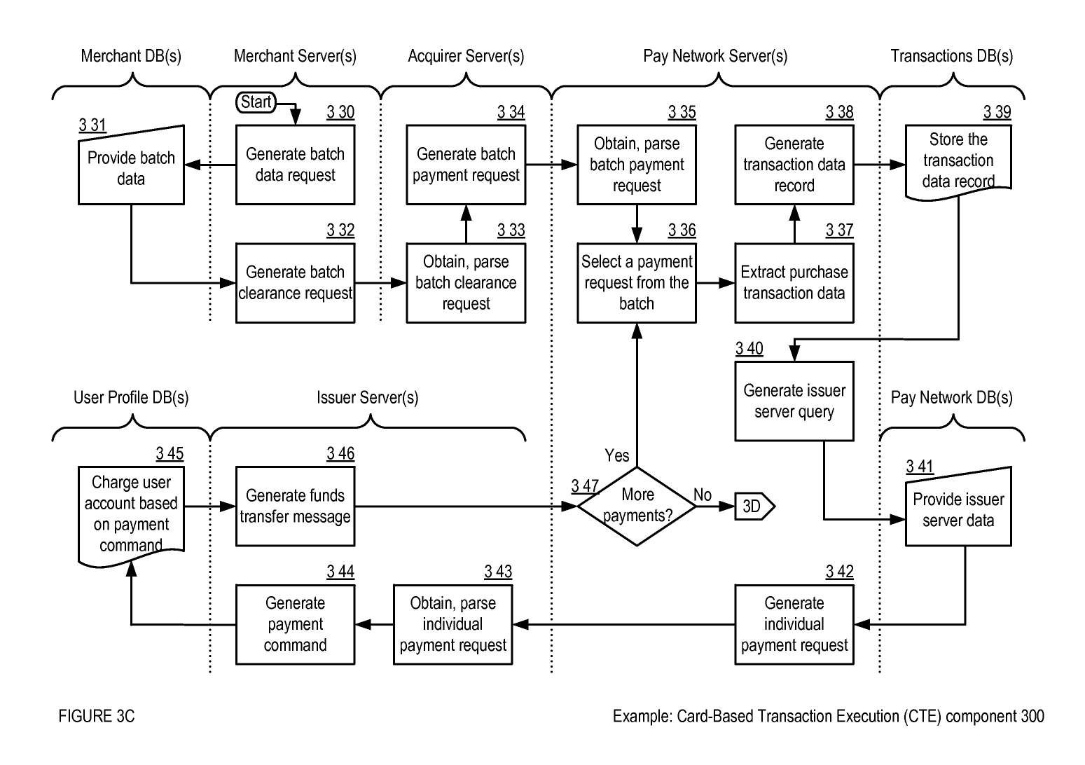

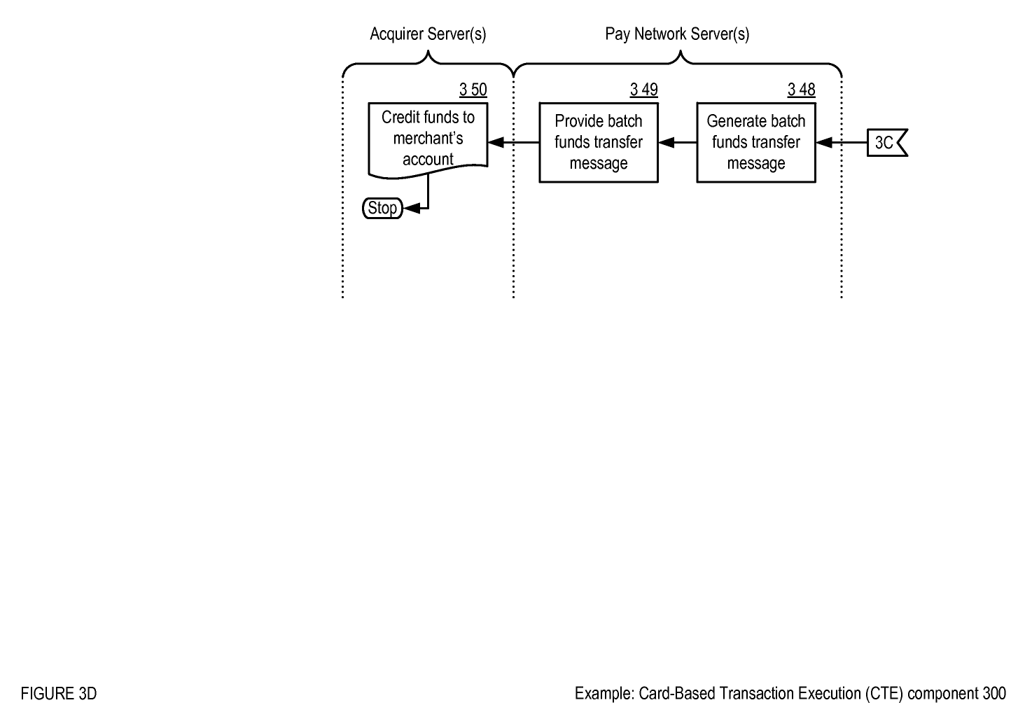

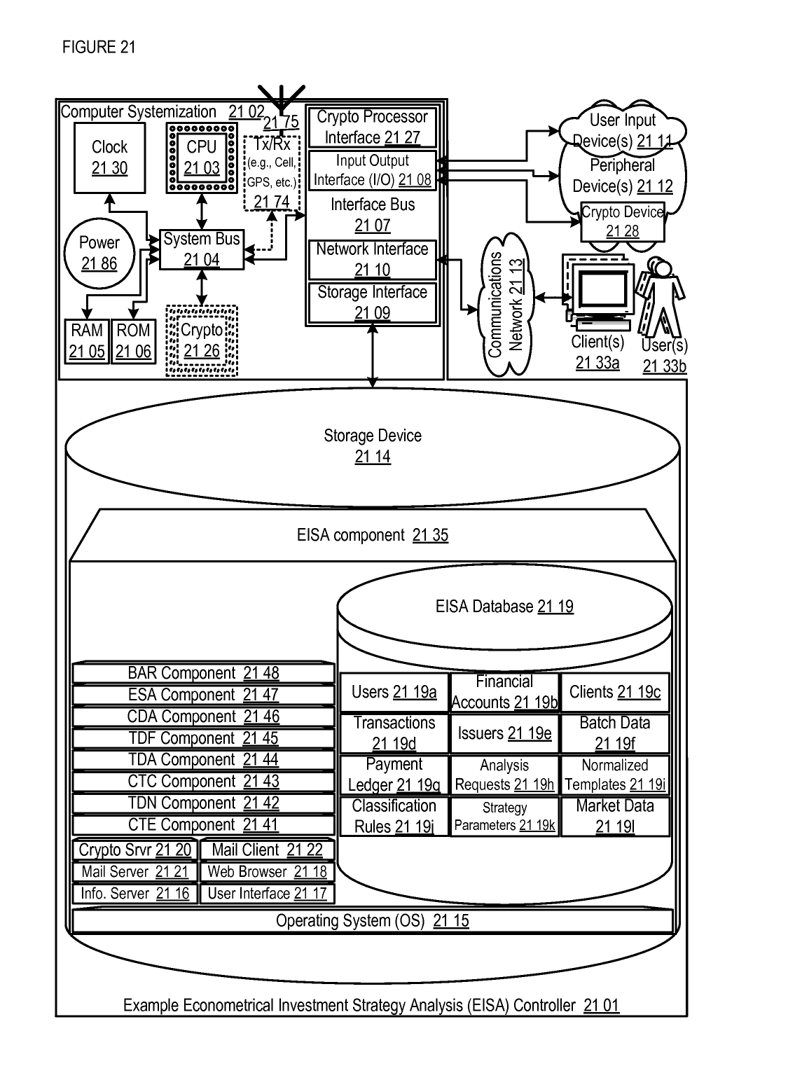

FIGS. 3A-D show logic flow diagrams illustrating example aspects of executing a card-based transaction resulting in generation of raw card-based transaction data in some embodiments of the EISA, e.g., a Card-Based Transaction Execution (“CTE”) component 300. In some implementations, a user may provide user input, e.g., 301, into a client indicating the user's desire to purchase a product from a merchant. The client may generate a purchase order message, e.g., 302, and provide the generated purchase order message to the merchant server. In some implementations, the merchant server may obtain, e.g., 303, the purchase order message from the client, and may parse the purchase order message to extract details of the purchase order from the user. Example parsers that the merchant client may utilize are discussed further below with reference to FIG. 21. The merchant server may generate a card query request, e.g., 304, to determine whether the transaction can be processed. For example, the merchant server may process the transaction only if the user has sufficient funds to pay for the purchase in a card account provided with the purchase order. The merchant server may provide the generated card query request to an acquirer server. The acquirer server may generate a card authorization request, e.g., 306, using the obtained card query request, and provide the card authorization request to a pay network server. In some implementations, the pay network server may obtain the card authorization request from the acquirer server, and may parse the card authorization request to extract details of the request. Using the extracted fields and field values, the pay network server may generate a query, e.g., 308, for an issuer server corresponding to the user's card account. In response to obtaining the issuer server query the pay network database may provide, e.g., 309, the requested issuer server data to the pay network server. In some implementations, the pay network server may utilize the issuer server data to generate a forwarding card authorization request, e.g., 310, to redirect the card authorization request from the acquirer server to the issuer server. The pay network server may provide the card authorization request to the issuer server. In some implementations, the issuer server may parse, e.g., 311, the card authorization request, and based on the request details may query a database, e.g., 312, for data of the user's card account. In response, the database may provide the requested user data. On obtaining the user data, the issuer server may determine whether the user can pay for the transaction using funds available in the account, e.g., 314. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 315, to the pay network server.

In some implementations, the pay network server may obtain the authorization message, and parse the message to extract authorization details. Upon determining that the user possesses sufficient funds for the transaction (e.g., 317, option “Yes”), the pay network server may extract the transaction card from the authorization message and/or card authorization request, e.g., 318, and generate a transaction data record, e.g., 319, using the card transaction details. The pay network server may provide the transaction data record for storage, e.g., 320, to a database. In some implementations, the pay network server may forward the authorization message, e.g., 321, to the acquirer server, which may in turn forward the authorization message, e.g., 322, to the merchant server. The merchant may obtain the authorization message, and parse the authorization message o extract its contents, e.g., 323. The merchant server may determine whether the user possesses sufficient funds in the card account to conduct the transaction. If the merchant server determines that the user possess sufficient funds, e.g., 324, option “Yes,” the merchant server may add the record of the transaction for the user to a batch of transaction data relating to authorized transactions, e.g., 325. The merchant server may also generate a purchase receipt, e.g., 327, for the user. If the merchant server determines that the user does not possess sufficient funds, e.g., 324, option “No,” the merchant server may generate an “authorization fail” message, e.g., 328. The merchant server may provide the purchase receipt or the “authorization fail” message to the client. The client may render and display, e.g., 329, the purchase receipt for the user.

In some implementations, the merchant server may initiate clearance of a batch of authorized transactions by generating a batch data request, e.g., 330, and providing the request to a database. In response to the batch data request, the database may provide the requested batch data, e.g., 331, to the merchant server. The server may generate a batch clearance request, e.g., 332, using the batch data obtained from the database, and provide the batch clearance request to an acquirer server. The acquirer server may generate, e.g., 334, a batch payment request using the obtained batch clearance request, and provide the batch payment request to a pay network server. The pay network server may parse, e.g., 335, the batch payment request, select a transaction stored within the batch data, e.g., 336, and extract the transaction data for the transaction stored in the batch payment request, e.g., 337. The pay network server may generate a transaction data record, e.g., 338, and store the transaction data, e.g., 339, the transaction in a database. For the extracted transaction, the pay network server may generate an issuer server query, e.g., 340, for an address of an issuer server maintaining the account of the user requesting the transaction. The pay network server may provide the query to a database. In response, the database may provide the issuer server data requested by the pay network server, e.g., 341. The pay network server may generate an individual payment request, e.g., 342, for the transaction for which it has extracted transaction data, and provide the individual payment request to the issuer server using the issuer server data from the database.

In some implementations, the issuer server may obtain the individual payment request, and parse, e.g., 343, the individual payment request to extract details of the request. Based on the extracted data, the issuer server may generate a payment command, e.g., 344. For example, the issuer server may issue a command to deduct funds from the user's account (or add a charge to the user's credit card account). The issuer server may issue a payment command, e.g., 345, to a database storing the user's account information. In response, the database may update a data record corresponding to the user's account to reflect the debit/charge made to the user's account. The issuer server may provide a funds transfer message, e.g., 346, to the pay network server after the payment command has been executed by the database.

In some implementations, the pay network server may check whether there are additional transactions in the batch that need to be cleared and funded. If there are additional transactions, e.g., 347, option “Yes,” the pay network server may process each transaction according to the procedure described above. The pay network server may generate, e.g., 348, an aggregated funds transfer message reflecting transfer of all transactions in the batch, and provide, e.g., 349, the funds transfer message to the acquirer server. The acquirer server may, in response, transfer the funds specified in the funds transfer message to an account of the merchant, e.g., 350.

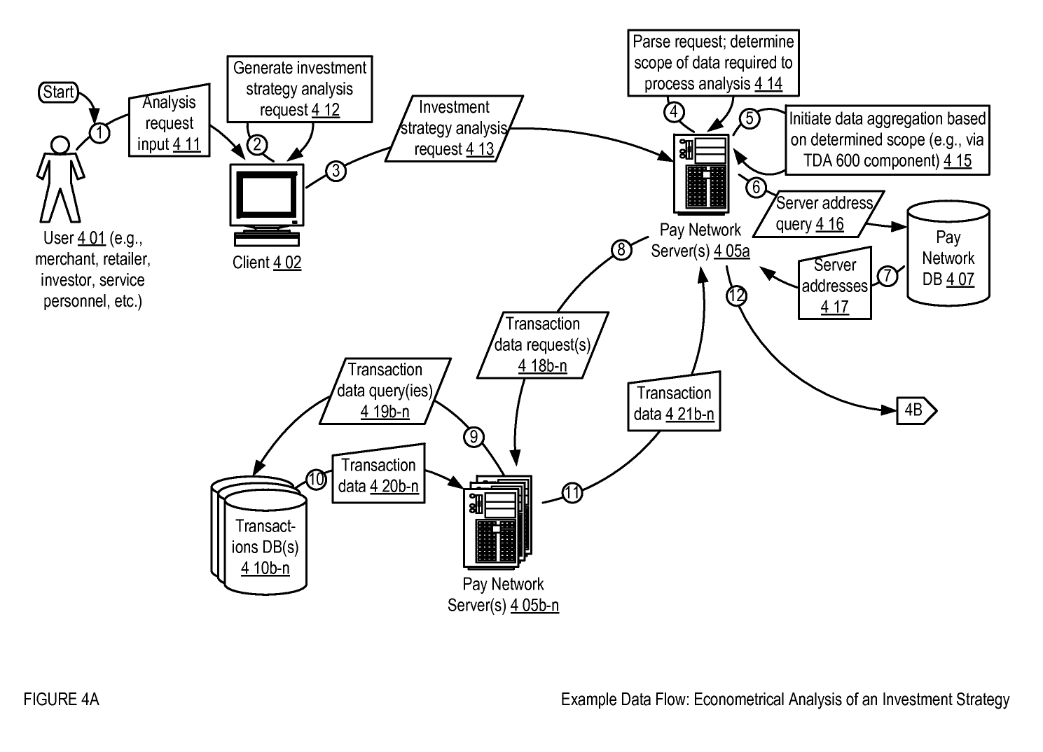

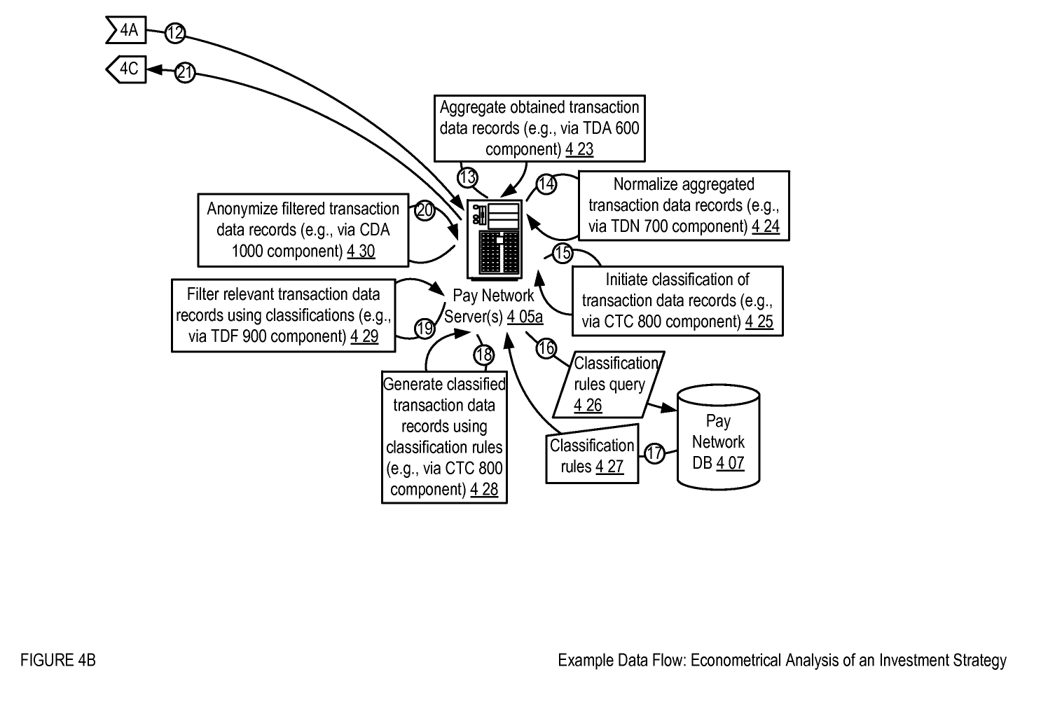

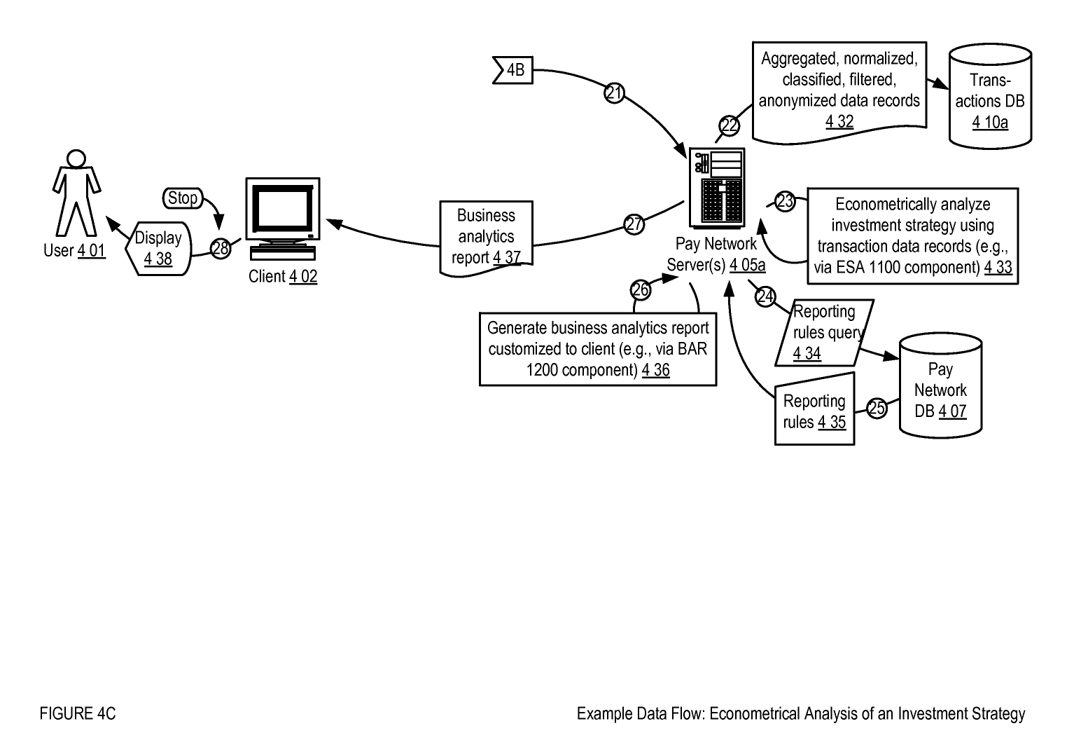

FIGS. 4A-C show data flow diagrams illustrating an example procedure for econometrical analysis of a proposed investment strategy based on card-based transaction data in some embodiments of the EISA. In some implementations, a user, e.g., 401, may desire to obtain an analysis of an investment strategy. For example, the user may be a merchant, a retailer, an investor, a serviceperson, and/or the like provider or products, services, and/or other offerings. The user may communicate with a pay network server, e.g., 405a, to obtain an investment strategy analysis. For example, the user may provide user input, e.g., analysis request input 411, into a client, e.g., 402, indicating the user's desire to request an investment strategy analysis. In various implementations, the user input may include, but not be limited to: keyboard entry, mouse clicks, depressing buttons on a joystick/game console, voice commands, single/multi-touch gestures on a touch-sensitive interface, touching user interface elements on a touch-sensitive display, and/or the like. In some implementations, the client may generate an investment strategy analysis request, e.g., 412, and provide, e.g., 413, the generated investment strategy analysis request to the pay network server. For example, a browser application executing on the client may provide, on behalf of the user, a (Secure) Hypertext Transfer Protocol (“HTTP(S)”) GET message including the investment strategy analysis request in the form of XML-formatted data. Below is an example HTTP(S) GET message including an XML-formatted investment strategy analysis request:

GET /analysisrequest.php HTTP/1.1
Host: www.paynetwork.com
Content-Type: Application/XML
Content-Length: 1306
<?XML version = “1.0” encoding = “UTF-8”?>
<analysis_request>

<request_ID>EJ39FI1F</request_ID>
timestamp>2011-02-24 09:08:11</timestamp>
<user_ID>investor@paynetwork.com</user_ID>
<password>******</password>
<request_details>

<time_period>year 2011</time_period>
<time_interval>month-to-month</time_interval>
<area_scope>United States</area>
<area_resolution>zipcode</area_resolution>
<spend_sector>retail<sub>home
improvement</sub></spend_sector>

</request_details>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>

</analysis_request>

In some implementations, the pay network server may parse the investment strategy analysis request, and determine the type of investment strategy analysis required, e.g., 414.

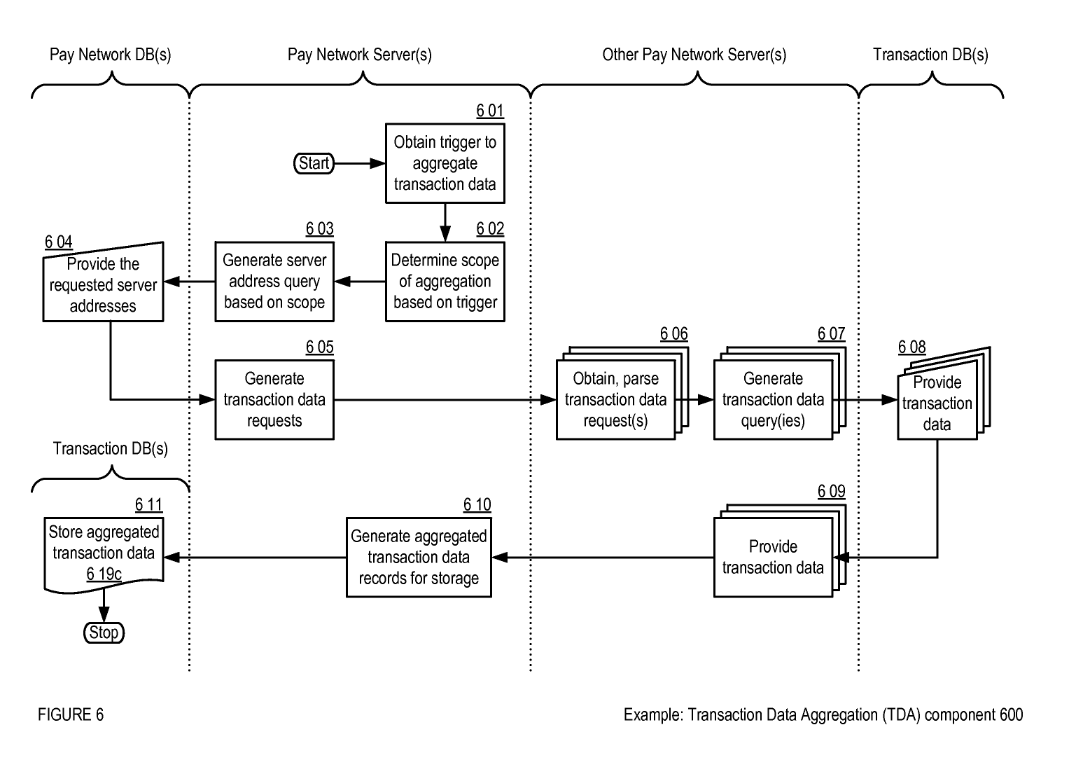

In some implementations, the pay network server may determine a scope of data aggregation required to perform the analysis. The pay network server may initiate data aggregation based on the determined scope, for example, via a Transaction Data Aggregation (“TDA”) component such as described below with reference to FIG. 6. The pay network server may query, e.g., 416, a pay network database, e.g., 407, for addresses of pay network servers that may have stored transaction data within the determined scope of the data aggregation. For example, the pay network server may utilize PHP/SQL commands similar to the examples provided above. The database may provide, e.g., 417, a list of server addresses in response to the pay network server's query. Based on the list of server addresses, the pay network server may issue transaction data requests, e.g., 418b-n, to the other pay network servers, e.g., 405b-n. The other the pay network servers may query their transaction databases, e.g., 410b-n, for transaction data falling within the scope of the transaction data requests. In response to the transaction data queries, e.g., 419b-n, the transaction databases may provide transaction data, e.g., 420b-n, to the other pay network servers. The other pay network servers may return the transaction data obtained from the transactions databases, e.g., 421b-n, to the pay network server making the transaction data requests, e.g., 405a.

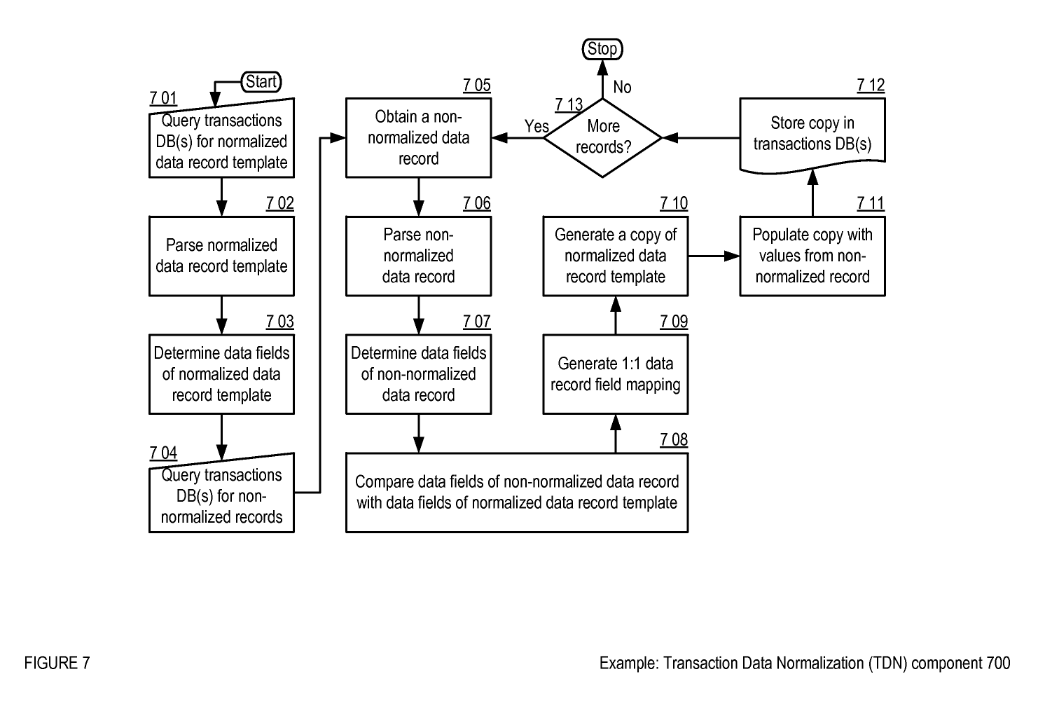

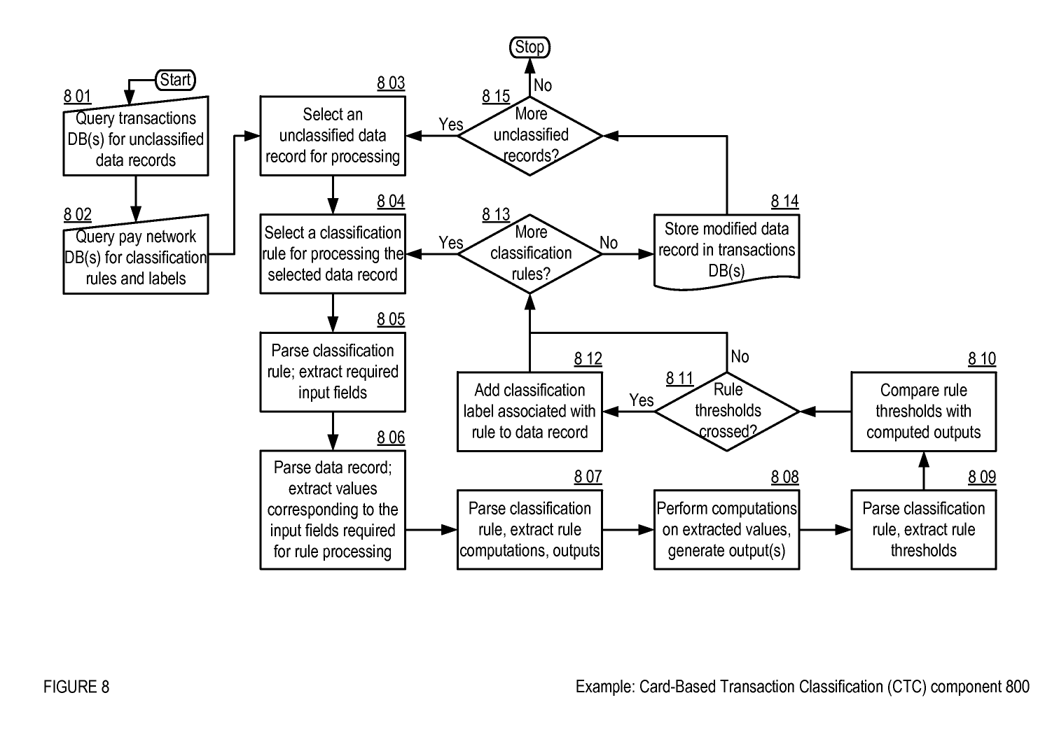

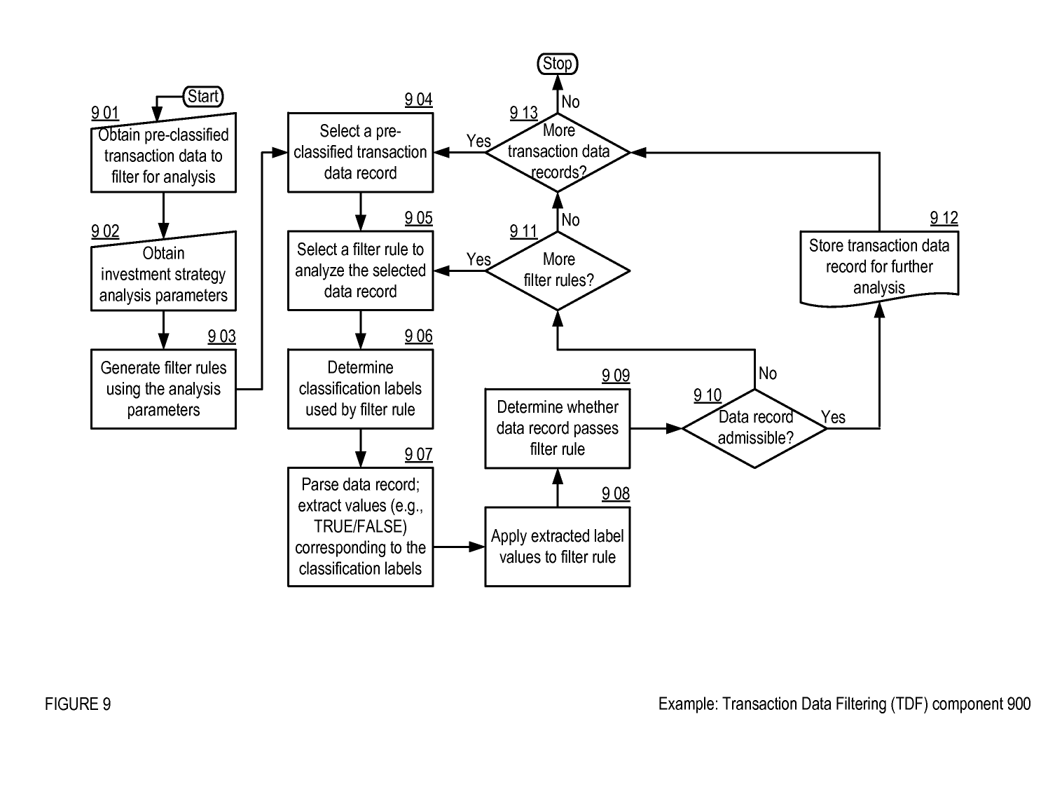

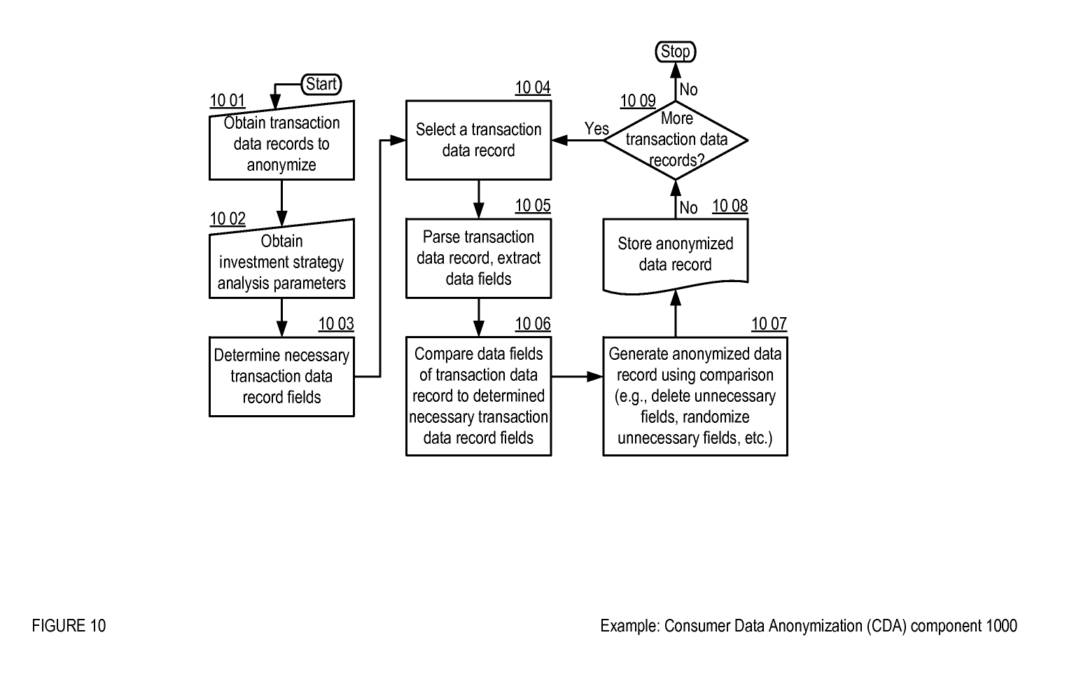

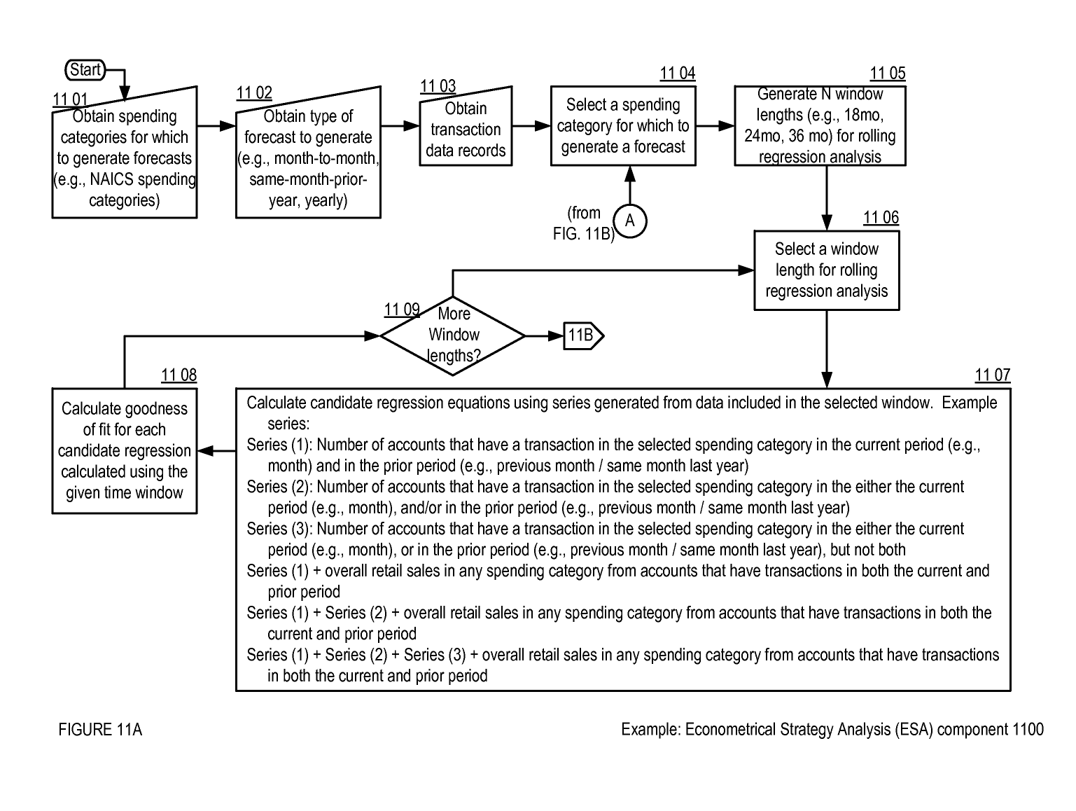

The pay network server 405a may aggregate, e.g., 423, the obtained transaction data records, e.g. via the TDA component. The pay network server may normalize, e.g., 424, the aggregated transaction data so that all the data share a uniform data structure format, e.g., via a Transaction Data Normalization (“TDN”) component such as described below with reference to FIG. 7. The pay network server may generate, e.g., 425-428, one or more classification labels for each of the transaction data records, e.g., via a Card-Based Transaction Classification (“CTC”) component such as described below with reference to FIG. 8. The pay network server may query for classification rules, e.g., 426, a database, e.g., pay network database 407. Upon obtaining the classification rules, e.g., 427, the pay network server may generate, e.g., 428, classified transaction data records using the classification rules, e.g., via the CTC component. The pay network server may filter, e.g., 429, relevant transaction data records using the classification labels, e.g., via a Transaction Data Filtering (“TDF”) component such as described below with reference to FIG. 9. The pay network server may anonymize, e.g., 430, the transaction data records, e.g., via a Consumer Data Anonymization (“CDA”) component such as described below with reference to FIG. 10. The pay network server may, in some implementations, store aggregated, normalized, classified, filtered, and/or anonymized data records, e.g., 432, in a database, e.g., transactions database 410a.

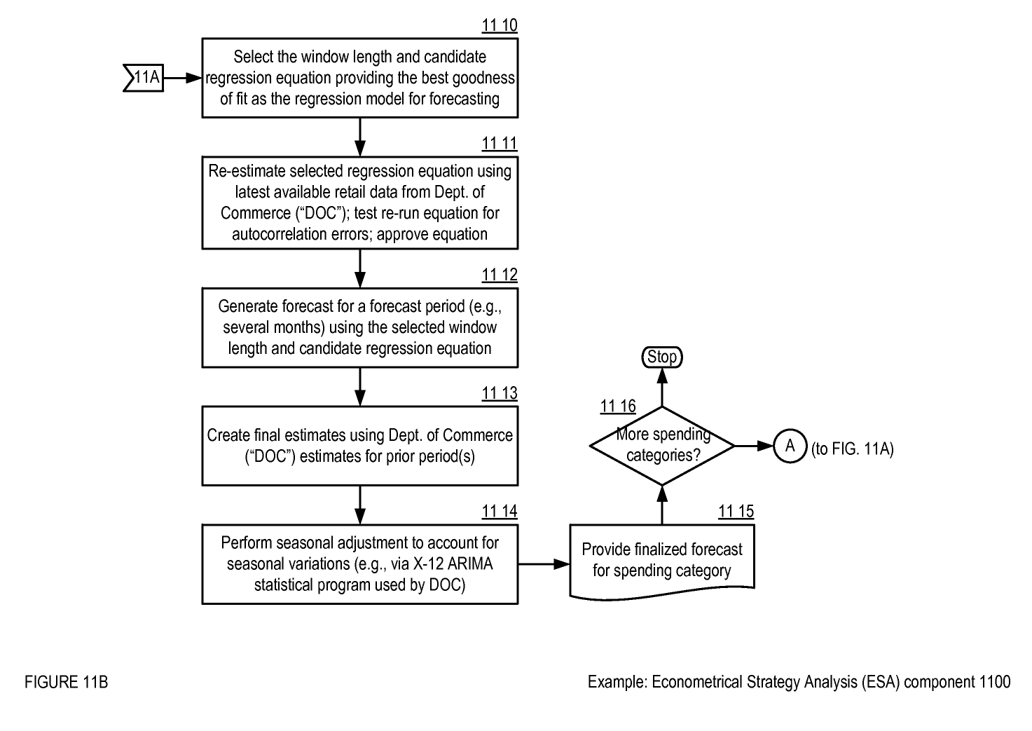

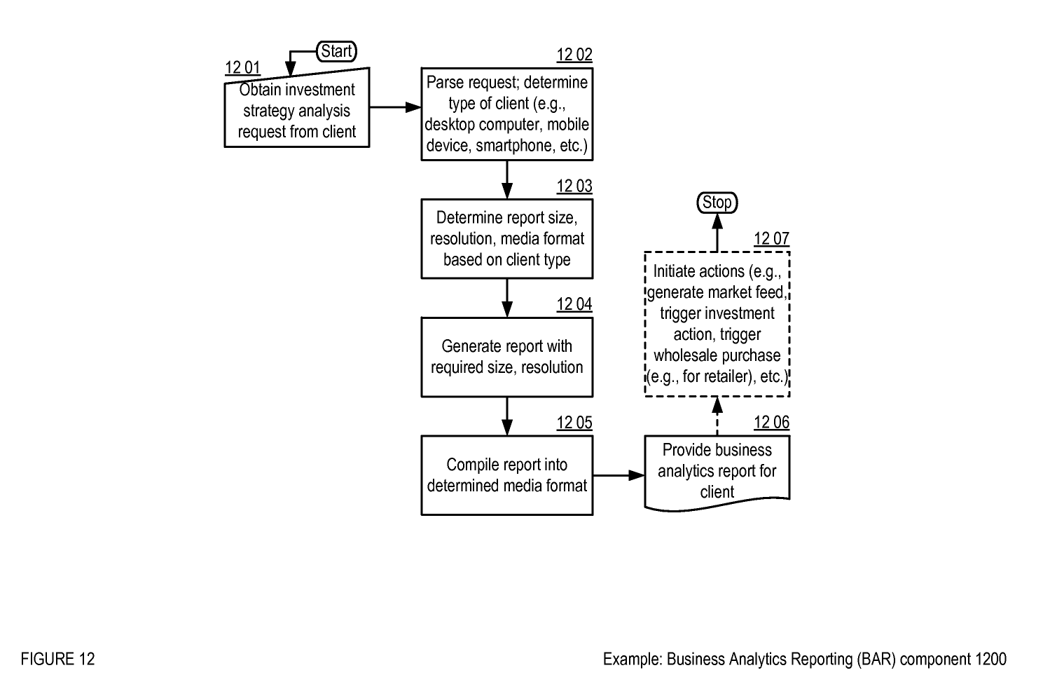

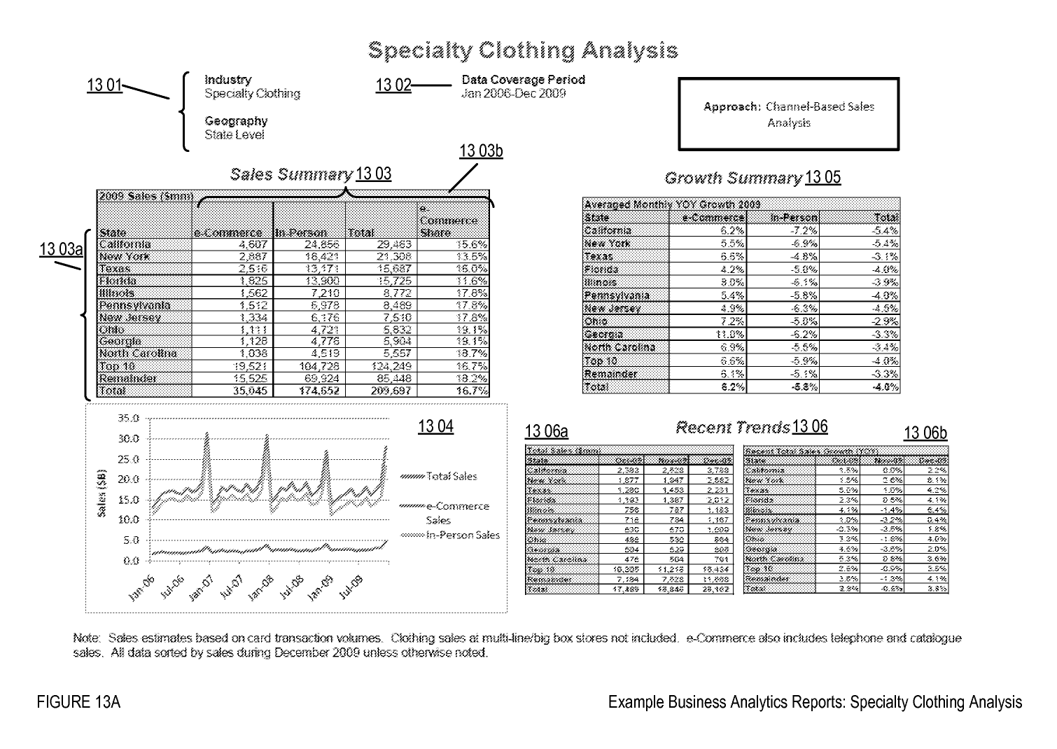

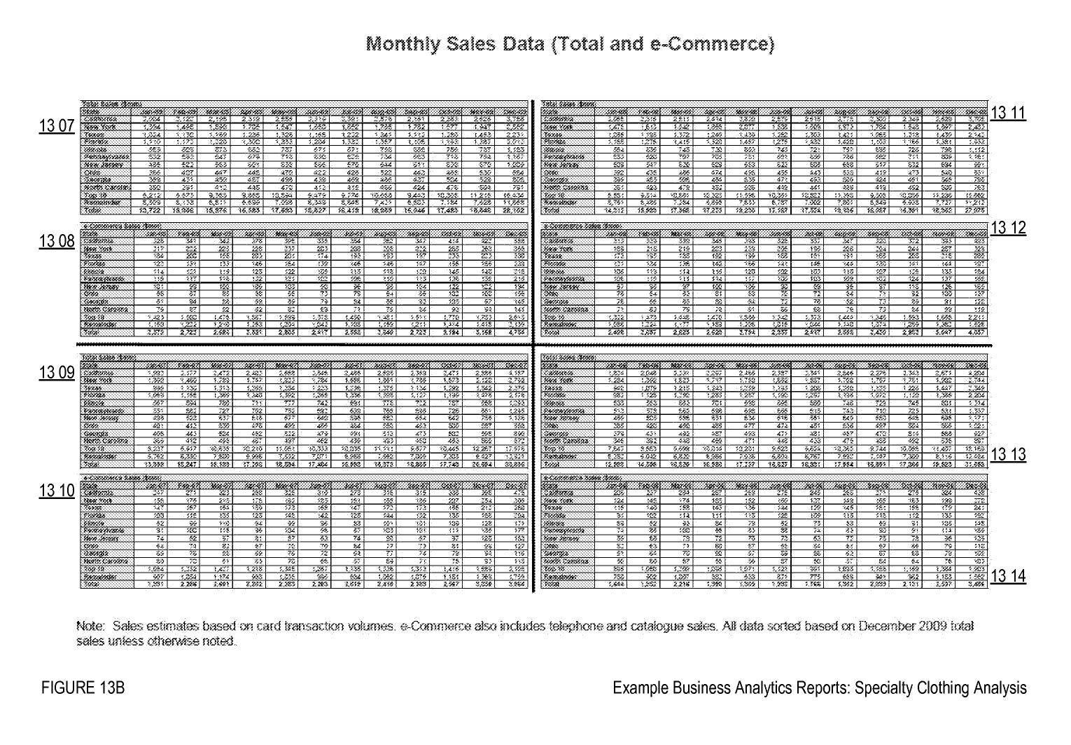

In some implementations, the pay network server may econometrically analyze, e.g., 433, aggregated, normalized, classified, filtered, and/or anonymized data records, e.g., via an Econometrical Strategy Analysis (“ESA”) component such as described below with reference to FIG. 11. The pay network server may prepare a report customized to the client used by the user. The pay network server may provide a reporting rules query to a database, e.g., pay network database 407, for reporting rules to use in preparing the business analytics report. Upon obtaining the reporting rules, e.g., 435, the pay network server may generate a business analytics report customized to the client, e.g., 436, for example via a Business Analytics Reporting (“BAR”) such as described below with reference to FIG. 12. The pay network server may provide the business analytics report, e.g., 437, to the client, e.g., 402. The client may render and display, e.g., 438, the business analytics report for the user.

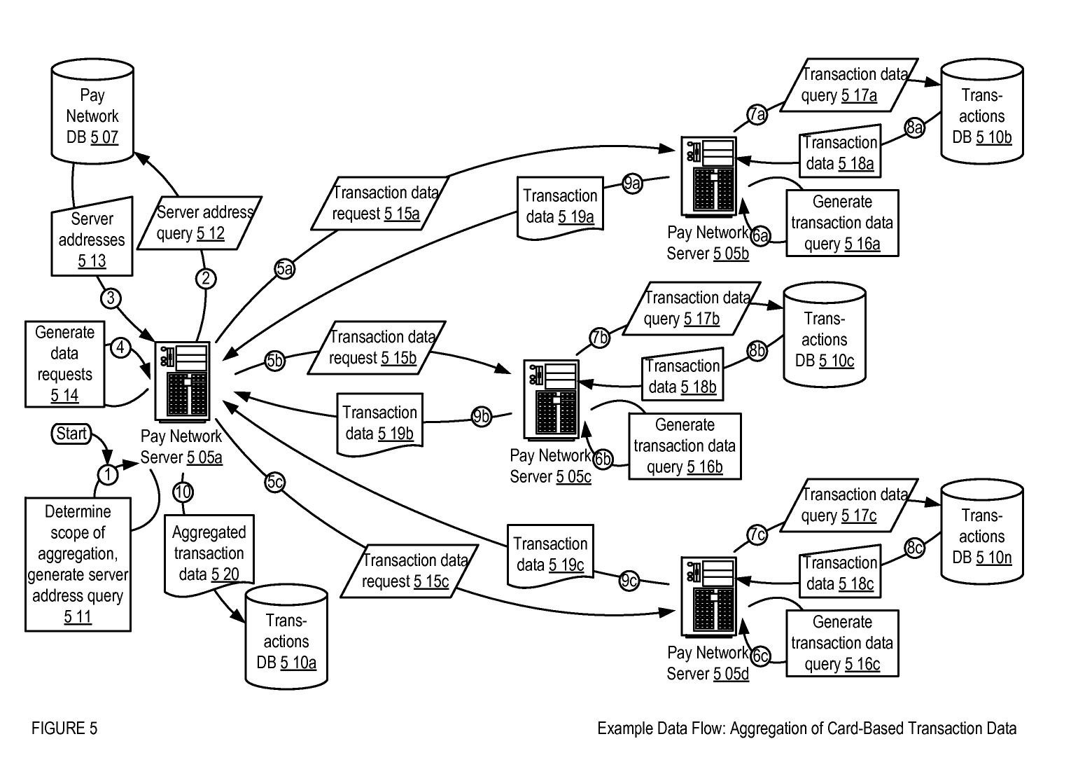

FIG. 5 shows a data flow diagram illustrating an example procedure to aggregate card-based transaction data in some embodiments of the EISA. In some implementations, the pay network server may determine a scope of data aggregation required to perform the analysis, e.g., 511. The pay network server may initiate data aggregation based on the determined scope. The pay network server may generate a query for addresses of server storing transaction data within the determined scope. The pay network server may query, e.g., 512, a pay network database, e.g., 507, for addresses of pay network servers that may have stored transaction data within the determined scope of the data aggregation. For example, the pay network server may utilize PHP/SQL commands similar to the examples provided above. The database may provide, e.g., 513, a list of server addresses in response to the pay network server's query. Based on the list of server addresses, the pay network server may generate transaction data requests, e.g., 514. The pay network server may issue the generated transaction data requests, e.g., 515a-c, to the other pay network servers, e.g., 505b-d. The other pay network servers may query, e.g., 517a-c, their transaction databases, e.g., 510b-d, for transaction data falling within the scope of the transaction data requests. In response to the transaction data queries, the transaction databases may provide transaction data, e.g., 518a-c, to the other pay network servers. The other pay network servers may return the transaction data obtained from the transactions databases, e.g., 519a-c, to the pay network server making the transaction data requests, e.g., 505a. The pay network server, e.g., 505a, may store the aggregated transaction data, e.g., 52o, in a database, e.g., 510a.

FIG. 6 shows a logic flow diagram illustrating example aspects of aggregating card-based transaction data in some embodiments of the EISA, e.g., a Transaction Data Aggregation (“TDA”) component 600. In some implementations, a pay network server may obtain a trigger to aggregate transaction data, e.g., 601. For example, the server may be configured to initiate transaction data aggregation on a regular, periodic, basis (e.g., hourly, daily, weekly, monthly, quarterly, semi-annually, annually, etc.). As another example, the server may be configured to initiate transaction data aggregation on obtaining information that the U.S. Government (e.g., Department of Commerce, Office of Management and Budget, etc) has released new statistical data related to the U.S. business economy. As another example, the server may be configured to initiate transaction data aggregation on-demand, upon obtaining a user investment strategy analysis request for processing. The pay network server may determine a scope of data aggregation required to perform the analysis, e.g., 602. For example, the scope of data aggregation may be pre-determined. As another example, the scope of data aggregation may be determined based on a received user investment strategy analysis request. The pay network server may initiate data aggregation based on the determined scope. The pay network server may generate a query for addresses of server storing transaction data within the determined scope, e.g., 603. The pay network server may query a database for addresses of pay network servers that may have stored transaction data within the determined scope of the data aggregation. The database may provide, e.g., 604, a list of server addresses in response to the pay network server's query. Based on the list of server addresses, the pay network server may generate transaction data requests, e.g., 605. The pay network server may issue the generated transaction data requests to the other pay network servers. The other pay network servers may obtain and parse the transaction data requests, e.g., 606. Based on parsing the data requests, the other pay network servers may generate transaction data queries, e.g., 607, and provide the transaction data queries to their transaction databases. In response to the transaction data queries, the transaction databases may provide transaction data, e.g., 608, to the other pay network servers. The other pay network servers may return, e.g., 609, the transaction data obtained from the transactions databases to the pay network server making the transaction data requests. The pay network server may generate aggregated transaction data records from the transaction data received from the other pay network servers, e.g., 610, and store the aggregated transaction data in a database, e.g., 611.

FIG. 7 shows a logic flow diagram illustrating example aspects of normalizing raw card-based transaction data into a standardized data format in some embodiments of the EISA, e.g., a Transaction Data Normalization (“TDN”) component 700. In some implementations, a pay network server (“server”) may attempt to convert any transaction data records stored in a database it has access to in a normalized data format. For example, the database may have a transaction data record template with predetermined, standard fields that may store data in pre-defined formats (e.g., long integer/double float/4 digits of precision, etc.) in a pre-determined data structure. A sample XML transaction data record template is provided below:

<?XML version = “1.0” encoding = “UTF-8”?>
<transaction_record>

<record_ID>00000000</record_ID>
<norm_flag>false</norm_flag>
<timestamp>yyyy-mm-dd hh:mm:ss</timestamp>
<transaction_cost>$0,000,000,00/transaction_cost>
<merchant_params>

<merchant_id>00000000</merchant_id>
<merchant_name>TBD</merchant_name>
<merchant_auth_key>0000000000000000</merchant_auth_key>

</merchant_params>
<merchant_products>

<num_products>000</num_products>
<product>

<product_type>TBD</product_type>
<product_name>TBD</product_name>
<class_labels_list>TBD<class_labels_list>
<product_quantity>000</product_quantity>
<unit_value>$0,000,000.00</unit_value>
<sub_total>$0,000,000.00</sub_total>
<comment>normalized transaction data record template</comment>

</product>

</merchant_products>
<user_account_params>

<account_name>JTBD</account_name>
<account_type>TBD</account_type>
<account_num>0000000000000000</account_num>
<billing_line1>TBD</billing_line1>
<billing_line2>TBD</billing_line2>
<zipcode>TBD</zipcode>
<state>TBD</state>
<country>TBD</country>
<phone>00-00-000-000-0000</phone>
<sign>TBD</sign>

</user_account_params>

</transaction_record>

In some implementations, the server may query a database for a normalized transaction data record template, e.g., 701. The server may parse the normalized data record template, e.g., 702. Based on parsing the normalized data record template, the server may determine the data fields included in the normalized data record template, and the format of the data stored in the fields of the data record template, e.g., 703. The server may obtain transaction data records for normalization. The server may query a database, e.g., 704, for non-normalized records. For example, the server may issue PHP/SQL commands to retrieve records that do not have the ‘norm_flag’ field from the example template above, or those where the value of the ‘norm_flag’ field is ‘false’. Upon obtaining the non-normalized transaction data records, the server may select one of the non-normalized transaction data records, e.g., 705. The server may parse the non-normalized transaction data record, e.g., 706, and determine the fields present in the non-normalized transaction data record, e.g., 707. The server may compare the fields from the non-normalized transaction data record with the fields extracted from the normalized transaction data record template. For example, the server may determine whether the field identifiers of fields in the non-normalized transaction data record match those of the normalized transaction data record template, (e.g., via a dictionary, thesaurus, etc.), are identical, are synonymous, are related, and/or the like. Based on the comparison, the server may generate a 1:1 mapping between fields of the non-normalized transaction data record match those of the normalized transaction data record template, e.g., 709. The server may generate a copy of the normalized transaction data record template, e.g., 710, and populate the fields of the template using values from the non-normalized transaction data record, e.g., 711. The server may also change the value of the ‘norm_flag’ field to ‘true’ in the example above. The server may store the populated record in a database (for example, replacing the original version), e.g., 712. The server may repeat the above procedure for each non-normalized transaction data record (see e.g., 713), until all the non-normalized transaction data records have been normalized.

FIG. 8 shows a logic flow diagram illustrating example aspects of generating classification labels for card-based transactions in some embodiments of the EISA, e.g., a Card-Based Transaction Classification (“CTC”) component 800. In some implementations, a server may apply one or more classification labels to each of the transaction data records. For example, the server may classify the transaction data records, according to criteria such as, but not limited to: geo-political area, luxury level of the product, industry sector, number of items purchased in the transaction, and/or the like. The server may obtain transactions from a database that are unclassified, e.g., 801, and obtain rules and labels for classifying the records, e.g., 802. For example, the database may store classification rules, such as the exemplary illustrative XML-encoded classification rule provided below:

<rule>

<id>NAICS44_45</id>
<name>NAICS - Retail Trade</name>
<inputs>merchant_id</inputs>
<operations>

<1>label = ‘null’</1>
<1>cat = NAICS_LOOKUP (merchant_id)</1>
<2>IF (cat == 44 || cat ==45) label = ‘retail trade’</2>

</operations>
<outputs>label</outputs>

</rule>

The server may select an unclassified data record for processing, e.g., 803. The server may also select a classification rule for processing the unclassified data record, e.g., 804. The server may parse the classification rule, and determine the inputs required for the rule, e.g., 805. Based on parsing the classification rule, the server may parse the normalized data record template, e.g., 806, and extract the values for the fields required to be provided as inputs to the classification rule. For example, to process the rule in the example above, the server may extract the value of the field ‘merchant_id’ from the transaction data record. The server may parse the classification rule, and extract the operations to be performed on the inputs provided for the rule processing, e.g., 807. Upon determining the operations to be performed, the server may perform the rule-specified operations on the inputs provided for the classification rule, e.g., 808. In some implementations, the rule may provide threshold values. For example, the rule may specify that if the number of products in the transaction, total value of the transaction, average luxury rating of the products sold in the transaction, etc. may need to cross a threshold in order for the label(s) associated with the rule to be applied to the transaction data record. The server may parse the classification rule to extract any threshold values required for the rule to apply, e.g., 809. The server may compare the computed values with the rule thresholds, e.g., 810. If the rule threshold(s) is crossed, e.g., 811, option “Yes,” the server may apply one or more labels to the transaction data record as specified by the classification rule, e.g., 812. For example, the server may apply a classification rule to an individual product within the transaction, and/or to the transaction as a whole. In some implementations, the server may process the transaction data record using each rule (see, e.g., 813). Once all classification rules have been processed for the transaction record, e.g., 813, option “No,” the server may store the transaction data record in a database, e.g., 814. The server may perform such processing for each transaction data record until all transaction data records have been classified (see, e.g., 815).

FIG. 9 shows a logic flow diagram illustrating example aspects of filtering card-based transaction data for econometrical investment strategy analysis in some embodiments of the EISA, e.g., a Transaction Data Filtering (“TDF”) component 900. In some implementations, a server may filter transaction data records prior to econometrical investment strategy analysis based on classification labels applied to the transaction data records. For example, the server may filter the transaction data records, according to criteria such as, but not limited to: geo-political area, luxury level of the product, industry sector, number of items purchased in the transaction, and/or the like. The server may obtain transactions from a database that are classified, e.g., 901, and investment strategy analysis parameters, e.g., 902. Based on the analysis parameters, the server may generate filter rules for the transaction data records, e.g., 903. The server may select a classified data record for processing, e.g., 904. The server may also select a filter rule for processing the classified data record, e.g., 905. The server may parse the filter rule, and determine the classification labels required for the rule, e.g., 906. Based on parsing the classification rule, the server may parse the classified data record, e.g., 907, and extract values for the classification labels (e.g., true/false) required to process the filter rule. The server may apply the classification labels values to the filter rule, e.g., 908, and determine whether the transaction data record passes the filter rule, e.g., 909. If the data record is admissible in view of the filter rule, e.g., 910, option “Yes,” the server may store the transaction data record for further analysis, e.g., 912. If the data record is not admissible in view of the filter rule, e.g., 910, option “No,” the server may select another filter rule to process the transaction data record. In some implementations, the server may process the transaction data record using each rule (see, e.g., 911) until all rules are exhausted. The server may perform such processing for each transaction data record until all transaction data records have been filtered (see, e.g., 913).

FIG. 10 shows a logic flow diagram illustrating example aspects of anonymizing consumer data from card-based transactions for econometrical investment strategy analysis in some embodiments of the EISA, e.g., a Consumer Data Anonymization (“CDA”) component woo. In some implementations, a server may remove personal information relating to the user (e.g., those fields that are not required for econometrical investment strategy analysis) and/or merchant from the transaction data records. For example, the server may truncate the transaction data records, fill randomly generated values in the fields comprising personal information, and/or the like. The server may obtain transactions from a database that are to be anonymized, e.g., 1001, and investment strategy analysis parameters, e.g., 1002. Based on the analysis parameters, the server may determine the fields that are necessary for econometrical investment strategy analysis, e.g., 1003. The server may select a transaction data record for processing, e.g., 1004. The server may parse the transaction data record, e.g., 1005, and extract the data fields in the transactions data records. The server may compare the data fields of the transaction data record with the fields determined to be necessary for the investment strategy analysis, e.g., 1006. Based on the comparison, the server may remove any data fields from the transaction data record, e.g., those that are not necessary for the investment strategy analysis, and generate an anonymized transaction data record, e.g., 1007. The server may store the anonymized transaction data record in a database, e.g., 1008. In some implementations, the server may process each transaction data record (see, e.g., 1009) until all the transaction data records have been anonymized.

FIGS. 11A-B show logic flow diagrams illustrating example aspects of econometrically analyzing a proposed investment strategy based on card-based transaction data in some embodiments of the EISA, e.g., an Econometrical Strategy Analysis (“ESA”) component 1100. In some implementations, the server may obtain spending categories (e.g., spending categories as specified by the North American Industry Classification System (“NAICS”)) for which to generate estimates, e.g., 1101. The server may also obtain the type of forecast (e.g., month-to-month, same-month-prior-year, yearly, etc.) to be generated from the econometrical investment strategy analysis, e.g., 1102. In some implementations, the server may obtain the transaction data records using which the server may perform econometrical investment strategy analysis, e.g., 1103. For example, the server may select a spending category (e.g., from the obtained list of spending categories) for which to generate the forecast, e.g., 1104. For example, the forecast series may be several aggregate series (described below) and the 12 spending categories in the North American Industry Classification System (NAICS) such as department stores, gasoline, and so on, that may be reported by the Department of Commerce (DOC).

To generate the forecast, the server may utilize a random sample of transaction data (e.g., approximately 6% of all transaction data within the network of pay servers), and regression analysis to generate model equations for calculating the forecast from the sample data. For example, the server may utilize distributed computing algorithms such as Google MapReduce. Four elements may be considered in the estimation and forecast methodologies: (a) rolling regressions; (b) selection of the data sample (“window”) for the regressions; (c) definition of explanatory variables (selection of accounts used to calculate spending growth rates); and (d) inclusion of the explanatory variables in the regression equation (“candidate” regressions) that may be investigated for forecasting accuracy. The dependent variable may be, e.g., the growth rate calculated from DOC revised sales estimates published periodically. Rolling regressions may be used as a stable and reliable forecasting methodology. A rolling regression is a regression equation estimated with a fixed length data sample that is updated with new (e.g., monthly) data as they become available. When a new data observation is added to the sample, the oldest observation is dropped, causing the total number of observations to remain unchanged. The equation may be estimated with the most recent data, and may be re-estimated periodically (e.g., monthly). The equation may then be used to generate a one-month ahead forecast for year-over-year or month over month sales growth.

Thus, in some implementations, the server may generate N window lengths (e.g., 18 mo, 24 mo, 36 mo) for rolling regression analysis, e.g., 1105. For each of the candidate regressions (described below), various window lengths may be tested to determine which would systemically provide the most accurate forecasts. For example, the server may select a window length may be tested for rolling regression analysis, e.g., 1106. The server may generate candidate regression equations using series generated from data included in the selected window, e.g., 1107. For example, the server may generate various series, such as, but not limited to:

Series (1): Number of accounts that have a transaction in the selected spending category in the current period (e.g., month) and in the prior period (e.g., previous month/same month last year);

Series (2): Number of accounts that have a transaction in the selected spending category in the either the current period (e.g., month), and/or in the prior period (e.g., previous month/same month last year);

Series (3): Number of accounts that have a transaction in the selected spending category in the either the current period (e.g., month), or in the prior period (e.g., previous month/same month last year), but not both;

Series (4): Series (1)+overall retail sales in any spending category from accounts that have transactions in both the current and prior period;

Series (5): Series (1)+Series (2)+overall retail sales in any spending category from accounts that have transactions in both the current and prior period; and

Series (6): Series (1)+Series (2)+Series (3)+overall retail sales in any spending category from accounts that have transactions in both the current and prior period.

In some implementations, the server may calculate several (e.g., six) candidate regression equations for each of the series. For example, the server may calculate the coefficients for each of the candidate regression equations. The server may calculate a value of goodness of fit to the data for each candidate regression equations, e.g., 1108. For example, two measures of goodness of fit may be used: (1) out-of-sample (simple) correlation; and (2) minimum absolute deviation of the forecast from revised DOC estimates. In some implementations, various measures of goodness of fit may be combined to create a score. In some implementations, candidate regression equations may be generated using rolling regression analysis with each of the N generated window lengths (see, e.g., 1109). In some implementations, upon generation of all the candidate regression equations and their corresponding goodness of fit scores, the equation (s) with the best score is chosen as the model equation for forecasting, e.g., 1110. In some implementations, the equation (s) with the highest score is then re-estimated using latest retail data available, e.g., from the DOC, e.g., 1111. The rerun equations may be tested for auto correlated errors. If the auto correlation test is statistically significant then the forecasts may include an autoregressive error component, which may be offset based on the autocorrelation test.

In some implementations, the server may generate a forecast for a specified forecast period using the selected window length and the candidate regression equation, e.g., 1112. The server may create final estimates for the forecast using DOC estimates for prior period(s), e.g., 1113. For example, the final estimates (e.g., Fₜ^{Y}-year-over-year growth, Fₜ^{M}-month-over-month growth) may be calculated by averaging month-over-month and year-over-year estimates, as follows:

Dₜ^{Y}=(1+Gₜ^{Y})·Rₜ₋₁₂

Dₜ^{M}=(1+Gₜ^{M})·Aₜ₋₁

Dₜ=Mean(Dₜ^{M},Dₜ^{Y})

Bₜ₋₁^{Y}=(1+Gₜ₋₁^{Y})·Rₜ₋₁₃

Bₜ₋₁^{M}=Aₜ₋₁

Bₜ₋₁=Mean (Bₜ₋₁^{M},Bₜ₋₁^{Y})

Fₜ^{Y}=Dₜ/Rₜ₋₁₂−1

Fₜ^{M}=Dₜ/Bₜ₋₁−1

Here, G represents the growth rates estimated by the regressions for year (superscript Y) or month (superscript M), subscripts refer to the estimate period, t is the current forecasting period); R represents the DOC revised dollar sales estimate; A represents the DOC advance dollar estimate; D is a server-generated dollar estimate, B is a base dollar estimate for the previous period used to calculate the monthly growth forecast.

In some implementations, the server may perform a seasonal adjustment to the final estimates to account for seasonal variations, e.g., 1114. For example, the server may utilize the X-12 ARIMA statistical program used by the DOC for seasonal adjustment. The server may then provide the finalized forecast for the selected spending category, e.g., 1115. Candidate regressions may be similarly run for each spending category of interest (see, e.g., 1116).

FIG. 12 shows a logic flow diagram illustrating example aspects of reporting business analytics derived from an econometrical analysis based on card-obased transaction data in some embodiments of the EISA, e.g., a Business Analytics Reporting (“BAR”) component 1200. In some implementations, the server may customize a business analytics report to the attributes of a client of the user requesting the investment strategy analysis. The server may obtain an investment strategy analysis request from a client. The request may include details about the client such as, but not limited to: client_type, client_IP, client_model, client_OS, app_installed_flag, and/or the like. The server may parse the request, e.g., 1202, and determine the type of client (e.g., desktop computer, mobile device, smartphone, etc.). Based on the type of client, the server may determine attributes of the business analytics report, including but not limited to: report size; report resolution, media format, and/or the like, e.g., 1203. The server may generate the business analytics report according to the determined attributes, e.g., 1204. The server may compile the report into a media format according to the attributes of the client, e.g., 1205, and provide the business analytics report for the client, e.g., 1206. Optionally, in some implementations, the server may initiate actions (e.g., generate a market data feed, trigger an investment action, trigger a wholesale purchase of goods for a retailer, etc.) based on the business analytics report and/or data utilized in preparing the business analytics report, e.g., 1207.

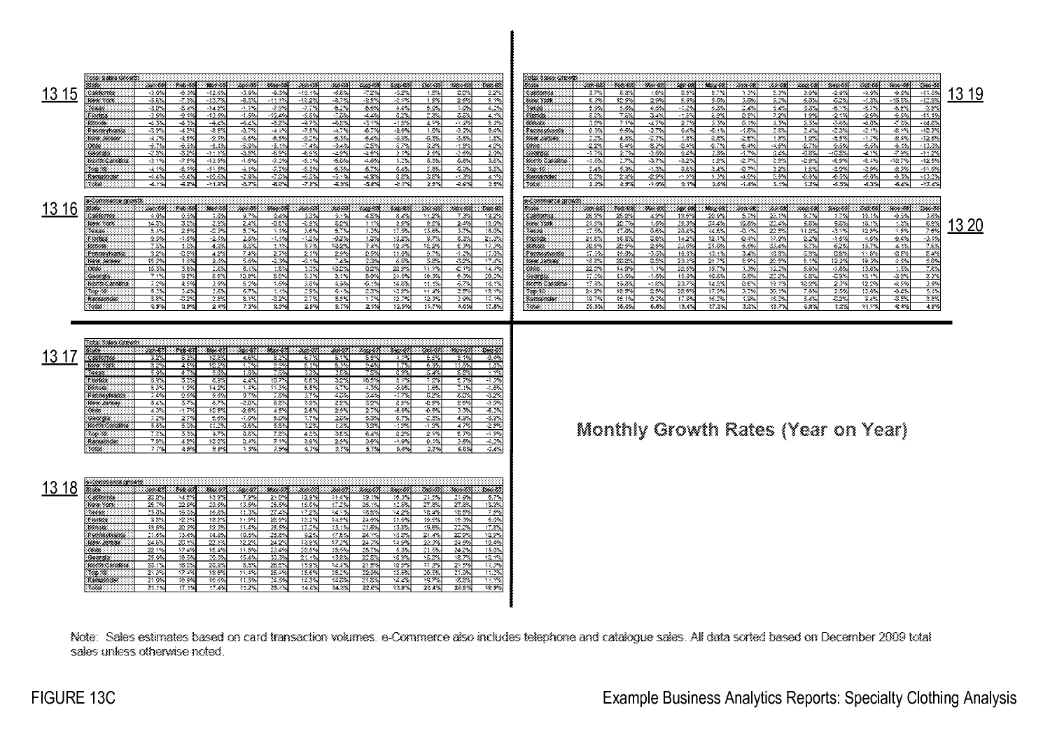

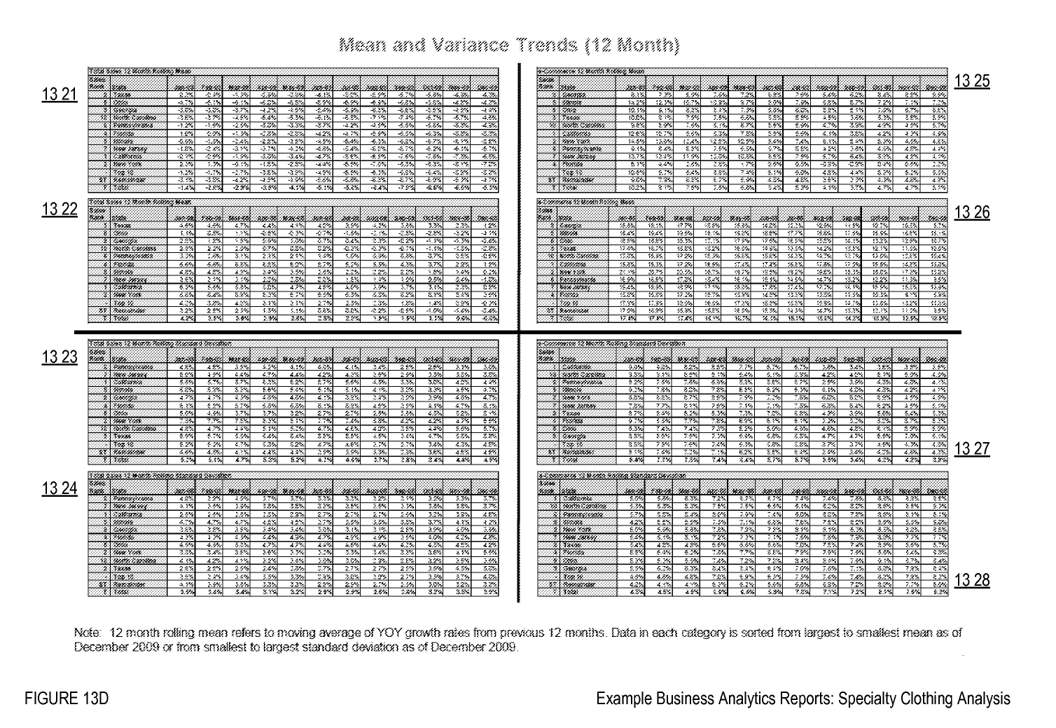

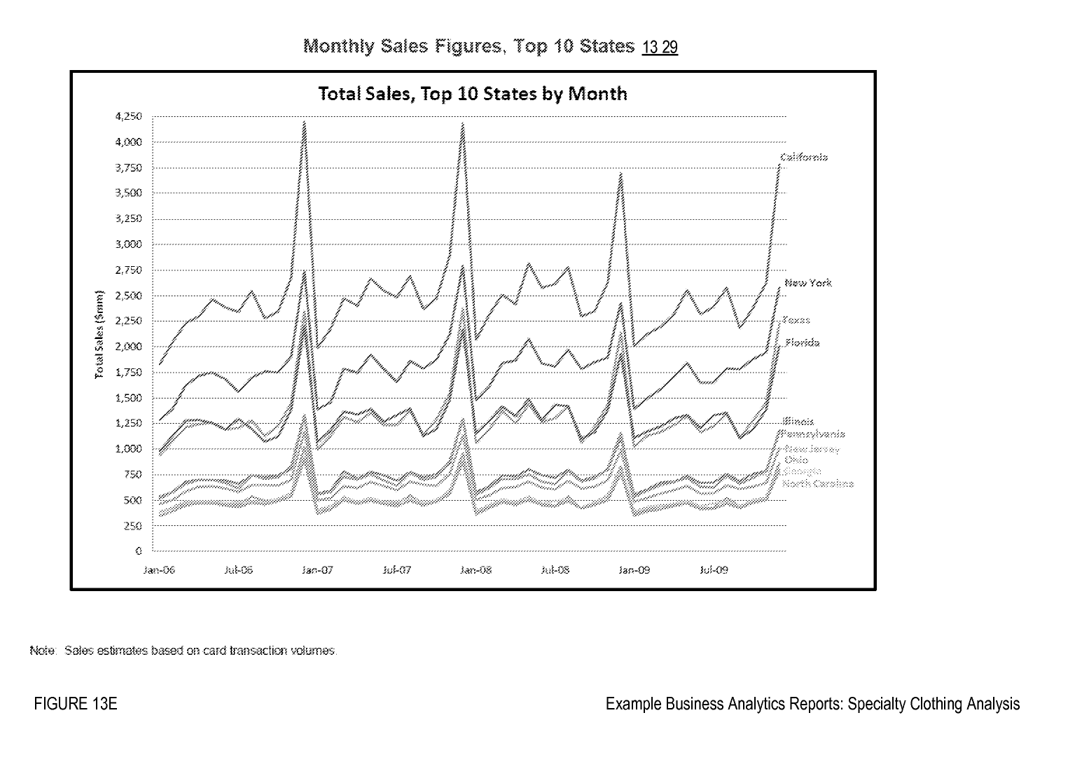

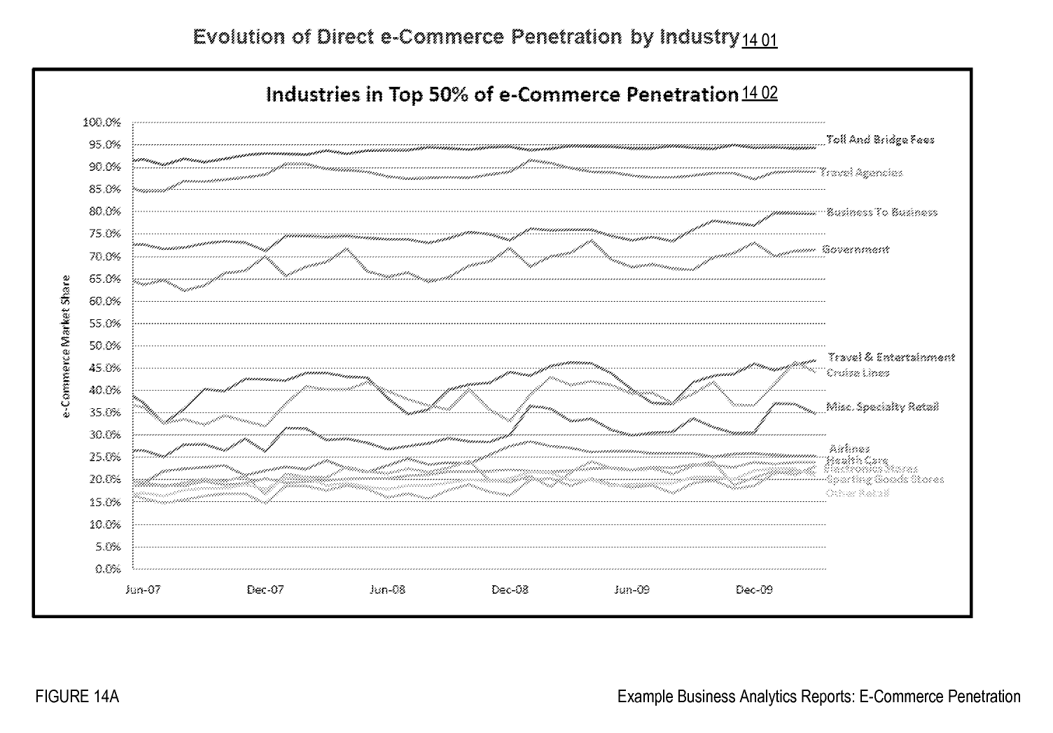

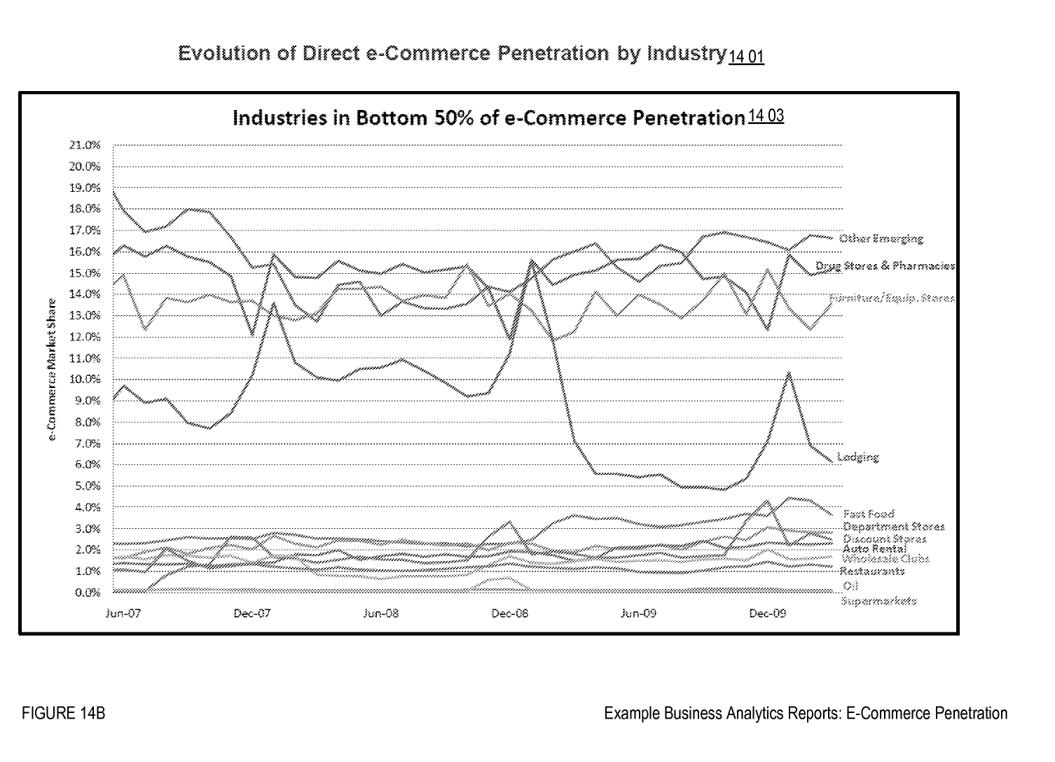

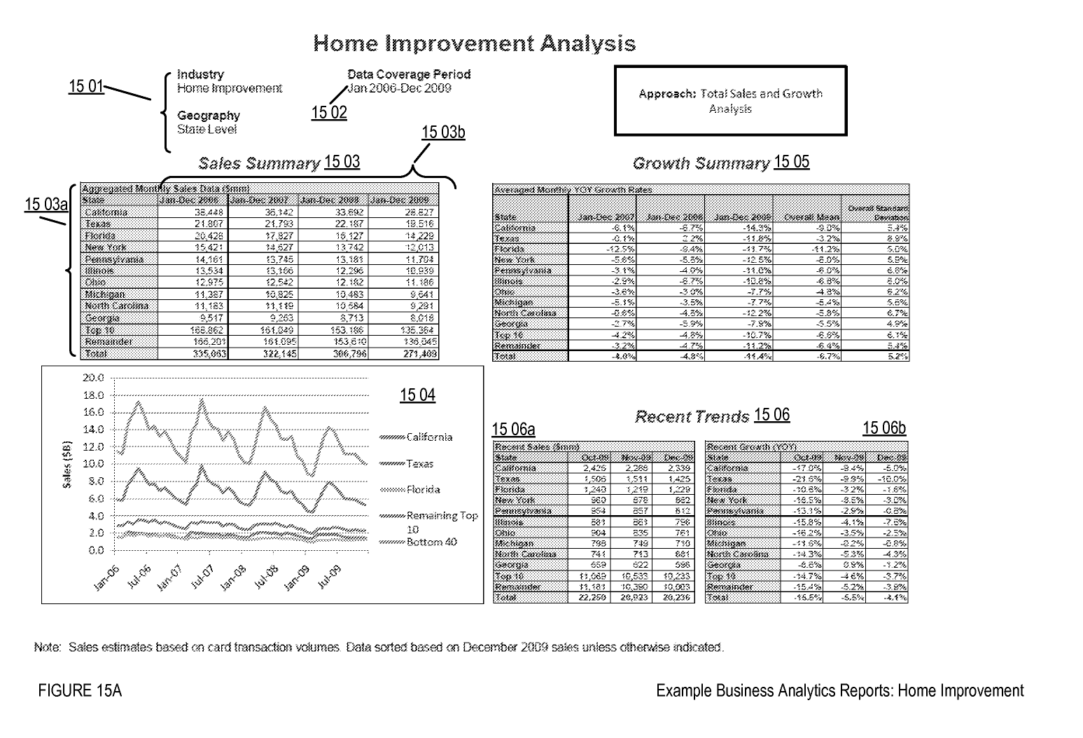

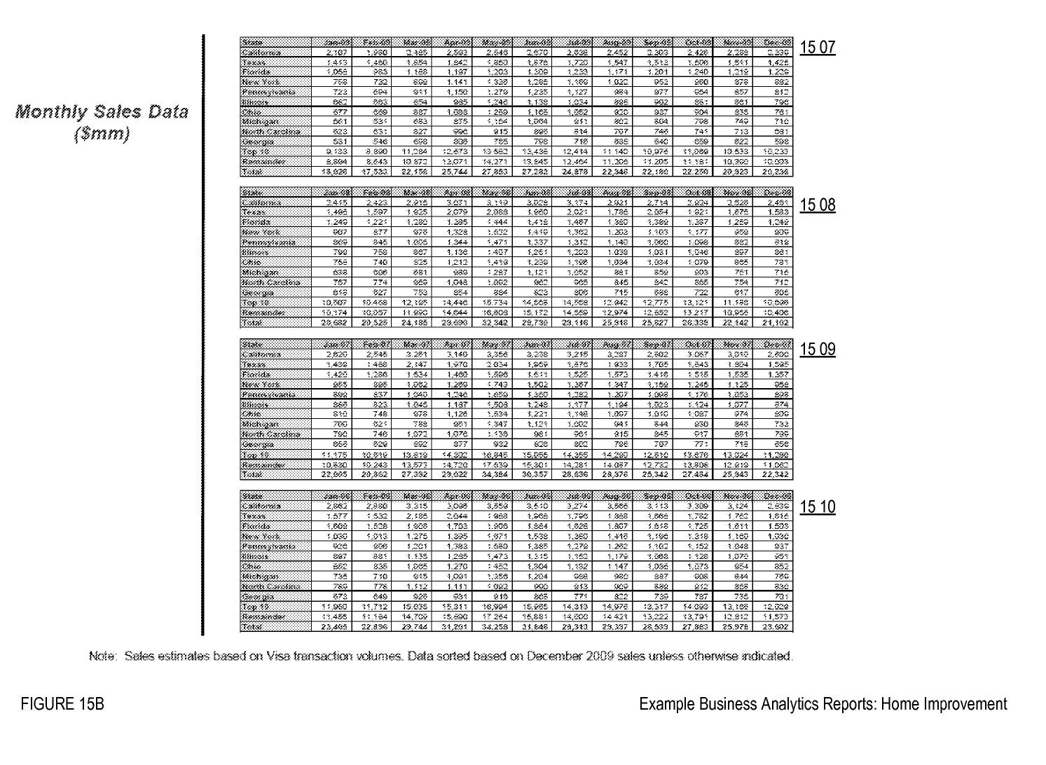

FIGS. 13A-E show example business analytics reports on specially clothing analysis generated from econometrical investment strategy analysis based on card-based transaction data in some embodiments of the EISA. The reports provide state level information on the specific industry of specialty clothing (see 1301), based on card transaction data aggregated over a specified period of time (see 1302). The report provides a sales summary (1303) and graphical report (1304) in this industry sector broken down by state (see 1303a) and sales channel (see 1303b). The report also provides a growth summary (1305) and data on recent trends (1306), including total sales (1306a) and total sales growth (1306b). The report also provides monthly sales data broken down by state and sales channel (1307-1314), monthly growth rates by state and sales channel (1315-1320), mean and variance trends (1321-1328), and monthly sales figures (1329).

FIGS. 14A-B show example business analytics reports on e-commerce penetration into various industries generated from econometrical investment strategy analysis based on card-based transaction data in some embodiments of the EISA. The reports graphically provides information on penetration of the e-commerce sales channel into various industries over time (see 1401-1403), specifically, those industries in the top 50% of e-commerce penetration (1402) and those in the bottom 50% of e-commerce penetration (1403).

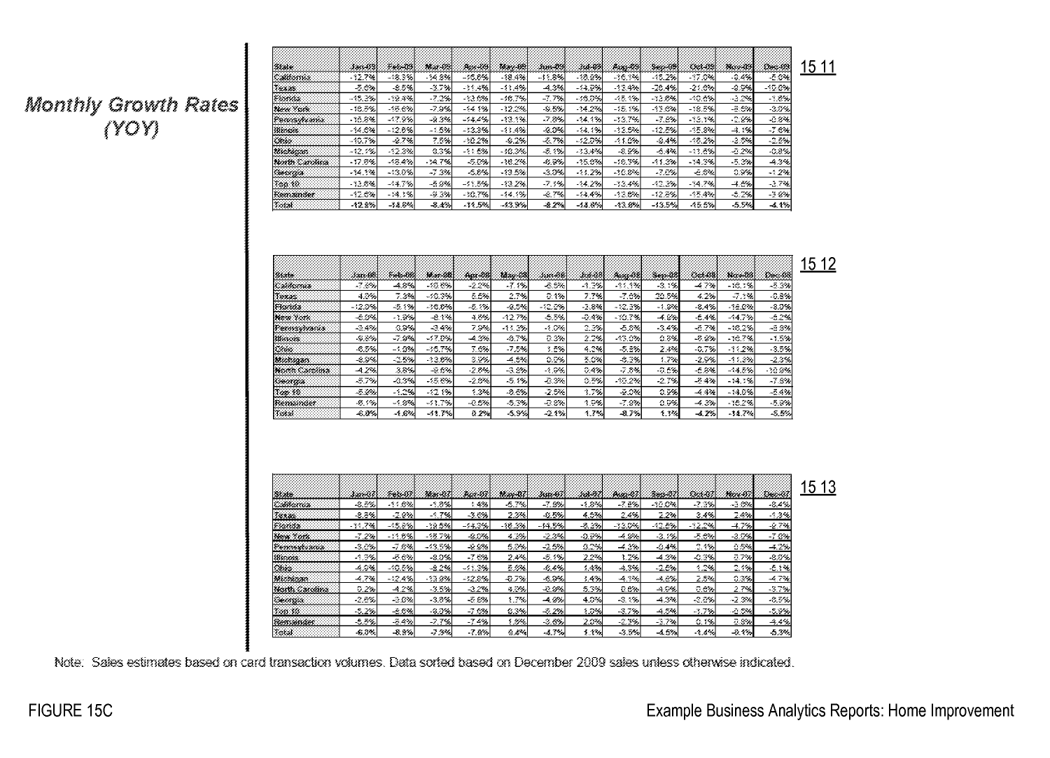

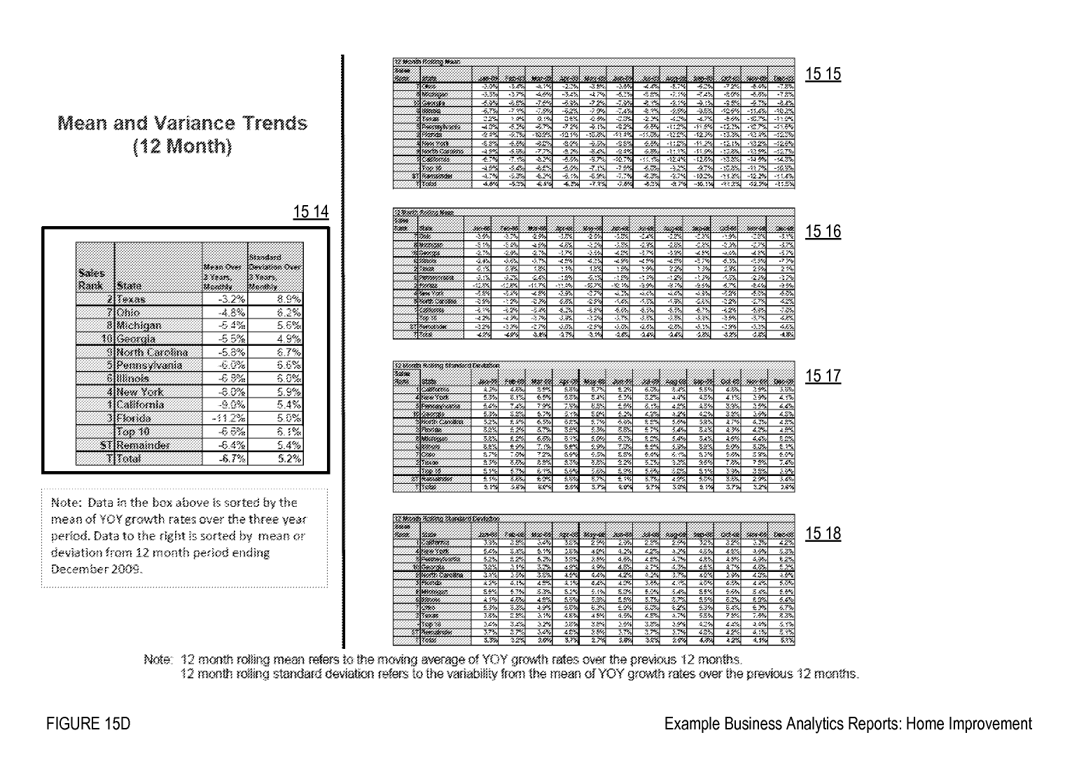

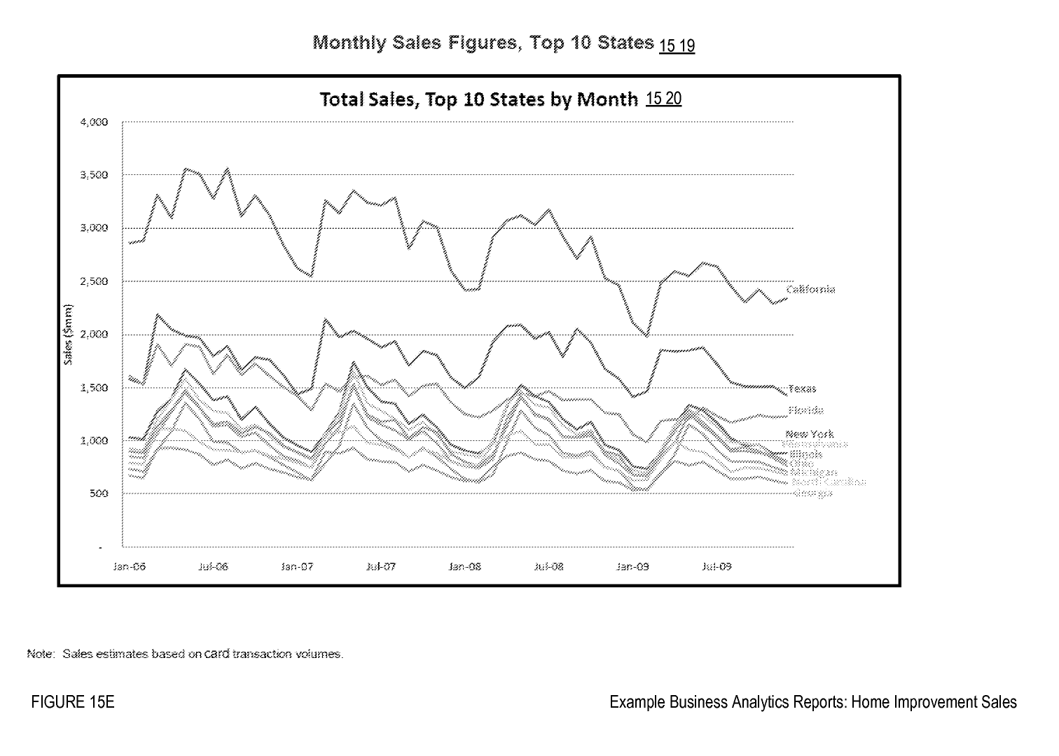

FIGS. 15A-E show example business analytics reports on home improvement sales generated from econometrical investment strategy analysis based on card-based transaction data in some embodiments of the EISA. The reports provide state level information on the specific industry of home improvement (see 1501), based on card transaction data aggregated over a specified period of time (see 1502). The report provides a sales summary (1503) and graphical report (1504) in this industry sector broken down by state (see 1503a) and sales channel (see 1503b). The report also provides a growth summary (1305) and data on recent trends (1506), including total sales (1506a) and total sales growth (1506b). The report also provides monthly sales data by state (1507-1510), monthly growth rates by state (1511-1513), mean and variance trends (1515-1518), and monthly sales FIGS. 1519-1520).

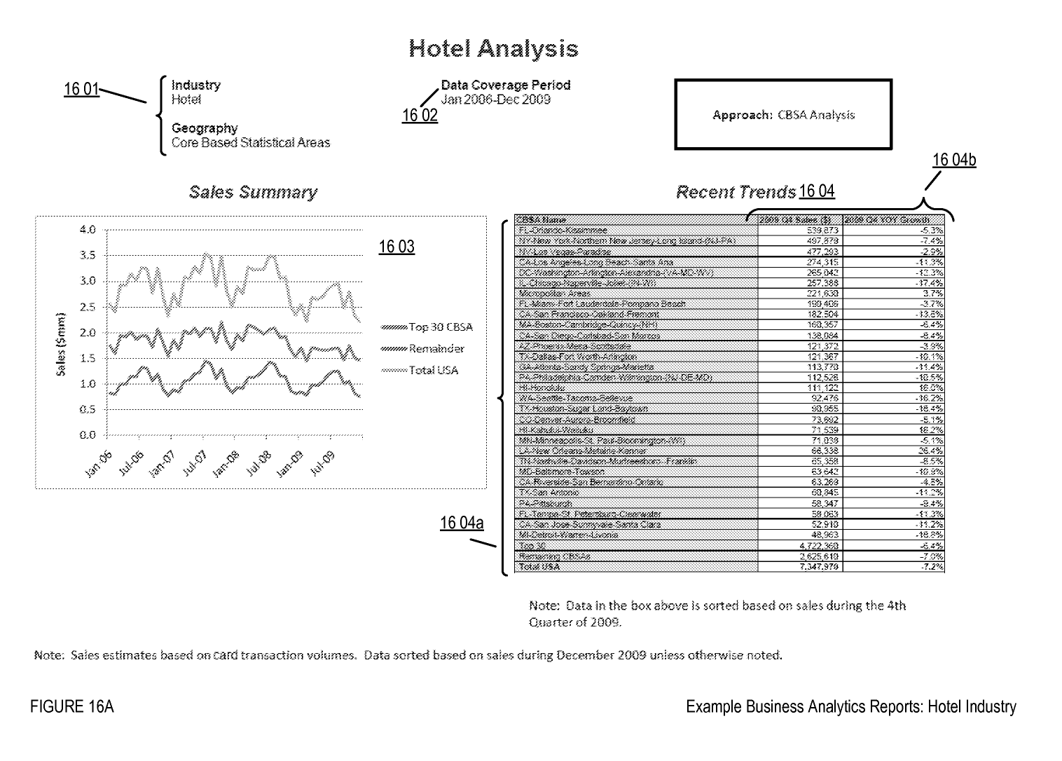

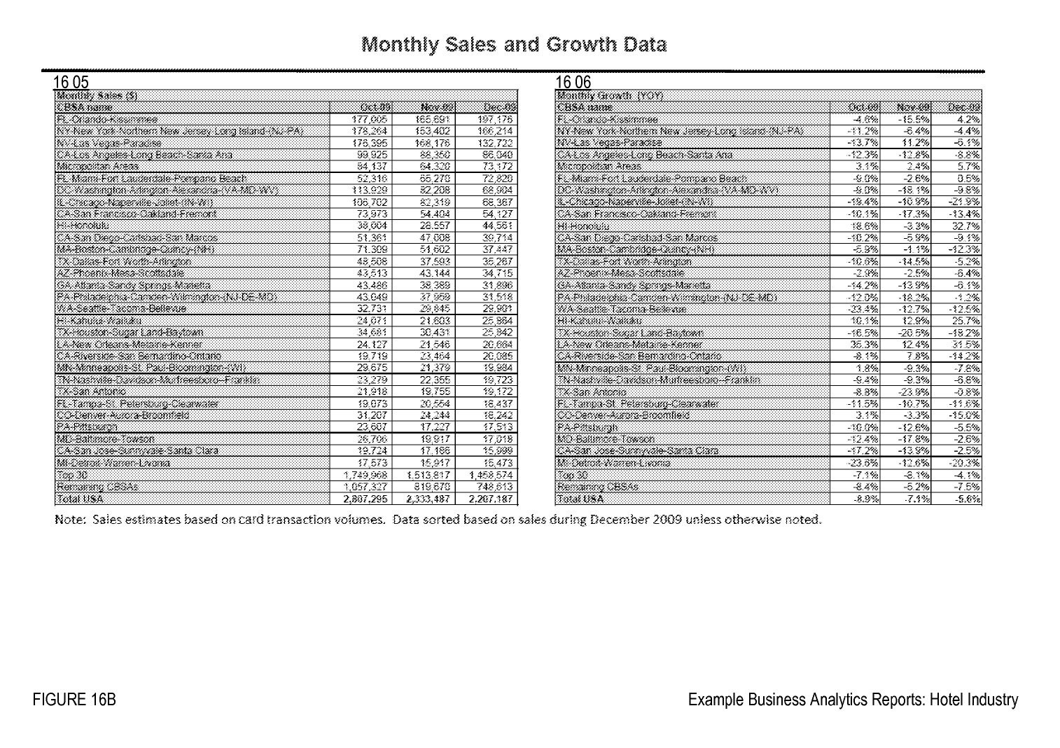

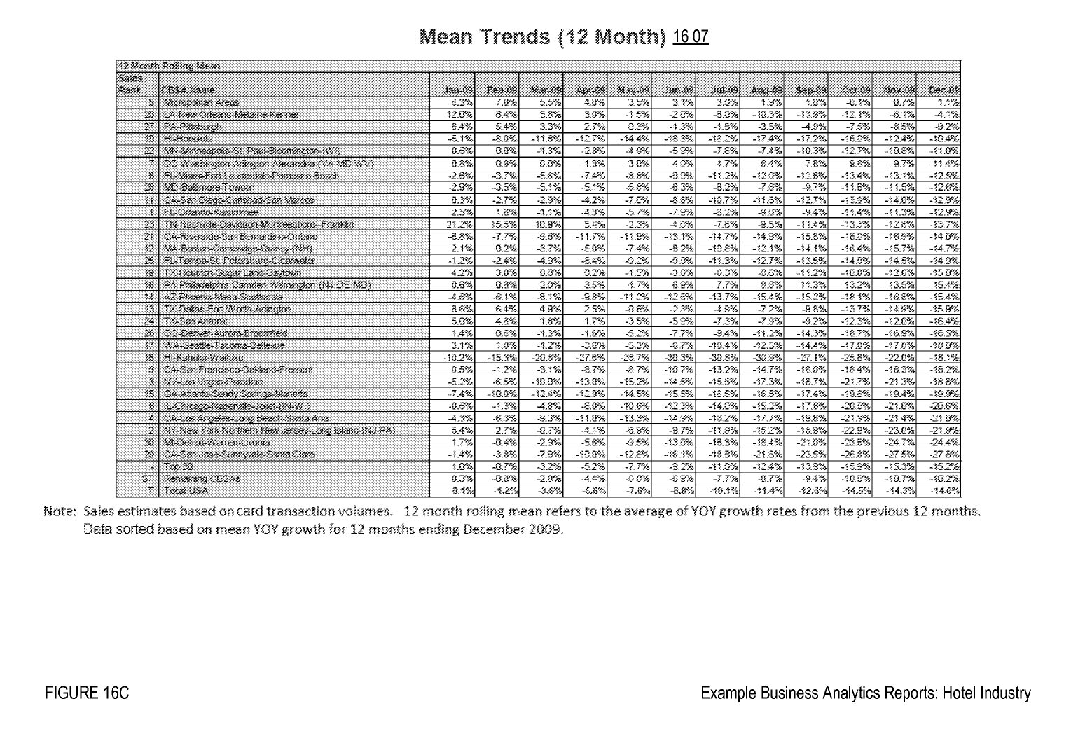

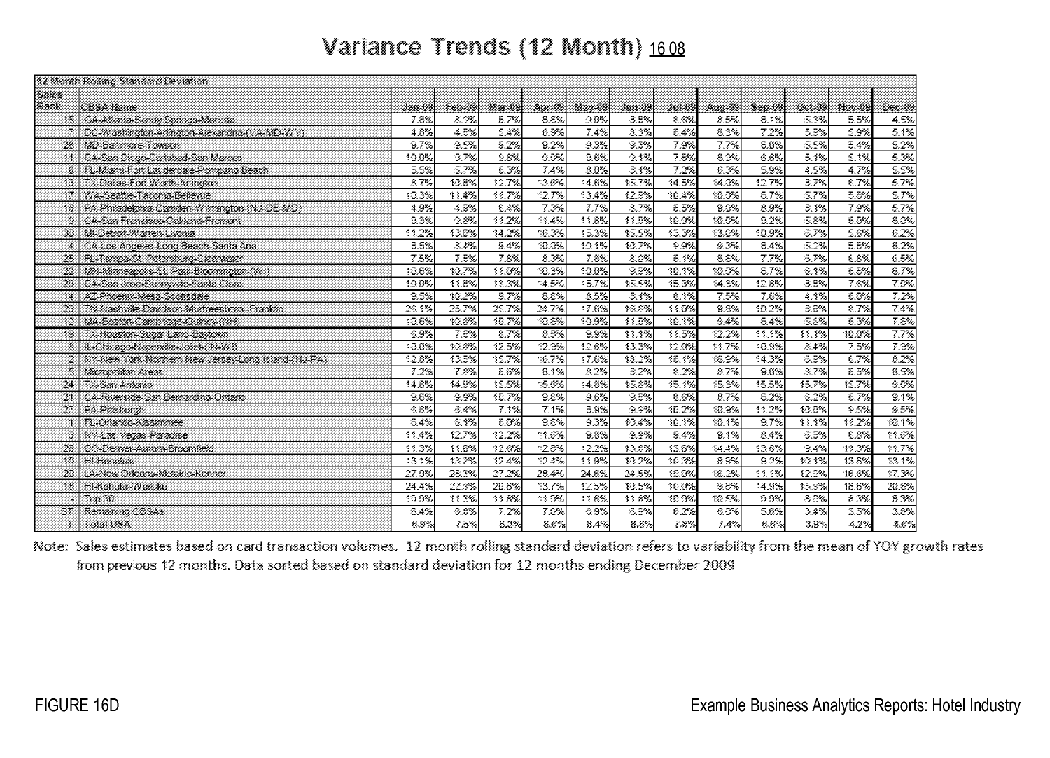

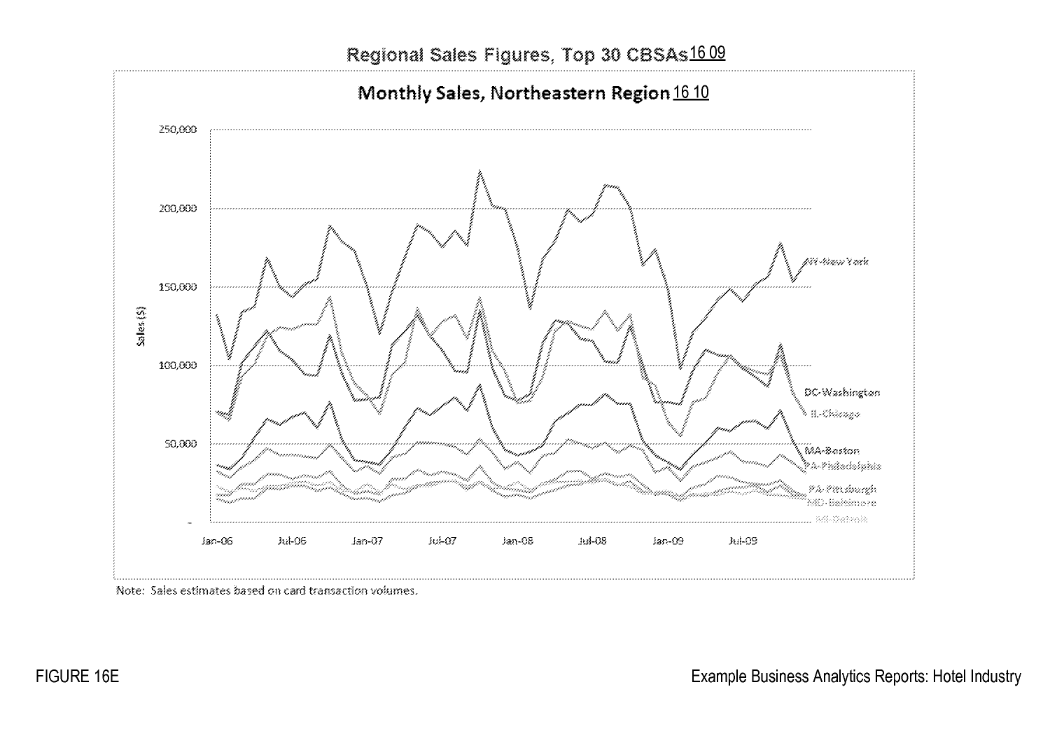

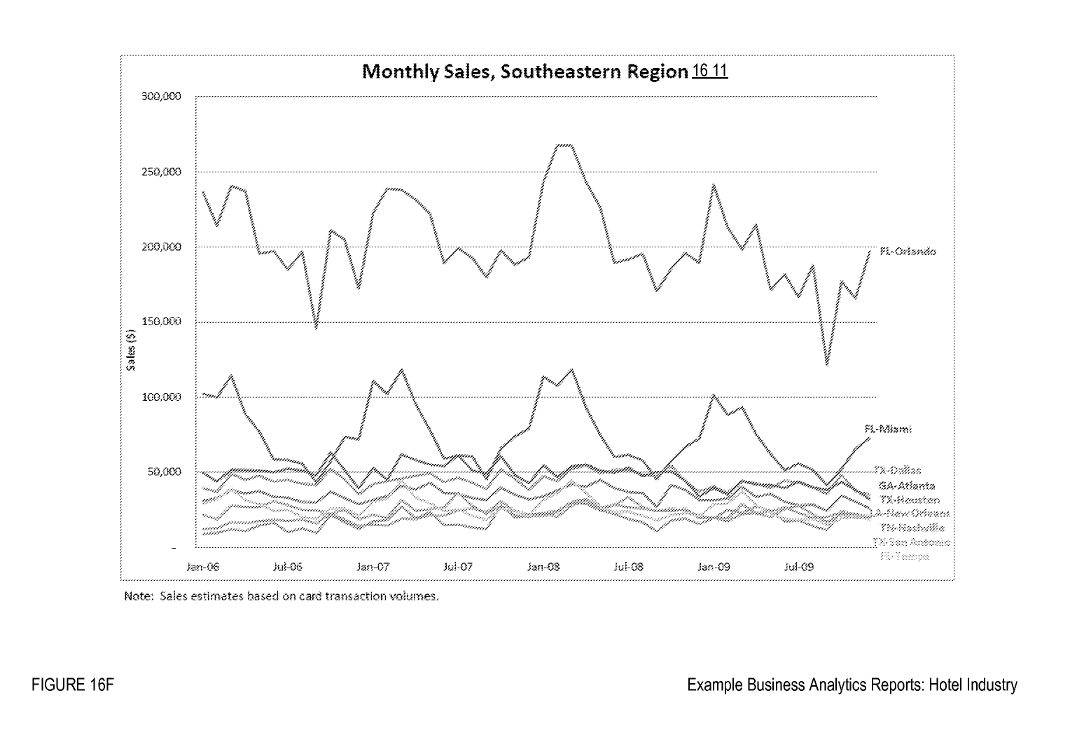

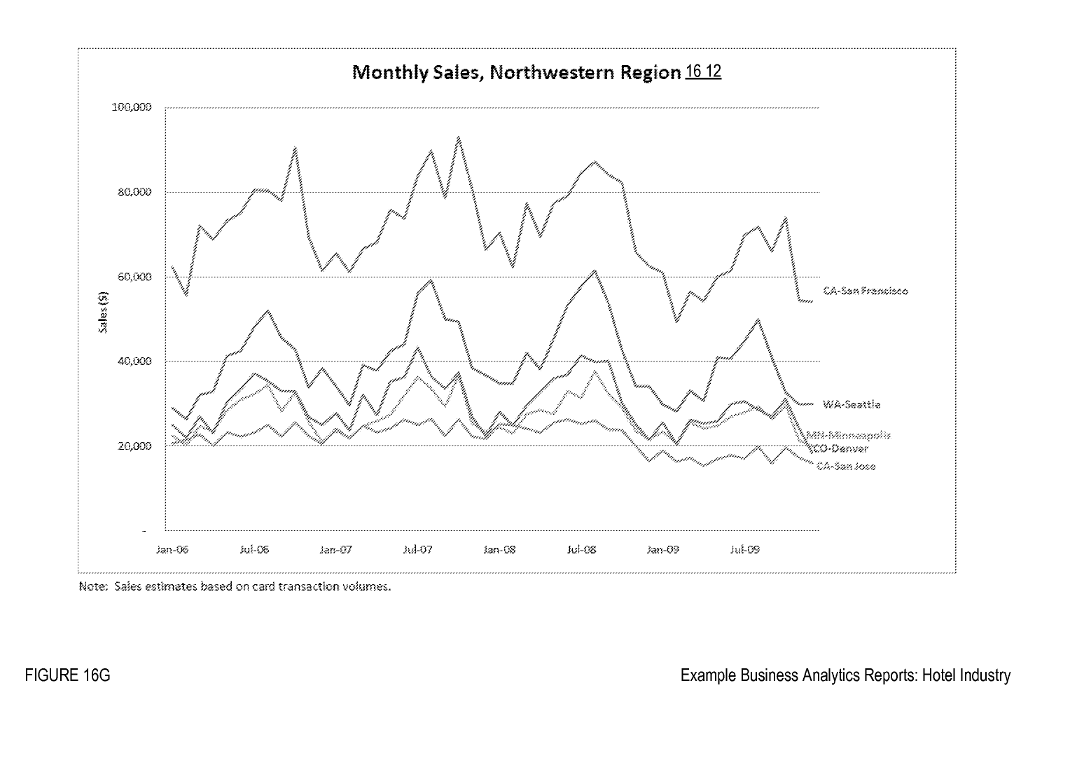

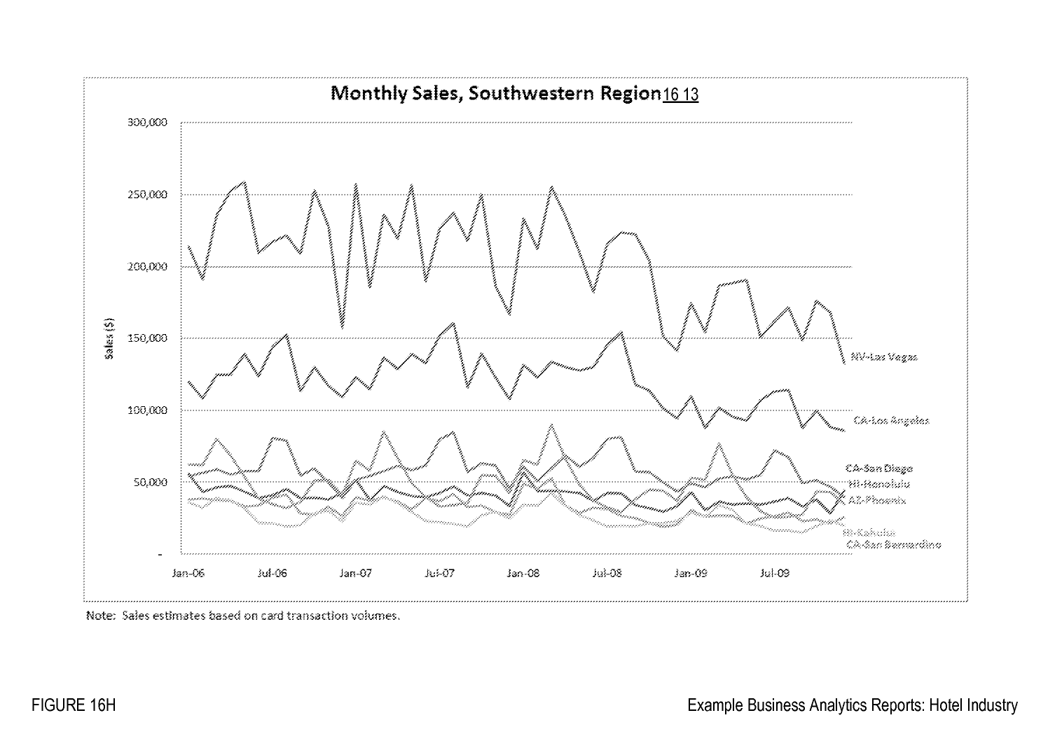

FIGS. 16A-H show example business analytics reports on the hotel industry generated from econometrical investment strategy analysis based on card-based transaction data in some embodiments of the EISA. The reports provide metro area-specific information on the hotel industry (see 1601), based on card transaction data aggregated over a specified period of time (see 1602). The report provides a sales graphical summary (1603) and recent trends (1604) in this industry sector broken down by metro area (see 1604a) and time (see 1604b). The report also provides monthly sales and growth data by state (1605-1606), mean trends (1607), variance trends (1608) and monthly regional sales figures (see 1609-1613).

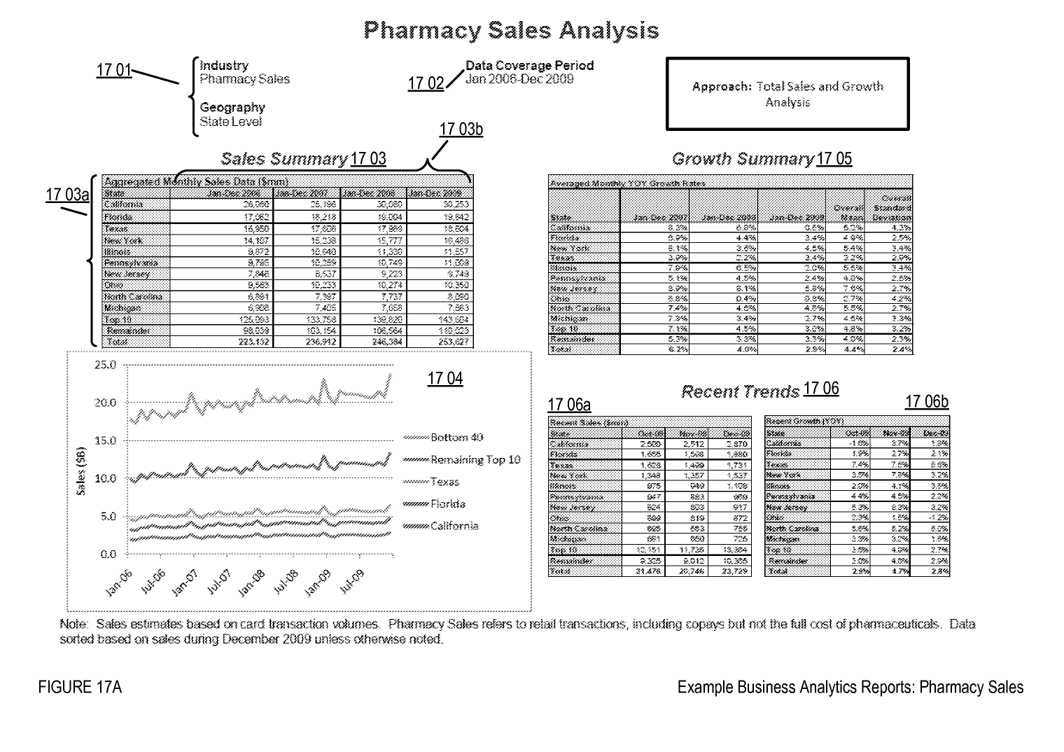

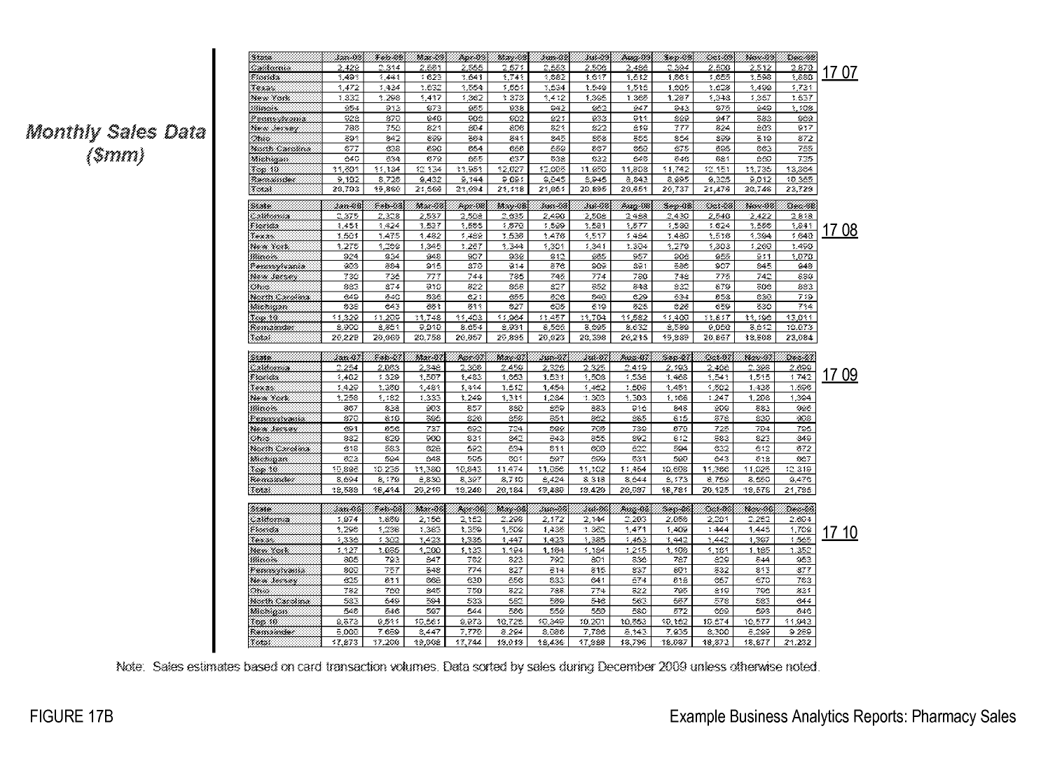

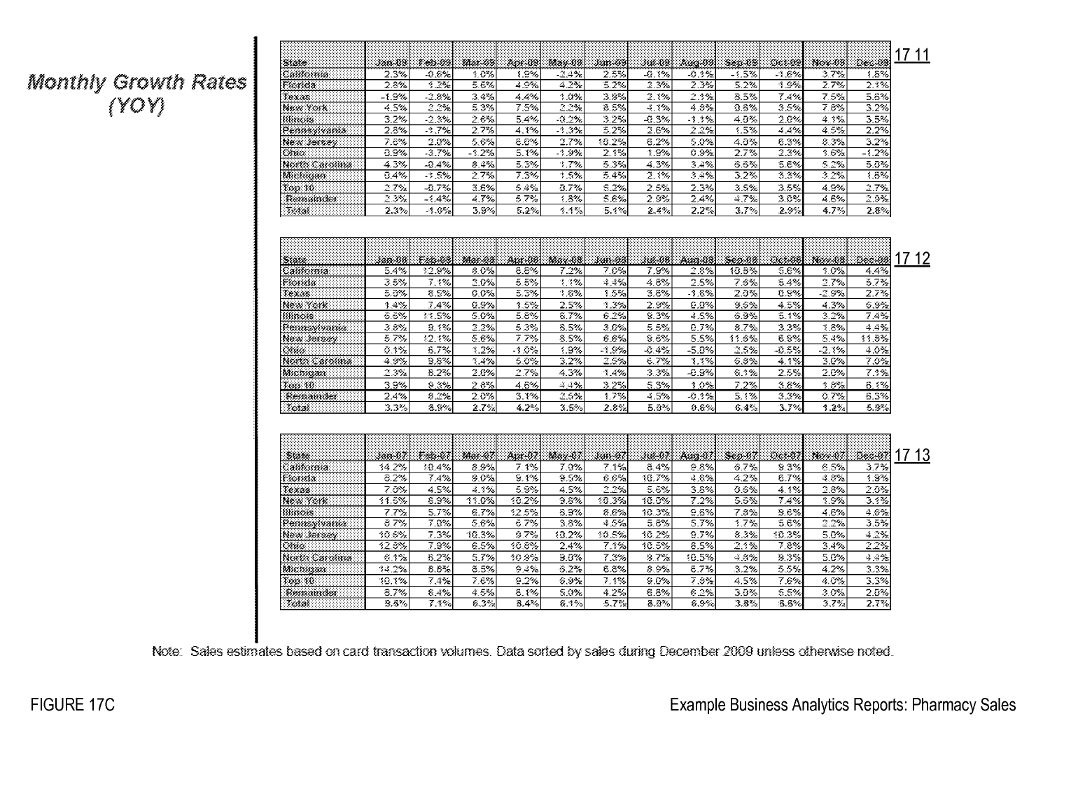

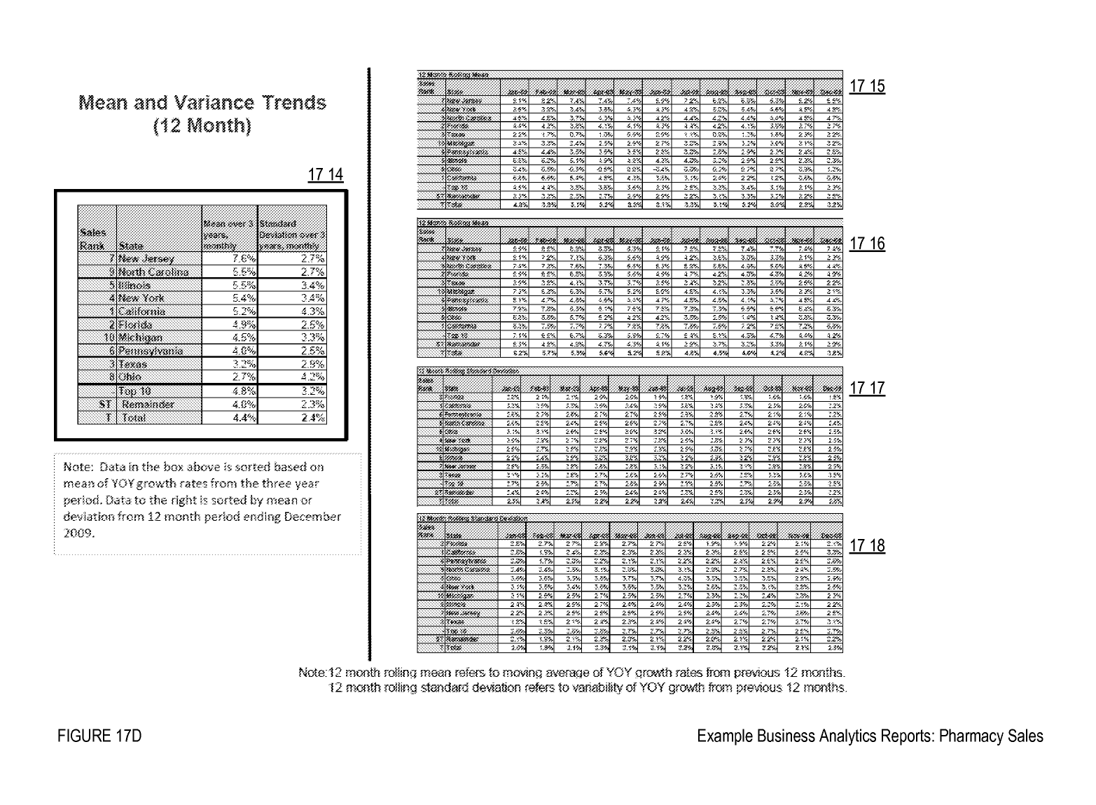

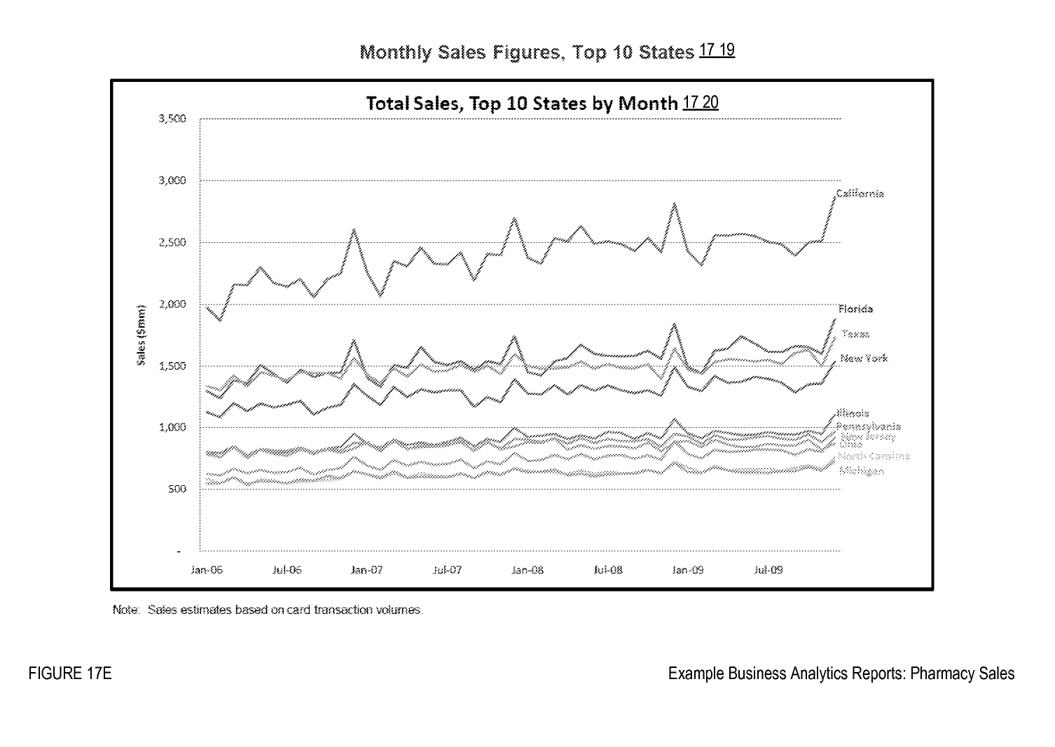

FIGS. 17A-E show example business analytics reports on pharmacy sales generated from econometrical investment strategy analysis based on card-based transaction data in some embodiments of the EISA. The reports provide state level information on the specific industry of pharmacy sales (see 1701), based on card transaction data aggregated over a specified period of time (see 1702). The report provides a sales summary (1703) and graphical report (1704) in this industry sector broken down by state (see 1703a) and sales channel (see 1703b). The report also provides a growth summary (1705) and data on recent trends (1706), including total sales (1706a) and total sales growth (1706b). The report also provides monthly sales data by state (1707-1710), monthly growth rates by state (1711-1713), mean and variance trends (1714-1718), and monthly sales FIGS. 1719-1720).

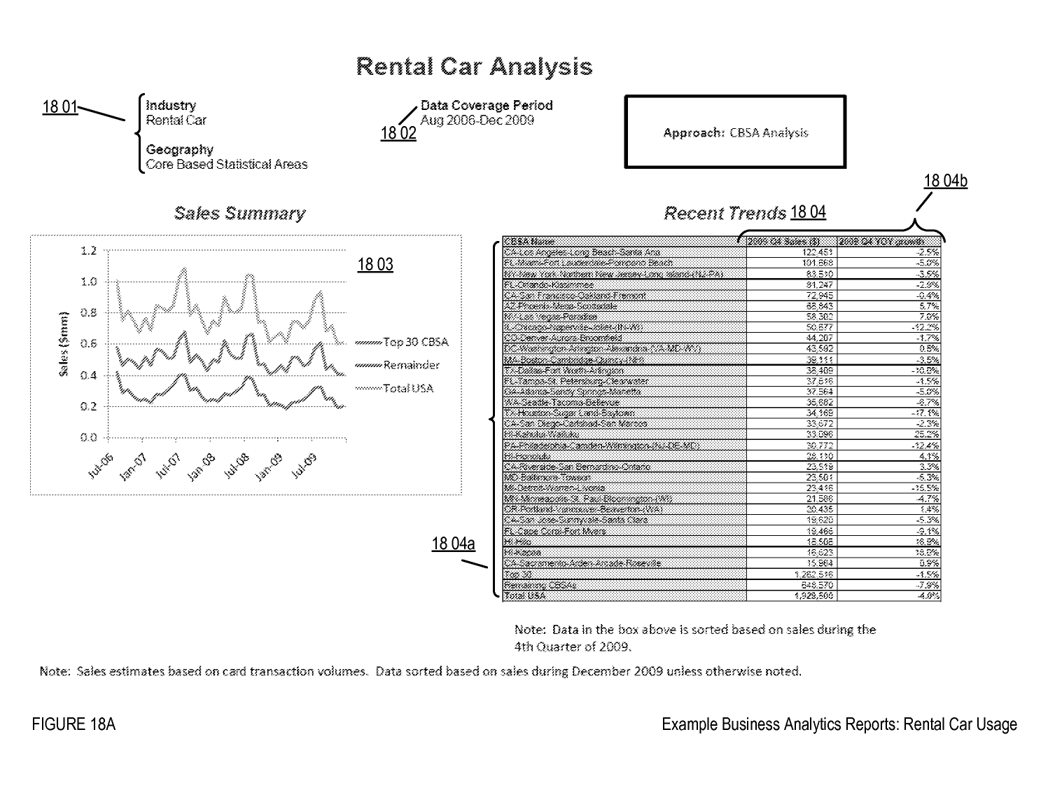

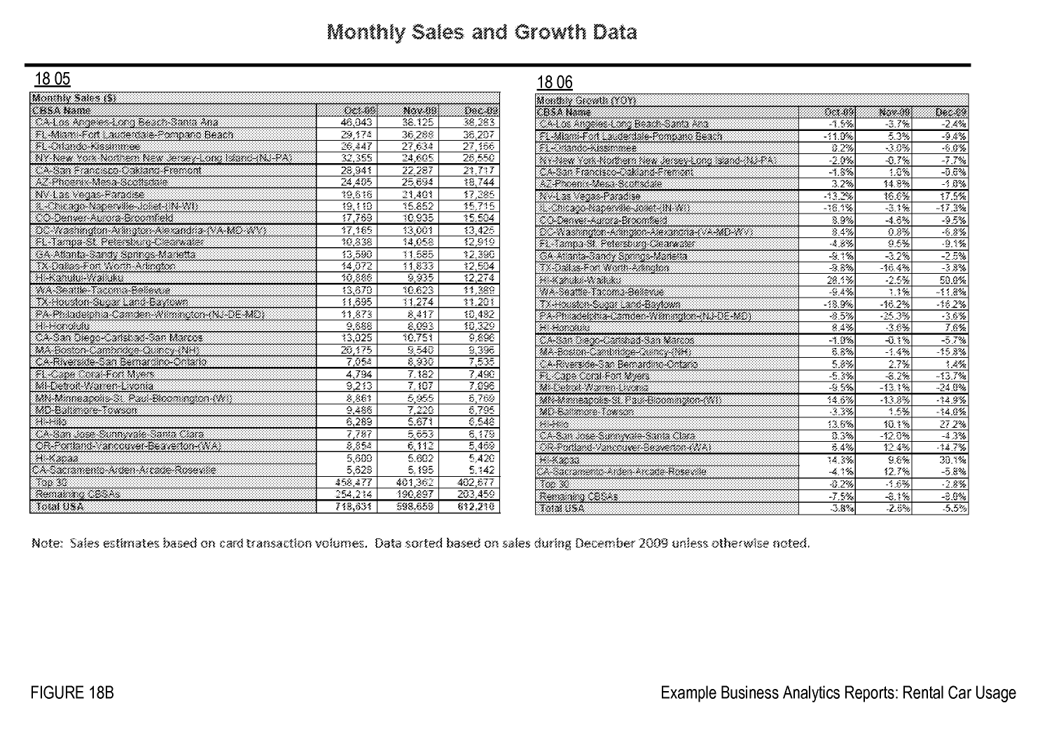

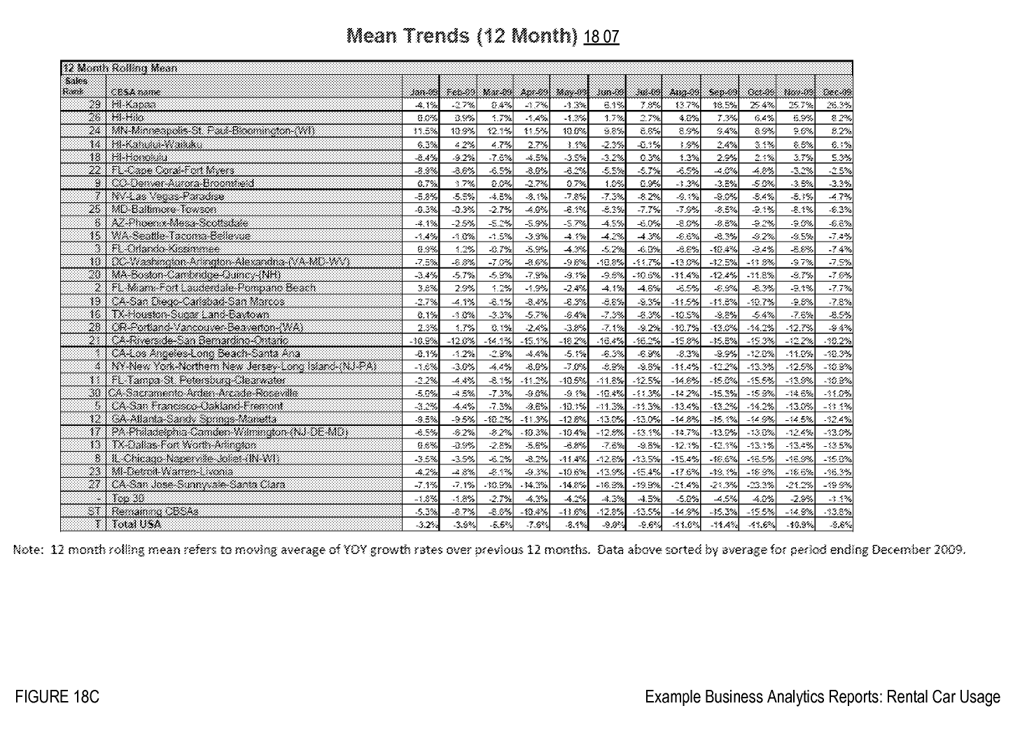

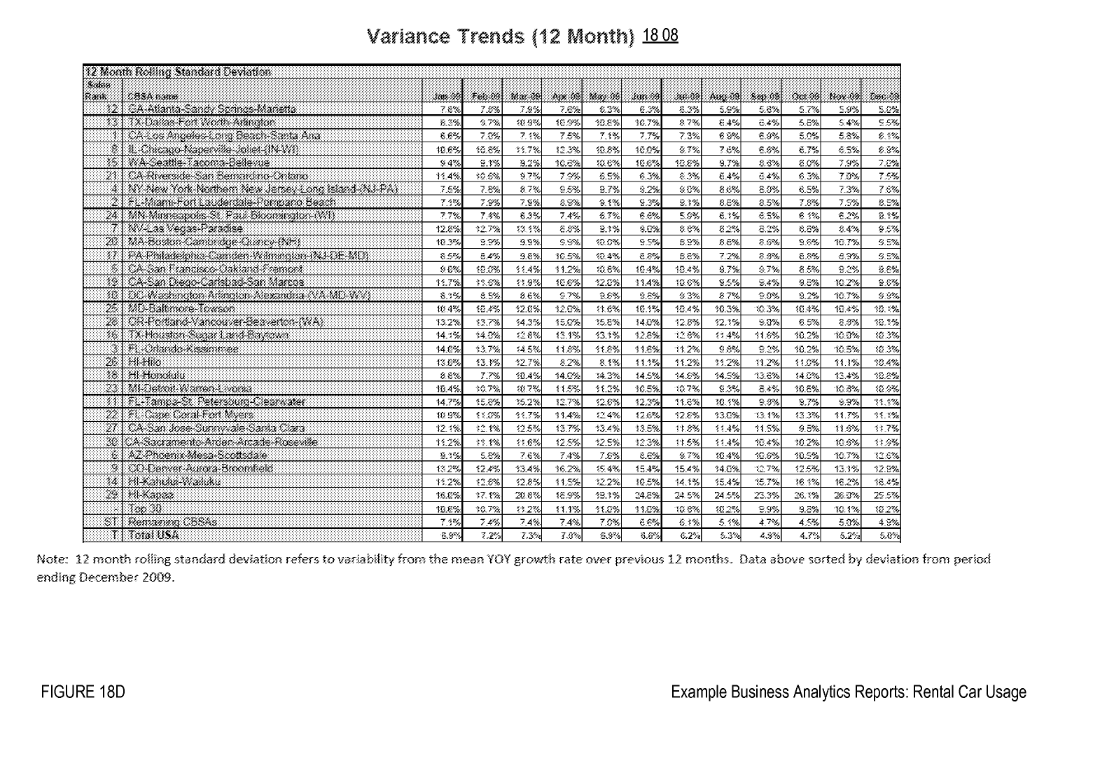

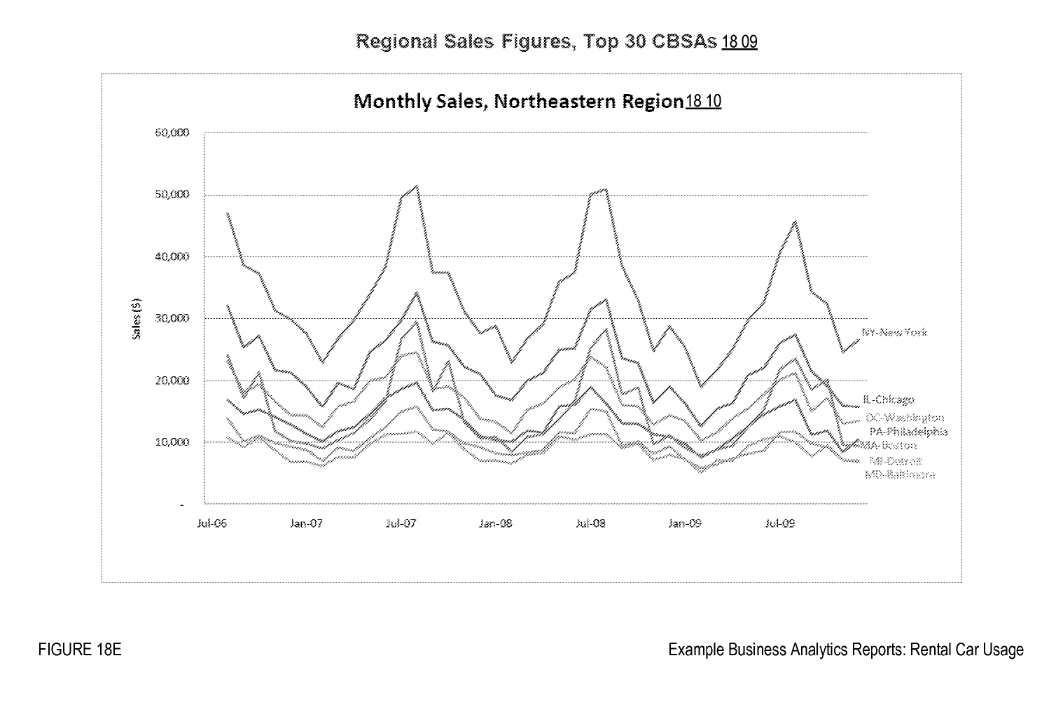

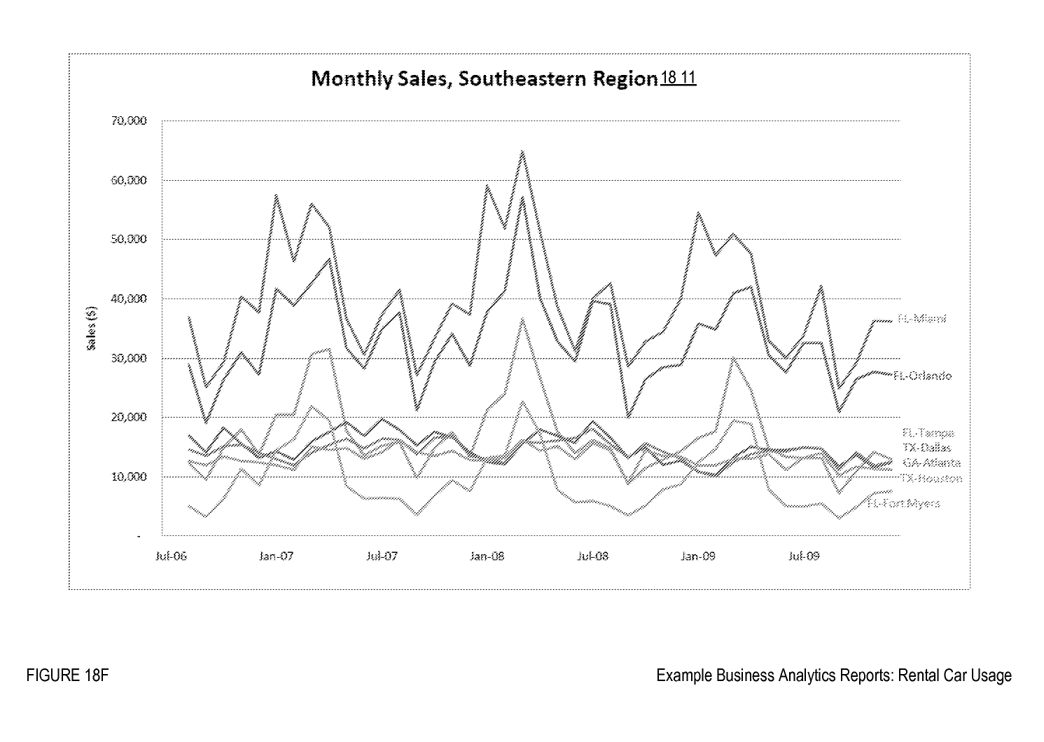

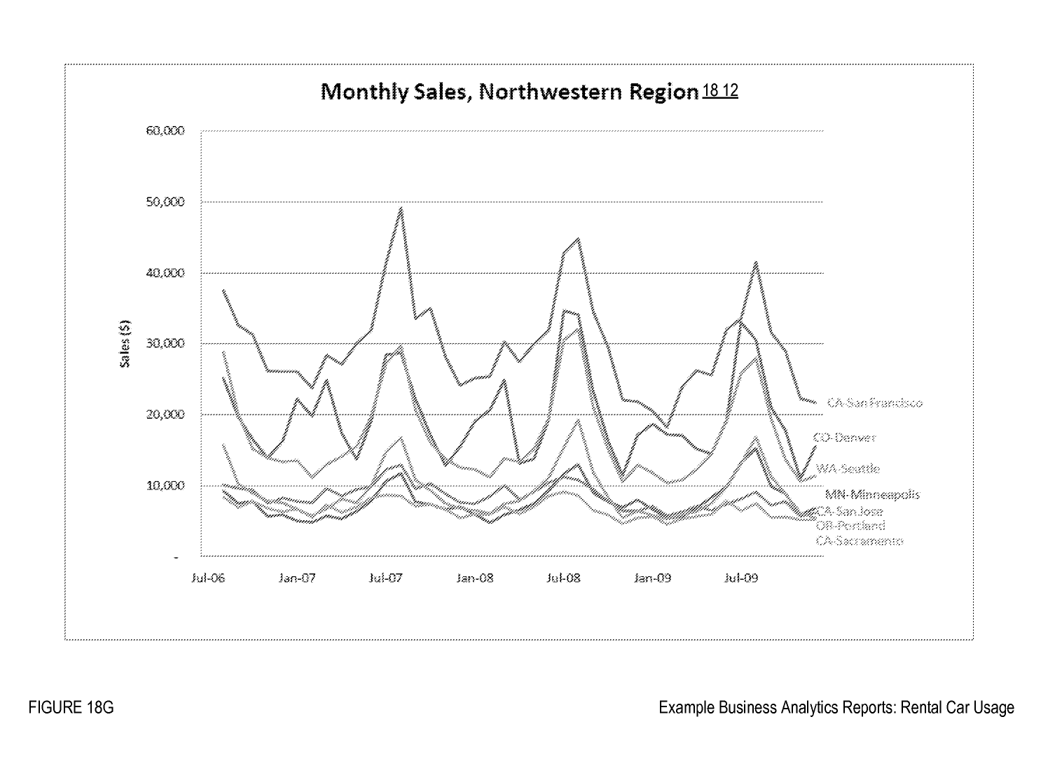

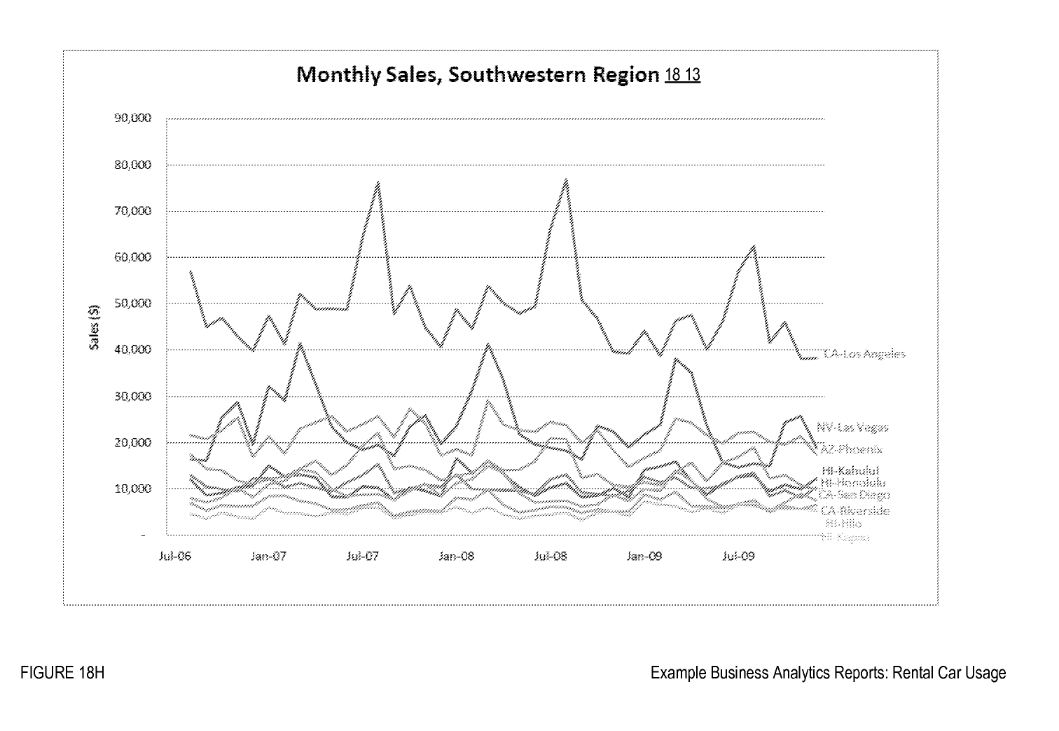

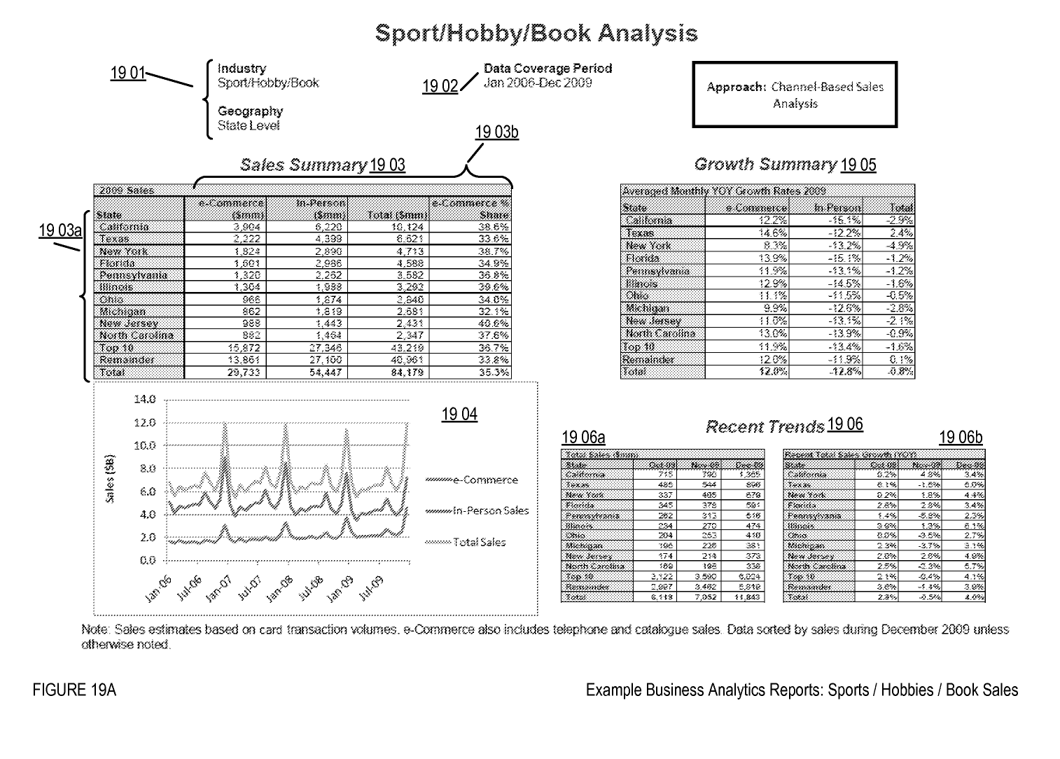

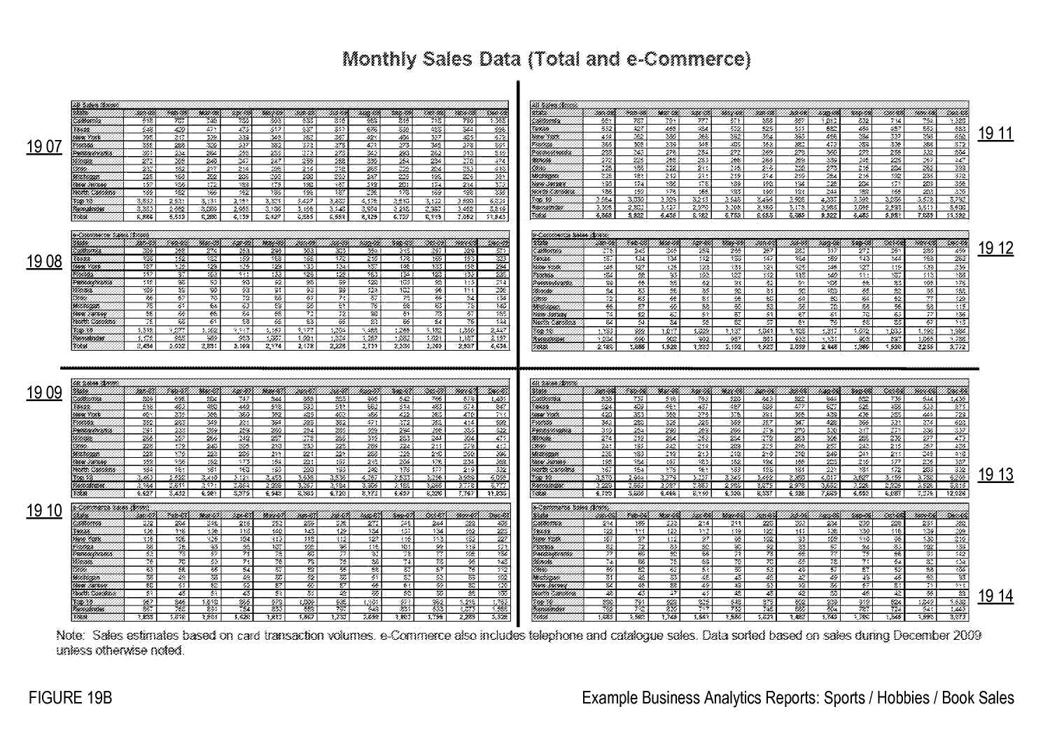

FIGS. 18A-H show example business analytics reports on rental car usage generated from econometrical investment strategy analysis based on card-based transaction data in some embodiments of the EISA. The reports provide metro area-specific information on the car rental industry (see 1801), based on card transaction data aggregated over a specified period of time (see 1802). The report provides a sales graphical summary (1803) and recent trends (1804) in this industry sector broken down by metro area (see 1804a) and time (see 1804b). The report also provides monthly sales and growth data by state (1805-1806), mean trends (1807), variance trends (1808) and monthly regional sales figures (see 1809-1813).

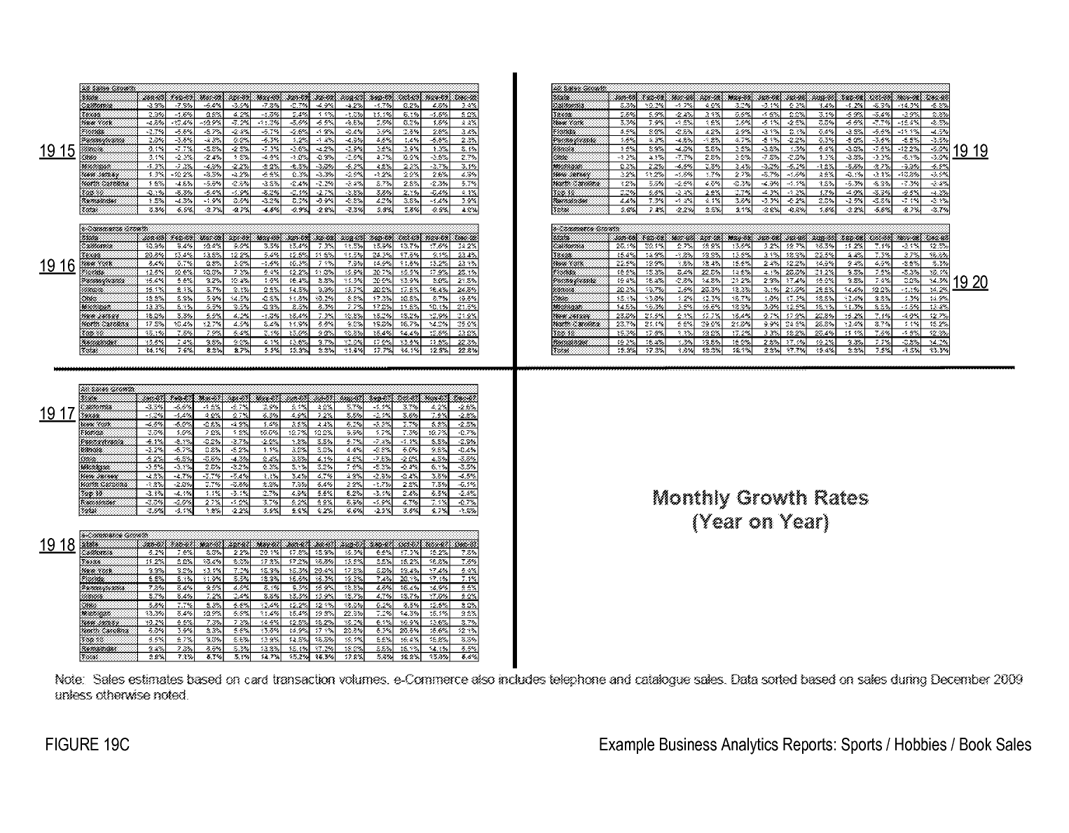

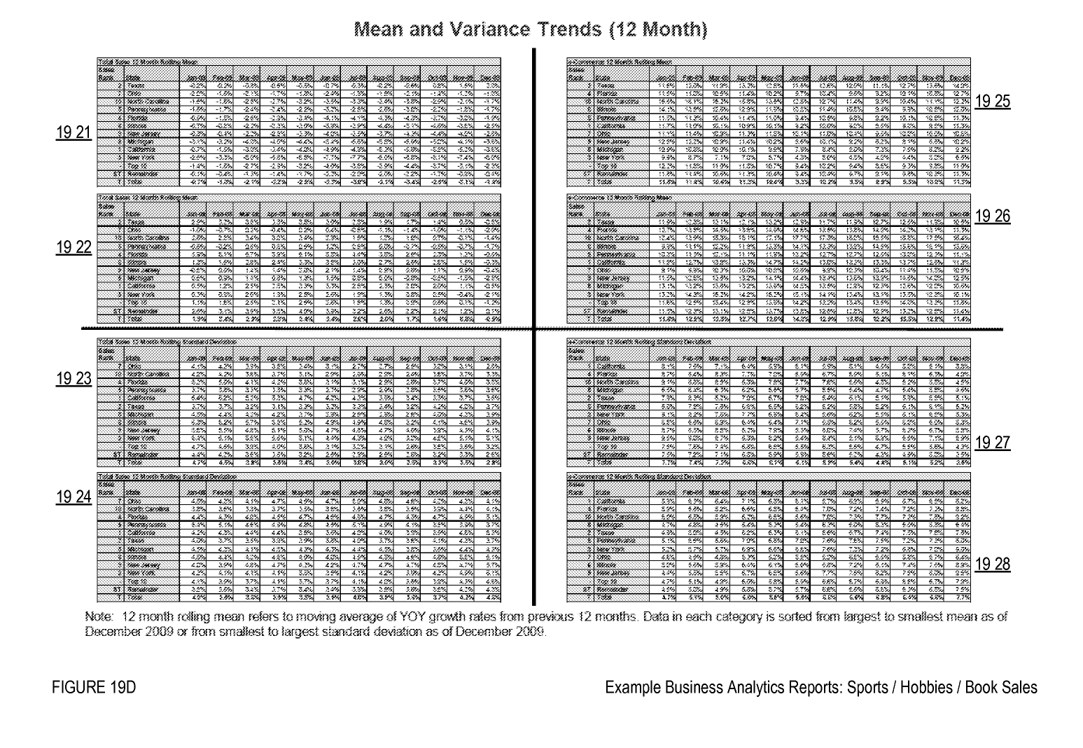

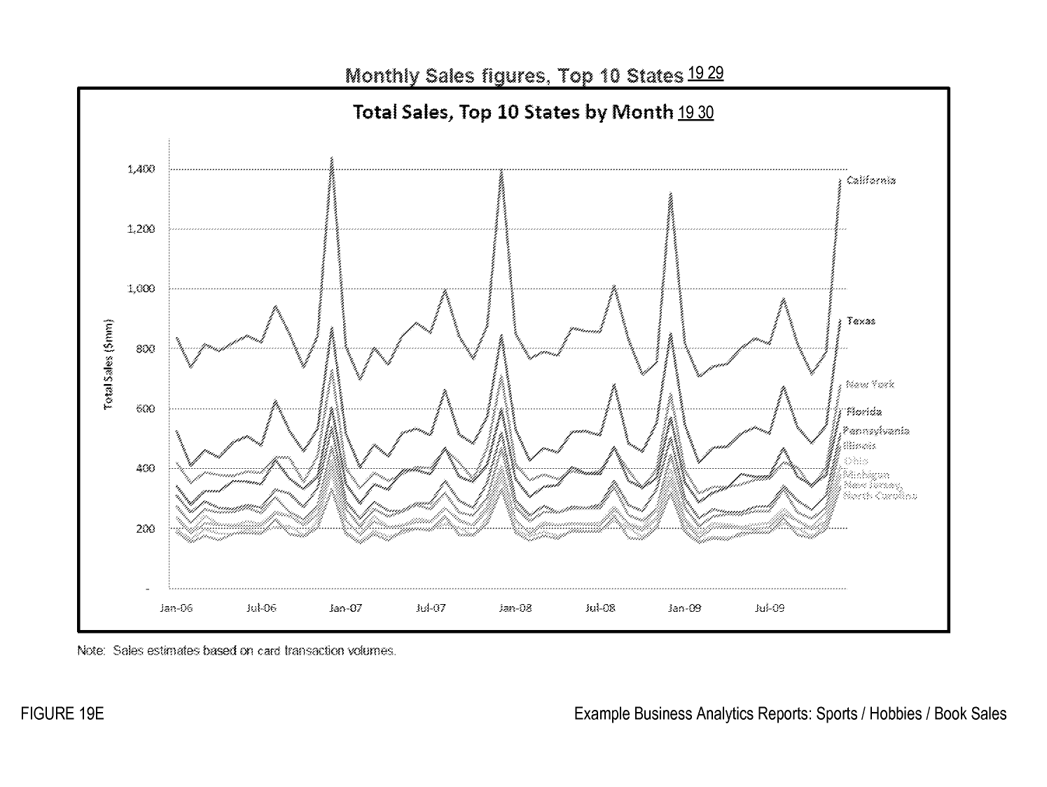

FIGS. 19A-E show example business analytics reports on sports, hobbies, and book-related sales generated from econometrical investment strategy analysis based on card-based transaction data in some embodiments of the EISA. The reports provide state level information on sports, hobbies, and book-related sales (see 1901), based on card transaction data aggregated over a specified period of time (see 1902). The report provides a sales summary (1903) and graphical report (1904) in this industry sector broken down by state (see 1903a) and sales channel (see 1903b). The report also provides a growth summary (1905) and data on recent trends (1906), including total sales (1906a) and total sales growth (1906b). The report also provides monthly sales data broken down by state and sales channel (1907-1914), monthly growth rates by state and sales channel (1915-1920), mean and variance trends (1921-1928), and monthly sales FIGS. 1929-1930).

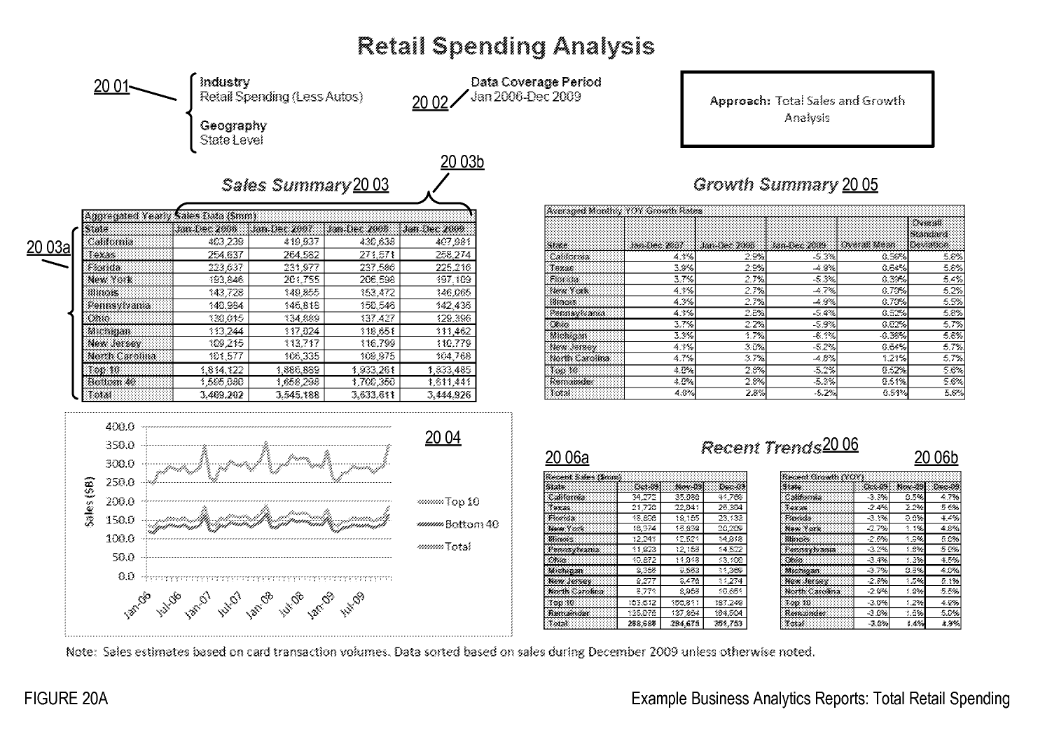

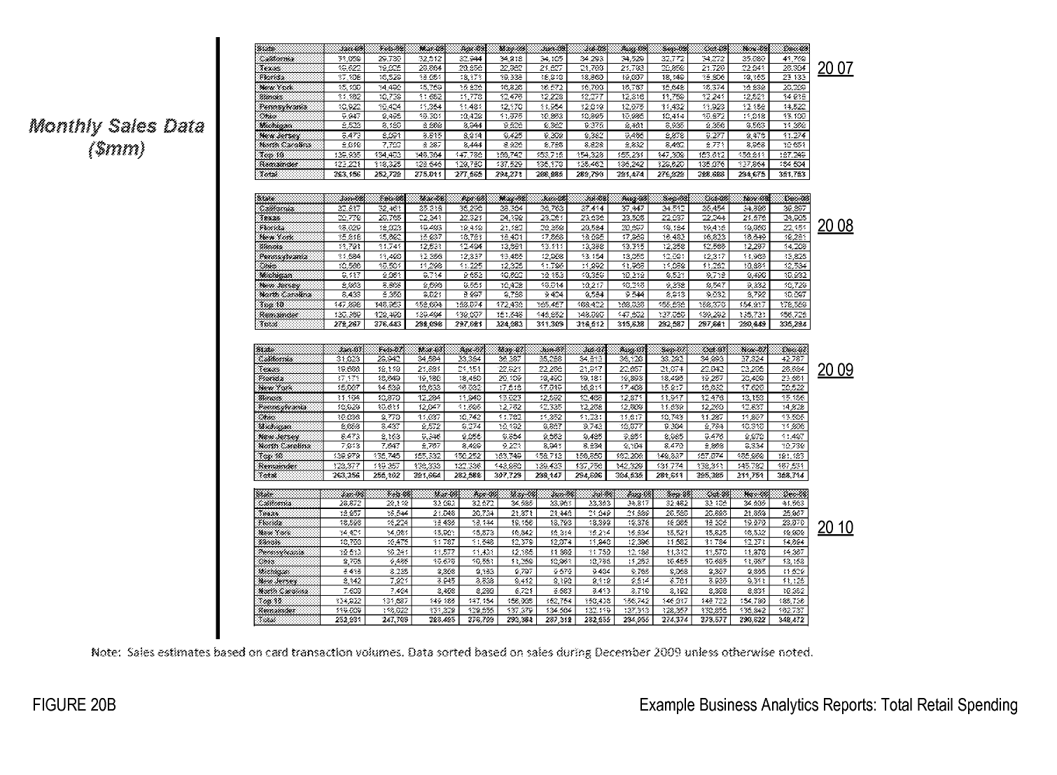

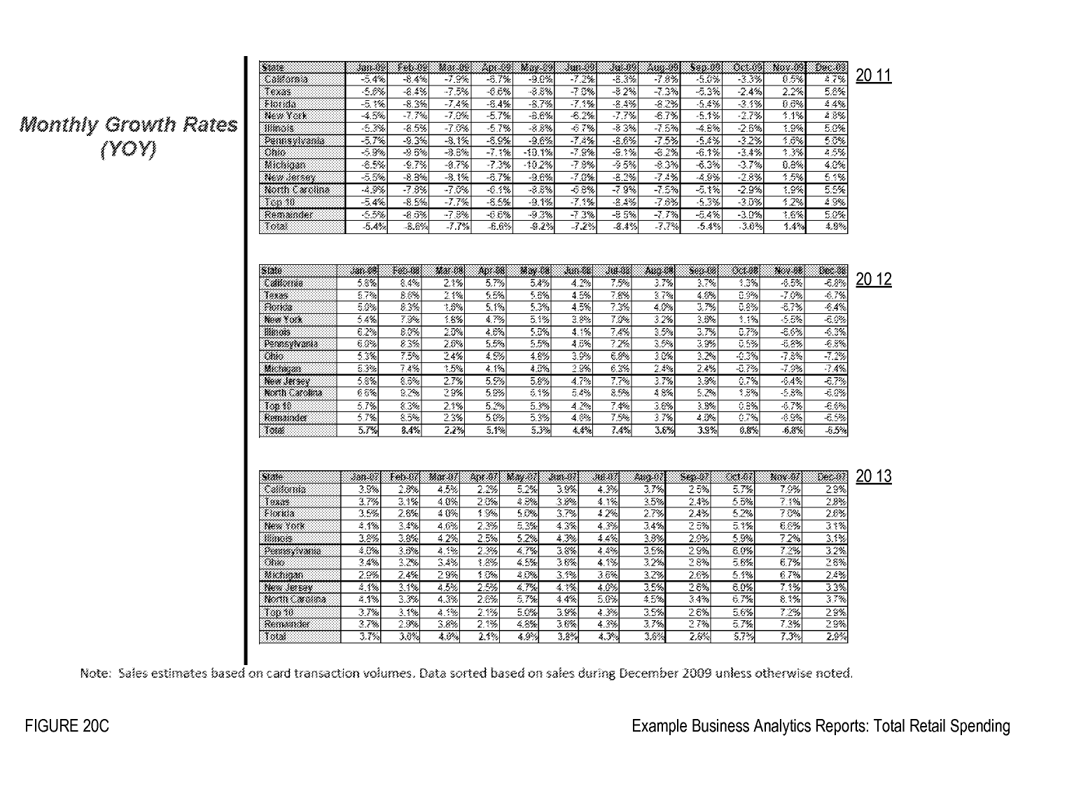

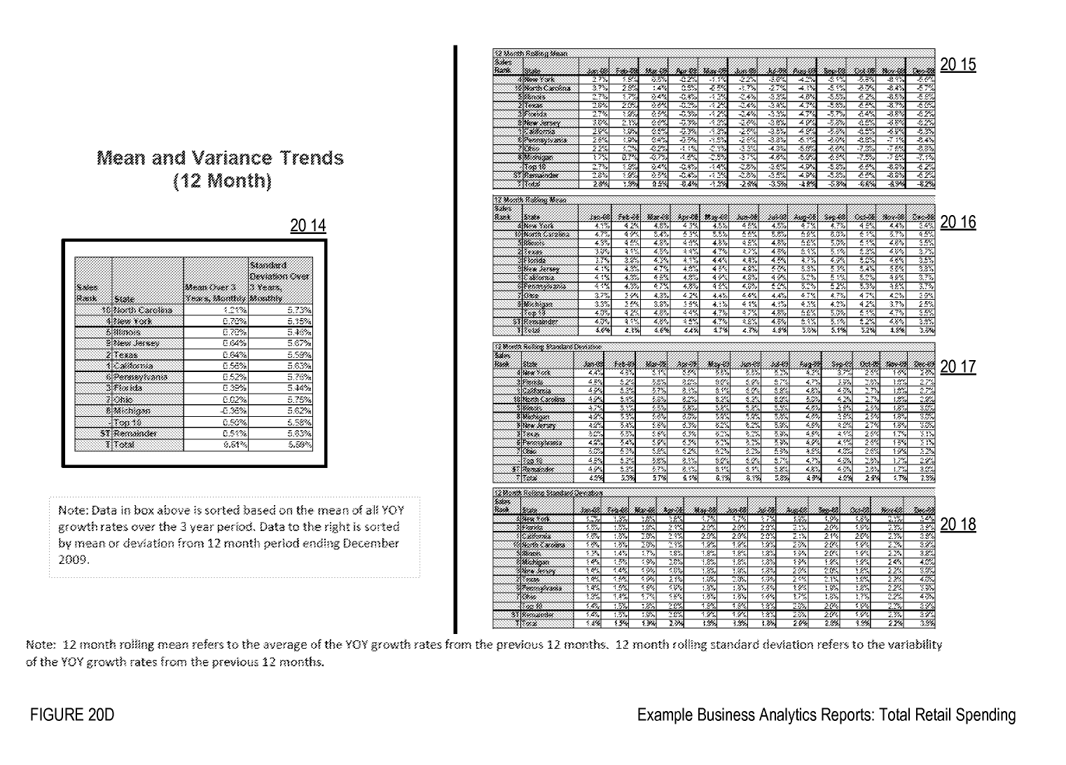

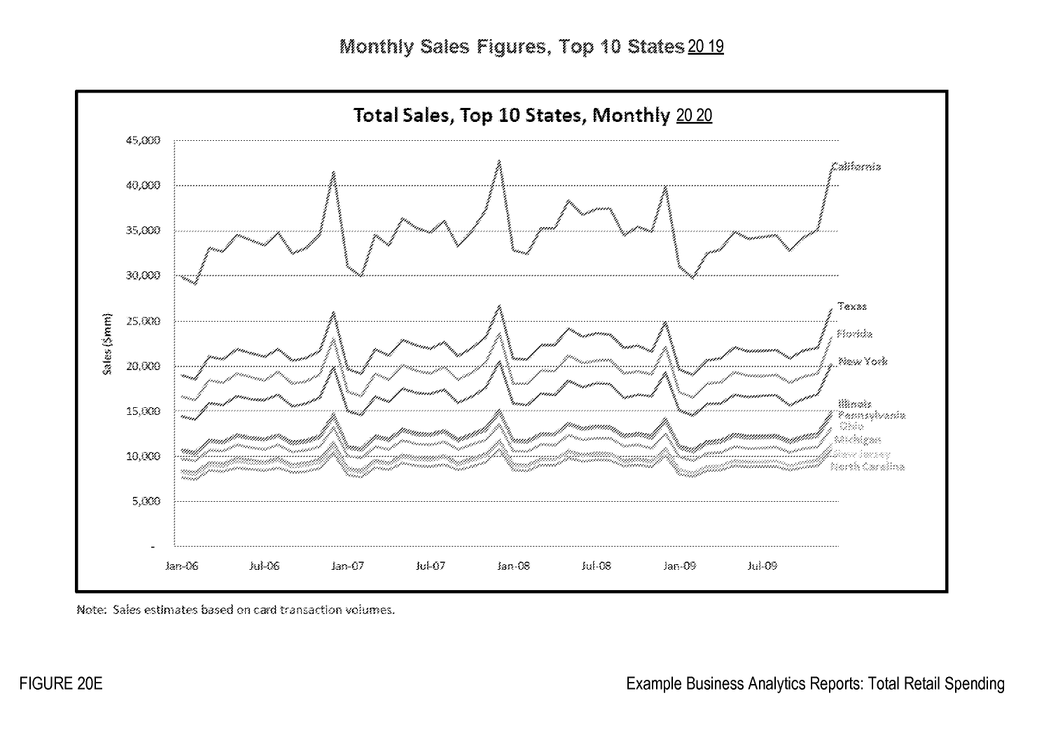

FIGS. 20A-E show example business analytics reports on total retail spending generated from econometrical investment strategy analysis based on card-based transaction data in some embodiments of the EISA. The reports provide state level information on retail spending (see 2001), based on card transaction data aggregated over a specified period of time (see 2002). The report provides a sales summary (2003) and graphical report (2004) in this industry sector broken down by state (see 2003a) and sales channel (see 2003b). The report also provides a growth summary (2005) and data on recent trends (2006), including total sales (2006a) and total sales growth (2006b). The report also provides monthly sales data by state (2007-2010), monthly growth rates by state (2011-2013), mean and variance trends (2014-2018), and monthly sales FIGS. 2019-2020).

### EISA Controller

FIG. 21 illustrates inventive aspects of a EISA controller 2101 in a block diagram. In this embodiment, the EISA controller 2101 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the EISA controller 2101 may be connected to and/or communicate with entities such as, but not limited to: one or more users from user input devices 2111; peripheral devices 2112; an optional cryptographic processor device 2128; and/or a communications network 2113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The EISA controller 2101 may be based on computer systems that may comprise, but are not limited to, components such as: a computer systemization 2102 connected to memory 2129.

### Computer Systemization

A computer systemization 2102 may comprise a clock 2130, central processing unit (“CPU(s)” and/or “processor(s)” (these terms are used interchangeable throughout the disclosure unless noted to the contrary)) 2103, a memory 2129 (e.g., a read only memory (ROM) 2106, a random access memory (RAM) 2105, etc.), and/or an interface bus 2107, and most frequently, although not necessarily, are all interconnected and/or communicating through a system bus 2104 on one or more (mother)board(s) 2102 having conductive and/or otherwise transportive circuit pathways through which instructions (e.g., binary encoded signals) may travel to effect communications, operations, storage, etc. Optionally, the computer systemization may be connected to an internal power source 2186; e.g., optionally the power source may be internal. Optionally, a cryptographic processor 2126 and/or transceivers (e.g., ICs) 2174 may be connected to the system bus. In another embodiment, the cryptographic processor and/or transceivers may be connected as either internal and/or external peripheral devices 2112 via the interface bus I/O. In turn, the transceivers may be connected to antenna(s) 2175, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing EISA controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the EISA controller and beyond through various interfaces. Should processing requirements dictate a greater amount speed and/or capacity, distributed processors (e.g., Distributed EISA), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the EISA may be achieved by implementing a microcontroller such as CAST's R8051XC2 microcontroller; Intel's MCS 51 (i.e., 8051 microcontroller); and/or the like. Also, to implement certain features of the EISA, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the EISA component collection (distributed or otherwise) and/or features may be implemented via the microprocessor and/or via embedded components; e.g., via ASIC, coprocessor, DSP, FPGA, and/or the like. Alternately, some implementations of the EISA may be implemented with embedded components that are configured and used to achieve a variety of features or signal processing.

Depending on the particular implementation, the embedded components may include software solutions, hardware solutions, and/or some combination of both hardware/software solutions. For example, EISA features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the EISA features. A hierarchy of programmable interconnects allow logic blocks to be interconnected as needed by the EISA system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the EISA may be developed on regular FPGAs and then migrated into a fixed version that more resembles ASIC implementations. Alternate or coordinating implementations may migrate EISA controller features to a final ASIC instead of or in addition to FPGAs. Depending on the implementation all of the aforementioned embedded components and microprocessors may be considered the “CPU” and/or “processor” for the EISA.

### Power Source

The power source 2186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2186 is connected to at least one of the interconnected subsequent components of the EISA thereby providing an electric current to all subsequent components. In one example, the power source 2186 is connected to the system bus component 2104. In an alternative embodiment, an outside power source 2186 is provided through a connection across the I/O 2108 interface. For example, a USB and/or IEEE 1394 connection carries both data and power across the connection and is therefore a suitable source of power.

### Interface Adapters

Interface bus(ses) 2107 may accept, connect, and/or communicate to a number of interface adapters, conventionally although not necessarily in the form of adapter cards, such as but not limited to: input output interfaces (I/O) 2108, storage interfaces 2109, network interfaces 2110, and/or the like. Optionally, cryptographic processor interfaces 2127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) 22 Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2109 may accept, communicate, and/or connect to a number of storage devices such as, but not limited to: storage devices 2114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2110 may accept, communicate, and/or connect to a communications network 2113. Through a communications network 2113, the EISA controller is accessible through remote clients 2133b (e.g., computers with web browsers) by users 2133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed EISA), architectures may similarly be employed to pool, load balance, and/or otherwise increase the communicative bandwidth required by the EISA controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2110 may be used to engage with various communications network types 2113. For example, multiple network interfaces may be employed to allow for the communication over broadcast, multicast, and/or unicast networks.

Input Output interfaces (I/O) 2108 may accept, communicate, and/or connect to user input devices 2111, peripheral devices 2112, cryptographic processor devices 2128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth, cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2111 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2112 may be connected and/or communicate to I/O and/or other facilities of the like such as network interfaces, storage interfaces, directly to the interface bus, system bus, the CPU, and/or the like. Peripheral devices may be external, internal and/or part of the EISA controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the EISA controller may be embodied as an embedded, dedicated, and/or monitor-less (i.e., headless) device, wherein access would be provided over a network interface connection.

Cryptographic units such as, but not limited to, microcontrollers, processors 2126, interfaces 2127, and/or devices 2128 may be attached, and/or communicate with the EISA controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2129. However, memory is a fungible technology and resource, thus, any number of memory embodiments may be employed in lieu of or in concert with one another. It is to be understood that the EISA controller and/or a computer systemization may employ various forms of memory 2129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2129 will include ROM 2106, RAM 2105, and a storage device 2114. A storage device 2114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2129 may contain a collection of program and/or database components and/or data such as, but not limited to: operating system component(s) 2115 (operating system); information server component(s) 2116 (information server); user interface component(s) 2117 (user interface); Web browser component(s) 2118 (Web browser); database(s) 2119; mail server component(s) 2121; mail client component(s) 2122; cryptographic server component(s) 2120 (cryptographic server); the EISA component(s) 2135; and/or the like (i.e., collectively a component collection). These components may be stored and accessed from the storage devices and/or from storage devices accessible through an interface bus. Although non-conventional program components such as those in the component collection, typically, are stored in a local storage device 2114, they may also be loaded and/or stored in memory such as: peripheral devices, RAM, remote storage facilities through a communications network, ROM, various forms of memory, and/or the like.

### Operating System

The operating system component 2115 is an executable program component facilitating the operation of the EISA controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like.

For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the EISA controller to communicate with other entities through a communications network 2113. Various communication protocols may be used by the EISA controller as a subcarrier transport mechanism for interaction, such as, but not limited to: multicast, TCP/IP, UDP, unicast, and/or the like.

### Information Server

An information server component 2116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the EISA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the EISA database 2119, operating systems, other program components, user interfaces, Web browsers, and/or the like.

Access to the EISA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the EISA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the EISA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the EISA enabled nodes. The combined application may be nugatory on systems employing standard Web browsers.

### Mail Server

A mail server component 2121 is a stored program component that is executed by a CPU 2103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the EISA.

Access to the EISA mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2122 is a stored program component that is executed by a CPU 2103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2120 is a stored program component that is executed by a CPU 2103, cryptographic processor 2126, cryptographic processor interface 2127, cryptographic processor device 2128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the EISA may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the EISA component to engage in secure transactions if so desired. The cryptographic component facilitates the secure accessing of resources on the EISA and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The EISA Database

The EISA database component 2119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the EISA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the EISA database is implemented as a data-structure, the use of the EISA database 2119 may be integrated into another component such as the EISA component 2135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2119 includes several tables 2119a-k. A Users table 2119a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a EISA. A Financial Accounts table 2119b may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Clients table 2119c may include fields such as, but not limited to: user_id, client_id, client_ip, client_type, client_model, operating_system, os_version, app_installed_flag, and/or the like. A Transactions table 2119d may include fields such as, but not limited to: order_id, user_id, timestamp, transaction_cost, purchase_details_list, num_products, products_list, product_type, product_params list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. An Issuers table 2119e may include fields such as, but not limited to: issuer_id, issuer_name, issuer_address, ip_address, mac_address, auth_key, port_num, security_settings_list, and/or the like. A Batch Data table 2119f may include fields such as, but not limited to: batch_id, transaction_id_list, timestamp_list, cleared_flag_list, clearance_trigger_settings, and/or the like. A Payment Ledger table 2119g may include fields such as, but not limited to: request_id, timestamp, deposit_amount, batch_id, transaction_id, clear_flag, deposit_account, transaction_summary, payor_name, payor_account, and/or the like. An Analysis Requests table 2119h may include fields such as, but not limited to: user_id, password, request_id, timestamp, request_details_list, time_period, time_interval, area_scope, area_resolution, spend_sector_list, client_id, client_ip, client_model, operating_system, os_version, app_installed_flag, and/or the like. A Normalized Templates table 2119i may include fields such as, but not limited to: transaction_record_list, norm_flag, timestamp, transaction_cost, merchant_params list, merchant_id, merchant_name, merchant_auth_key, merchant_products_list, num_products, product_list, product_type, product_name, class_labels_list, product_quantity, unit_value, sub_total, comment, user_account_params, account_name, account_type, account_num, billing_line1, billing_line2, zipcode, state, country, phone, sign, and/or the like. A Classification Rules table 2119j may include fields such as, but not limited to: rule_id, rule_name, inputs list, operations_list, outputs_list, thresholds_list, and/or the like. A Strategy Parameters table 2119k may include fields such as, but not limited to: strategy_id, strategy_params_list, regression_models_list, regression_equations_list, regression_coefficients_list, fit_goodness_list, lsm_values_list, and/or the like. A Market Data table 2119l may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the EISA database may interact with other database systems. For example, employing a distributed database system, queries and data access by search EISA component may treat the combination of the EISA database, an integrated data security layer database as a single database entity.

In one embodiment, user programs may contain various user interface primitives, which may serve to update the EISA. Also, various accounts may require custom database tables depending upon the environments and the types of clients the EISA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2119a-k. The EISA may be configured to keep track of various settings, inputs, and parameters via database controllers.

The EISA database may communicate to and/or with other components in a component collection, including itself, and/or facilities of the like. Most frequently, the EISA database communicates with the EISA component, other program components, and/or the like. The database may contain, retain, and provide information regarding other nodes and data.

### The EISAs

The EISA component 2135 is a stored program component that is executed by a CPU. In one embodiment, the EISA component incorporates any and/or all combinations of the aspects of the EISA discussed in the previous figures. As such, the EISA affects accessing, obtaining and the provision of information, services, transactions, and/or the like across various communications networks.

The EISA component may transform raw card-based transaction data via EISA components into business analytics reports, and/or the like and use of the EISA. In one embodiment, the EISA component 2135 takes inputs (e.g., purchase input 211, issuer server data 220, user data 224, batch data 239, issuer server data 247, analysis request input 411, server addresses 417, transaction data 420b-n, transaction data 421b-n, classification rules 427, reporting rules 435, server addresses 513, transaction data 518a-c, and/or the like) etc., and transforms the inputs via various components (e.g., CTE component 2141, TDN component 2142, CTC component 2143, TDA component 2144, TDF component 2145, CDA component 2146, ESA component 2147, BAR component 2148, and/or the like), into outputs (e.g., authorization message 227, authorization message 231, authorization message 232, batch append data 234, purchase receipt 235, transaction data 245, funds transfer message 252, funds transfer message 253, business analytics report 437, transaction data 519a-c, aggregated transaction data 52o, and/or the like).

The EISA component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the EISA server employs a cryptographic server to encrypt and decrypt communications. The EISA component may communicate to and/or with other components in a component collection, including itself, and/or facilities of the like. Most frequently, the EISA component communicates with the EISA database, operating systems, other program components, and/or the like. The EISA may contain, communicate, generate, obtain, and/or provide program component, system, user, and/or data communications, requests, and/or responses.

### Distributed EISAs

The structure and/or operation of any of the EISA node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the EISA controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the EISA controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while ($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference.

In order to address various issues and advance the art, the entirety of this application for ECONOMETRICAL INVESTMENT STRATEGY ANALYSIS APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a EISA individual and/or enterprise user, database configuration and/or relational model, data type, data transmission and/or network framework, syntax structure, and/or the like, various embodiments of the EISA may be implemented that enable a great deal of flexibility and customization. For example, aspects of the EISA may be adapted for stock trading, sports betting, gambling security systems, weather forecasting, census analysis, journalism, political forecasting, voting systems analysis, social experiments, prediction analysis, and/or the like. While various embodiments and discussions of the EISA have been directed to business analytics, however, it is to be understood that the embodiments described herein may be readily configured and/or customized for a wide variety of other applications and/or implementations.

What is claimed is:

1. An econometrical investment strategy analysis processor-implemented method, comprising:
obtaining an investment strategy analysis request;
determining a scope of aggregation of card-based transaction data records for investment strategy analysis;
aggregating the card-based transaction data records for investment strategy analysis according to the determined scope;
determining a forecast regression equation using the aggregated card-based transaction data records;
calculating via a processor a forecast for retail spending in a specified spending category using the forecast regression equation;
generating a business analytics report based on the calculated forecast; and
providing the business analytics report in response to the obtained investment strategy analysis report.

2. The method of claim 1, further comprising:
generating anonymized card transaction data by removing identifying characteristics from the aggregated transaction data.

3. The method of claim 1, further comprising:
determining classification labels for the transaction data records according to spending categories associated with the transaction data records; and
filtering relevant transaction data records for investment strategy analysis based on the determined classification labels for the transaction data records.

4. The method of claim 1, further comprising:
generating the business analytics report in accordance with a user-specified customization.

5. The method of claim 1, further comprising:
triggering an investment action based on the forecast for retail spending in the specified spending category.

6. The method of claim 1, further comprising:
generating a data feed using the forecast for retail spending; and
providing the generated data feed.

7. The method of claim 1, wherein the specified spending category is one of: specialty clothing; home improvement; hotel industry; pharmacy sales; and car rentals.

8. An econometrical investment strategy analysis system, comprising:
a processor; and
a memory disposed in communication with the processor and storing processor-issuable instructions to:
obtain an investment strategy analysis request;
determine a scope of aggregation of card-based transaction data records for investment strategy analysis;
aggregate the card-based transaction data records for investment strategy analysis according to the determined scope;
determine a forecast regression equation using the aggregated card-based transaction data records;
calculate a forecast for retail spending in a specified spending category using the forecast regression equation;
generate a business analytics report based on the calculated forecast; and
provide the business analytics report in response to the obtained investment strategy analysis report.

9. The system of claim 8, the memory further storing instructions to:
generate anonymized card transaction data by removing identifying characteristics from the aggregated transaction data.

10. The system of claim 8, the memory further storing instructions to:
determine classification labels for the transaction data records according to spending categories associated with the transaction data records; and
filter relevant transaction data records for investment strategy analysis based on the determined classification labels for the transaction data records.

11. The system of claim 8, the memory further storing instructions to:
generate the business analytics report in accordance with a user-specified customization.

12. The system of claim 8, the memory further storing instructions to:
trigger an investment action based on the forecast for retail spending in the specified spending category.

13. The system of claim 8, the memory further storing instructions to:
generate a data feed using the forecast for retail spending; and
provide the generated data feed.

14. The system of claim 8, wherein the specified spending category is one of: specialty clothing; home improvement; hotel industry; pharmacy sales; and car rentals.

15. A processor-readable tangible medium storing processor-issuable econometrical investment strategy analysis instructions to:
obtain an investment strategy analysis request;
determine a scope of aggregation of card-based transaction data records for investment strategy analysis;
aggregate the card-based transaction data records for investment strategy analysis according to the determined scope;
determine a forecast regression equation using the aggregated card-based transaction data records;
calculate a forecast for retail spending in a specified spending category using the forecast regression equation;
generate a business analytics report based on the calculated forecast; and
provide the business analytics report in response to the obtained investment strategy analysis report.

16. The medium of claim 15, further storing instructions to:
generate anonymized card transaction data by removing identifying characteristics from the aggregated transaction data.

17. The medium of claim 15, further storing instructions to:
determine classification labels for the transaction data records according to spending categories associated with the transaction data records; and
filter relevant transaction data records for investment strategy analysis based on the determined classification labels for the transaction data records.

18. The medium of claim 15, further storing instructions to:
generate the business analytics report in accordance with a user-specified customization.

19. The medium of claim 15, further storing instructions to:
trigger an investment action based on the forecast for retail spending in the specified spending category.

20. The medium of claim 15, further storing instructions to:
generate a data feed using the forecast for retail spending; and
provide the generated data feed.

21. The medium of claim 15, wherein the specified spending category is one of: specialty clothing; home improvement; hotel industry; pharmacy sales; and car rentals.

22. An econometrical investment strategy analysis means, comprising:
means for obtaining an investment strategy analysis request;
means for determining a scope of aggregation of card-based transaction data records for investment strategy analysis;
means for aggregating the card-based transaction data records for investment strategy analysis according to the determined scope;
means for determining a forecast regression equation using the aggregated card-based transaction data records;
means for calculating via a processor a forecast for retail spending in a specified spending category using the forecast regression equation;
means for generating a business analytics report based on the calculated forecast; and
means for providing the business analytics report in response to the obtained investment strategy analysis report.

22. The means of claim 22, further comprising:
means for generating anonymized card transaction data by removing identifying characteristics from the aggregated transaction data.

24. The means of claim 22, further comprising:
means for determining classification labels for the transaction data records according to spending categories associated with the transaction data records; and
means for filtering relevant transaction data records for investment strategy analysis based on the determined classification labels for the transaction data records.

25. The means of claim 22, further comprising:
means for generating the business analytics report in accordance with a user-specified customization.

26. The means of claim 22, further comprising:
means for triggering an investment action based on the forecast for retail spending in the specified spending category.

27. The means of claim 22, further comprising:
means for generating a data feed using the forecast for retail spending; and
means for providing the generated data feed.

28. The means of claim 22, wherein the specified spending category is one of: specialty clothing; home improvement; hotel industry; pharmacy sales; and car rentals.

29. An investment strategy analysis requisition processor-implemented method, comprising:
generating via a processor an investment strategy analysis request specifying:
an investment strategy; and
a scope of aggregation of card-based transaction data records for analyzing the investment strategy;
providing the investment strategy analysis request for a pay network server; and
obtaining a business analytics report providing a forecast for retail spending related to the investment strategy based on the specified scope of aggregation of card-based transaction data records; and
presenting the forecast for retail spending related to the investment strategy.

30. The method of claim 29, further comprising:
providing a user-specified customization requirement for generating the business analytics report.

31. The method of claim 29, further comprising:
parsing the business analytics report; and
extracting data on the forecast for retail spending; and
triggering an investment action based on the extracted data on the forecast for retail spending.

32. The method of claim 29, wherein the business analytics report is obtained as a data feed.

33. The method of claim 29, wherein the forecast on retail spending includes a forecast on retail spending in a specified industry category.

34. The method of claim 33, wherein the specified industry category is one of: specialty clothing; home improvement; hotel industry; pharmacy sales; and car rentals.

35. The method of claim 29, wherein the forecast on retail spending includes a forecast on retail spending via a specified sales channel.

36. The method of claim 35, wherein the specified sales channel is one of: e-commerce; and in-person.

37. The method of claim 29, wherein the forecast on retail spending includes a forecast on retail spending in a specified geographical location.

38. The method of claim 37, wherein the specified geographical location is one of: a block; a street; a city; a metropolitan area; a district; a state; a country; and a continent.

39. An investment strategy analysis requisition apparatus, comprising:
a processor; and
a memory disposed in communication with a processor and storing processor-executable instructions to:
generate an investment strategy analysis request specifying:
an investment strategy; and
a scope of aggregation of card-based transaction data records for analyzing the investment strategy;
provide the investment strategy analysis request for a pay network server; and
obtain a business analytics report providing a forecast for retail spending related to the investment strategy based on the specified scope of aggregation of card-based transaction data records; and
present the forecast for retail spending related to the investment strategy.

40. The apparatus of claim 39, the memory further storing instructions to:
provide a user-specified customization requirement for generating the business analytics report.

41. The apparatus of claim 39, the memory further storing instructions to:
parse the business analytics report; and
extract data on the forecast for retail spending; and
trigger an investment action based on the extracted data on the forecast for retail spending.

42. The apparatus of claim 39, wherein the business analytics report is obtained as a data feed.

43. The apparatus of claim 39, wherein the forecast on retail spending includes a forecast on retail spending in a specified industry category.

44. The apparatus of claim 43, wherein the specified industry category is one of: specialty clothing; home improvement; hotel industry; pharmacy sales; and car rentals.

45. The apparatus of claim 39, wherein the forecast on retail spending includes a forecast on retail spending via a specified sales channel.

46. The apparatus of claim 45, wherein the specified sales channel is one of: e-commerce; and in-person.

47. The apparatus of claim 39, wherein the forecast on retail spending includes a forecast on retail spending in a specified geographical location.

48. The apparatus of claim 47, wherein the specified geographical location is one of: a block; a street; a city; a metropolitan area; a district; a state; a country; and a continent.

49. A processor-readable tangible medium storing processor-executable investment strategy analysis requisition instructions to:
generate an investment strategy analysis request specifying:
an investment strategy; and
a scope of aggregation of card-based transaction data records for analyzing the investment strategy;
provide the investment strategy analysis request for a pay network server; and
obtain a business analytics report providing a forecast for retail spending related to the investment strategy based on the specified scope of aggregation of card-based transaction data records; and
present the forecast for retail spending related to the investment strategy.

50. The medium of claim 49, further storing instructions to:
provide a user-specified customization requirement for generating the business analytics report.

51. The medium of claim 49, further storing instructions to:
parse the business analytics report; and
extract data on the forecast for retail spending; and
trigger an investment action based on the extracted data on the forecast for retail spending.

52. The medium of claim 49, wherein the business analytics report is obtained as a data feed.

53. The medium of claim 49, wherein the forecast on retail spending includes a forecast on retail spending in a specified industry category.

54. The medium of claim 52, wherein the specified industry category is one of: specialty clothing; home improvement; hotel industry; pharmacy sales; and car rentals.

55. The medium of claim 49, wherein the forecast on retail spending includes a forecast on retail spending via a specified sales channel.

56. The medium of claim 55, wherein the specified sales channel is one of: e-commerce; and in-person.

57. The medium of claim 49, wherein the forecast on retail spending includes a forecast on retail spending in a specified geographical location.

58. The medium of claim 57, wherein the specified geographical location is one of: a block; a street; a city; a metropolitan area; a district; a state; a country; and a continent.

59. An investment strategy analysis requisition means, comprising:
means for generating an investment strategy analysis request specifying:
an investment strategy; and
a scope of aggregation of card-based transaction data records for analyzing the investment strategy;
means for providing the investment strategy analysis request for a pay network server; and
means for obtaining a business analytics report providing a forecast for retail spending related to the investment strategy based on the specified scope of aggregation of card-based transaction data records; and
means for presenting the forecast for retail spending related to the investment strategy.

60. The means of claim 59, further comprising:
means for providing a user-specified customization requirement for generating the business analytics report.

61. The means of claim 59, further comprising:
means for parsing the business analytics report; and
means for extracting data on the forecast for retail spending; and
means for triggering an investment action based on the extracted data on the forecast for retail spending.

62. The means of claim 59, wherein the business analytics report is obtained as a data feed.

63. The means of claim 59, wherein the forecast on retail spending includes a forecast on retail spending in a specified industry category.

64. The means of claim 63, wherein the specified industry category is one of: specialty clothing; home improvement; hotel industry; pharmacy sales; and car rentals.

65. The means of claim 59, wherein the forecast on retail spending includes a forecast on retail spending via a specified sales channel.

66. The means of claim 65, wherein the specified sales channel is one of: e-commerce; and in-person.

67. The means of claim 59, wherein the forecast on retail spending includes a forecast on retail spending in a specified geographical location.

68. The means of claim 67, wherein the specified geographical location is one of: a block; a street; a city; a metropolitan area; a district; a state; a country; and a continent.

69. An investment strategy analysis data aggregation method, comprising:
obtaining card transaction data with a purchase order, as well as an authorization message for processing the purchase order;
generating via a processor a card-based transaction data batch using the card transaction data obtained with the purchase order; and
providing the card-based transaction data batch for econometrical investment strategy analysis.

70. The method of claim 69, further comprising:
obtaining a notification of utilization of the provided card-based transaction data batch in an econometrical investment strategy analysis.

71. An investment strategy analysis data aggregation system, comprising:
a processor; and
a memory disposed in communication with the processor and storing processor-executable investment strategy analysis data aggregation instructions to:
obtain card transaction data with a purchase order, as well as an authorization message for processing the purchase order;
generate a card-based transaction data batch using the card transaction data obtained with the purchase order; and
provide the card-based transaction data batch for econometrical investment strategy analysis.

72. The system of claim 71, the memory further storing instructions to:
obtain a notification of utilization of the provided card-based transaction data batch in an econometrical investment strategy analysis.

73. A processor-readable tangible medium storing processor-executable investment strategy analysis data aggregation instructions to:
obtain card transaction data with a purchase order, as well as an authorization message for processing the purchase order;
generate a card-based transaction data batch using the card transaction data obtained with the purchase order; and
provide the card-based transaction data batch for econometrical investment strategy analysis.

74. The medium of claim 73, further storing instructions to:
obtain a notification of utilization of the provided card-based transaction data batch in an econometrical investment strategy analysis.

75. An investment strategy analysis data aggregation means, comprising:
means for obtaining card transaction data with a purchase order, as well as an authorization message for processing the purchase order;
means for generating a card-based transaction data batch using the card transaction data obtained with the purchase order; and
means providing the card-based transaction data batch for econometrical investment strategy analysis.

76. The means of claim 75, further comprising:
means for obtaining a notification of utilization of the provided card-based transaction data batch in an econometrical investment strategy analysis.

77. An investment strategy analysis data supplier method, comprising:
obtaining card transaction data as part of a request for authorization to process a purchase order;
generating via a processor a card transaction authorization message including the card transaction data; and
providing the card-based transaction authorization message including the card transaction data for econometrical investment strategy analysis.

78. The method of claim 77, further comprising:
obtaining a notification of utilization of the provided card-based transaction data in an econometrical investment strategy analysis.

79. An investment strategy analysis data supplier system, comprising:
a processor; and
a memory disposed in communication with the processor and storing processor-executable instructions to:
obtain card transaction data as part of a request for authorization to process a purchase order;
generate a card transaction authorization message including the card transaction data; and
provide the card-based transaction authorization message including the card transaction data for econometrical investment strategy analysis.

80. The system of claim 79, the memory further storing instructions to:
obtain a notification of utilization of the provided card-based transaction data in an econometrical investment strategy analysis.

81. A processor-readable tangible medium storing processor-executable investment strategy analysis data supplier instructions to:
obtain card transaction data as part of a request for authorization to process a purchase order;
generate a card transaction authorization message including the card transaction data; and
provide the card-based transaction authorization message including the card transaction data for econometrical investment strategy analysis.

82. The medium of claim 81, further storing instructions to:
obtain a notification of utilization of the provided card-based transaction data in an econometrical investment strategy analysis.

83. An investment strategy analysis data supplier means, comprising:
means for obtaining card transaction data as part of a request for authorization to process a purchase order;
means for generating a card transaction authorization message including the card transaction data; and
means for providing the card-based transaction authorization message including the card transaction data for econometrical investment strategy analysis.

84. The method of claim 77, means comprising:
means for obtaining a notification of utilization of the provided card-based transaction data in an econometrical investment strategy analysis.
